(19) United States
(12) Patent Application Publication
(10) Pub. No.: US 2002/0118800 A1
(43) Pub. Date: Aug. 29, 2002

(54) Telecommunication systems and methods therefor

(76) Inventors: Maria Martinez, Winfield, IL (US); Asif Naseem, Naperville, IL (US); Richard Piepho, Naperville, IL (US); Gregory Johnson, Carol Stream, IL (US); May Pao, Glen Ellyn, IL (US); Lawrence Keeley, Chicago, IL (US)

Correspondence Address: MOTOROLA INC, 600 NORTH US HIGHWAY 45, LIBERTYVILLE, IL, 60048-5343, US

(21) Appl. No.: 09/904,746

(22) Filed: Jul. 12, 2001

Related U.S. Application Data
(62) Division of application No. 09/141,485, filed on Aug. 27, 1998.

(51) Int. Cl. H04M 1/64

(52) U.S. Cl. 379/67.1; 379/88.22

(57) ABSTRACT

The present invention relates to a telephone system including a telephone switch (36, 66) having at least one incoming line and at least one outgoing line. The telephone switch (36, 66) is responsive to control signals to switch a call received from a caller to an outgoing line directed to one of a plurality of numbers stored in a database for a first party. An audio processing unit (68) is connected to the telephone switch (36, 66) to receive incoming audio communications from the caller and to provide outgoing audio communications to the caller. A control unit (76) controls the telephone switch to transfer the call to the at least one outgoing line. A method of providing telephone communication service to a user is also provided. The method included the steps of receiving an incoming call from a user, connecting the incoming call to an audio processing unit, and obtaining a first audio request from the user. The method also includes the steps of determining whether the first audio request corresponds to one of a plurality of parties stored in a database, and placing an outgoing call directed to the one of the plurality of parties.

### FIELD OF THE INVENTION

The present invention relates generally to communication systems, and more particularly, to telecommunication systems.

### BACKGROUND OF THE INVENTION

A variety of telecommunication networks and services have been available in various countries. In particular, a telecommunication network typically includes a central office through which telephone calls are routed. Each central office is usually owned by a telephone company that participates in the network. A caller connected to the central office can call subscribers and can receive calls from other subscribers.

There are many different, commercially available communication devices that enable people to communicate with each other using a telecommunication network. In addition to the traditional telephone that has been around for decades, there are now mobile or cellular phones, cordless phones, car phones, personal communication devices, trunked radio devices, personal information management devices (PIM) (i.e., palm pilots), personal digital assistants (PDA), pagers, local and wide area computer networks, and facsimile machines.

As the use of these various communications devices increases, it can become difficult to remember each of the frequently called phone numbers of business and personal contacts or parties. Furthermore, callers may not have immediate access to a directory of their frequently called phone numbers.

Accordingly, a need exists for a phone directory that can be accessed from any remote location by using a suitable communication device. It would be desirable to place calls to parties stored in the directory in response to commands from a user. Furthermore, it would be beneficial to provide content information to the user and allow the user to perform various transactions using a communication device.

### BRIEF DESCRIPTION OF THE DRAWINGS

The invention, together with further attendant advantages, will best be understood by reference to the following detailed description of the presently preferred embodiments of the invention, taken in conjunction with the accompanying drawings, wherein:

FIG. 1 is a block diagram of a communication network in accordance with the present invention;

FIG. 2 is a block diagram of one embodiment of a telecommunication system of the communications network of FIG. 1;

FIG. 3 is a block diagram of one configuration of a telecommunication system having a telecommunication node remotely located from a carrier network;

FIG. 4 is a block diagram of another configuration of a telecommunication system having a telecommunication node co-located with a carrier network;

FIG. 5 is a block diagram of another configuration of a telecommunication system;

FIG. 6 is a block diagram of another configuration of a telecommunication system having a public branch exchange network (PBX);

FIG. 7 is a block diagram of another configuration of a telecommunication system;

FIG. 8a is a diagrammatical view of one embodiment of a communication network in accordance with the present invention;

FIG. 8b is a block diagram of a telecommunication node in accordance with a preferred embodiment of the present invention;

FIG. 9a is a depiction of a welcome page of a web site of the telecommunication node of FIG. 8b;

FIG. 9b is a depiction of a home page of the web site of the telecommunication node of FIG. 8b;

FIG. 9c is a depiction of an address book page of the web site of the telecommunication node of FIG. 8b;

FIG. 9d is a depiction of another page of the address book of the web site of the telecommunication node of FIG. 8b;

FIG. 10 is a flow diagram of an Idle routine in accordance with the present invention;

FIG. 11 is a block diagram of a Main Menu routine in accordance with the present invention;

FIGS. 12-14 show a block diagram of a MM_Main routine in accordance with the present invention;

FIG. 15 is a block diagram of a Voice_Dial_Main routine in accordance with the present invention;

FIG. 16 is a block diagram of a Name_Loc_Conf routine and a Call_Setup routine in accordance with the present invention;

FIG. 17 is a block diagram of a Get_Name routine in accordance with the present invention;

FIG. 18 is a block diagram of a Change_Name_Loc routine in accordance with the present invention;

FIG. 19 is a block diagram of a Get_Name routine and a Call_Conf routine in accordance with the present invention;

FIG. 20 is a block diagram of a Phone_Num_Conf routine and a Phone_Num_Conf_One routine in accordance with the present invention;

FIG. 21 is a block diagram of a Get_Phone_Num routine and a Call_Conf_A routine in accordance with the present invention;

FIG. 22 is a block diagram of a System_Main routine, a System-Call_Opt routine, a Drop Conf routine and a System_Hold_Conf routine in accordance with the present invention;

FIG. 23 is a block diagram of a Paging_Name_Ret_Conf routine in accordance with the present invention;

FIG. 24 is a block diagram of a Paging_Main routine in accordance with the present invention;

FIG. 25 is a block diagram of a Get_Paging_Loc routine in accordance with the present invention;

FIG. 26 is a block diagram of a Chg_Paging_Name routine in accordance with the present invention;

FIG. 27 is a block diagram of a Get_Pagee_Name routine in accordance with the present invention;

FIG. 28 is a block diagram of a Chg_Paging_Name_Ret routine in accordance with the present invention;

FIG. 29 is a block diagram of a Page_Conf routine in accordance with the present invention;

FIGS. 30-32 show a block diagram of a Addr_Bk_Main routine, a Add_Bk_Main routine, or Addr_Bk_Details routine, and a Addr_Bk_Details_One routine in accordance with the present invention;

FIG. 33 is a block diagram of a VoiceNote_GetNames routine in accordance with the present invention;

FIG. 34 is a block diagram of a Fb_Sp_Rec_Gr routine and a Fb_Sp_Conf_Gr_One routine in accordance with the present invention;

FIGS. 34a-34bb are a block diagram of another VoiceNotes routine in accordance with the present invention;

FIG. 35 is a block diagram of a Fb_Sp_Rec_Gr System routine and a Fb_Sp_Rec_Gr_System_One routine in accordance with the present invention;

FIG. 36 is a block diagram of a Weather_Main routine, a Today_Weather routine, and an Extended Weather routine in accordance with the present invention;

FIG. 37 is a block diagram of a Stock_Mkt_Main routine, a Stock_Mkt_Ind routine, and a Stock_Portf routine in accordance with the present invention;

FIG. 38 is a block diagram of an Authenticate subroutine in accordance with the present invention;

FIG. 39 is a block diagram of an Error Processing subroutine in accordance with the present invention;

FIG. 40 is a block diagram of an Exit Processing subroutine in accordance with the present invention;

FIG. 41 is a block diagram of a Cancel Processing subroutine in accordance with the present invention;

FIG. 42 is a block diagram of a Goodbye Processing Confirmed subroutine in accordance with the present invention;

FIG. 42a is a block diagram of a Goodbye Processing Not Confirmed subroutine in accordance with the present invention; and

FIG. 43 is a block diagram of a Help Processing subroutine in accordance with the present invention.

### DESCRIPTION OF THE PREFERRED EMBODIMENTS

Before explaining the present embodiments in detail, it should be understood that the invention is not limited in its application or use to the details of construction and arrangement of parts illustrated in the accompanying drawings and description. It will be recognized that the illustrative embodiments of the invention may be implemented or incorporated in other embodiments, variations and modifications, and may be practiced or carried out in various ways. Furthermore, unless otherwise indicated, the terms and expressions employed herein have been chosen for the purpose of describing the illustrative embodiments of the present invention for the convenience of the reader and are not for the purpose of limitation.

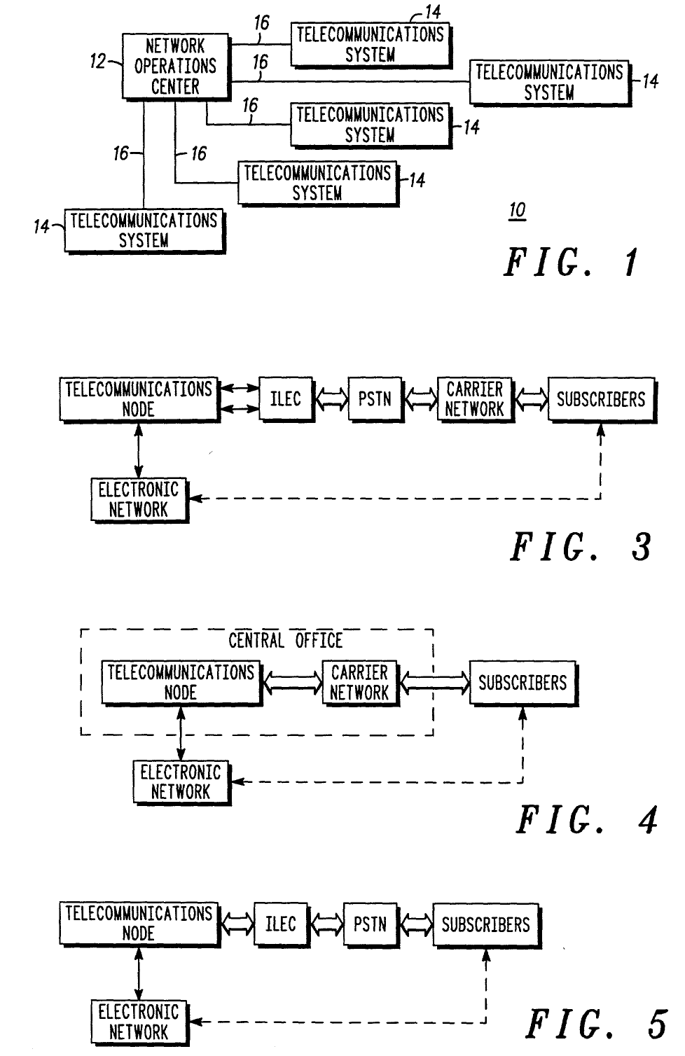

Referring now to the drawings, and more particularly to FIG. 1, a preferred embodiment of a communications network 10 is illustrated. The communication network 10 generally includes a Network Operations Center (NOC) 12 and at least one telecommunication system 14 (five being shown). The NOC 12 is connected to the telecommunication system 14 via a high-speed data link 16, such as, a T1 telephone line, a local area network (LAN), or a wide area network (WAN). The NOC 12 monitors the operation and functioning of the telecommunications system 14 and receives billing information from the telecommunication system 14. The NOC 10 also allows customer service representatives to enter product and service orders, billing records, service requests, subscription information, and other information into the telecommunication system.

The telecommunication system 14 of the communication network 10 can provide various services and capabilities to cellular subscribers, wireline subscribers, paging subscribers, satellite subscribers, mobile or portable phone subscribers, trunked radio subscribers, computer network subscribers (i.e., internet subscribers, intranet subscribers, etc.), and the like. In particular, the telecommunication system 14 provides speech recognition, incoming call authorization, call routing, text-to-speech capabilities, touch-tone recognition, content information (i.e., news reports, stock information, designated city weather, etc.), speech-to-text capabilities, messaging services, call screening, transactional capabilities, interactive voice applications, voice mail, voice dialing, etc.

The telecommunication system 14 can be operated by one or more carriers (i.e., Sprint PCS, Qwest Communications, MCI, etc.) or independent service providers, such as, for example, Motorola, Inc. The telecommunication system 14 can be located in various geographic locations throughout the world or the United States (i.e., Chicago, Ill.).

The telecommunication system 14 allows users or subscribers to control and manage communications from any location in the world using a suitable communication device (i.e., a telephone, a cellular phone, an office phone, a home phone, a pay phone, a web phone, a desk-top computer, a portable computer, a PIM, a PDA, a pager, etc.). The telecommunication system 14 can be accessed by dialing a single direct access telephone number (i.e., a foreign exchange number, a local number, or a toll-free number). The system can also be accessed over a Public Branch Exchange (PBX), an electronic network, such as, an intranet, the internet, and the World Wide Web (WWW), and a paging system. It will be recognized that the system can be accessed in various ways depending on the configuration of the system.

Once the user accesses the system, the user can perform a series of transactions without having to terminate the original call to the system or to re-enter an access number or PIN. For example, the user can complete a call to a party, obtain a news update, and access an email, all without having to dial additional numbers or terminate the original call.

When a user dials into the telecommunication system 14 from a communication device having an access or phone number registered with the system (i.e., a user's home phone, work phone, cellular phone, etc.), the system can by-pass a user screening option and automatically identify the user through the use of automatic number identification (ANI) or caller line identification (CLI). After the system verifies the call, the system personally welcomes the user to the system (i.e., “Hi, this is Maya. Welcome Bob. How may I help you?”). The system then enters into a dialogue with the user, and the user can select a variety of services and features provided by the system.

The system can provide various dialog voice personalities (i.e., a female voice, a male voice, etc.) and can implement various grammars (i.e. vocabulary) to detect the speech of the user. In addition, the system can automatically select speech recognition models (i.e., an English model, a Spanish model, an English accent model, etc.) based upon a user profile, the user's communication device, and the user's speech patterns. The system can also allow the user to select a particular speech recognition model.

When the user dials into the system from a communication device not registered with the system (i.e., a payphone, a phone of a non-subscriber, etc.), the system answers the call and prompts the user to enter his or her name and/or a personal identification number (PIN) using speech or voice commands or DTMF tones. The system can also utilize speaker verification to identify a particular speech pattern of the user. If the system authorizes the user to access the system, a personal greeting is announced by system to the user (i.e., “Hi, this is Maya. Welcome Ann. How may I help you?”). The system then enters into a dialogue with the user, and the user can select desired services and functions offered by the system. If the name and/or PIN of the user cannot be recognized or verified by the system, the user will be routed to a customer service representative.

Once the user has accessed the system, the user may implement a wide variety of services and features by using voice commands, such as, for example, voice dialing, voice paging, facsimiles, caller announcements, voice mails, reminders, call forwarding, call recording, content information (i.e. newspapers, etc.). The system can place outbound calls and pages to business and personal parties or contacts (i.e., friends, clients, business associates, family members, etc.) in response to DTMF tones or speech commands. The calls can be routed through a telephone or electronic network to the selected party and the pagers can be sent to a selected party via a paging system. The system can also receive calls routed through a telephone or electronic network.

The system can place a call to a particular contact at a selected location or device in response to speech commands or DTMF tones from a user (i.e., “call Bob at home”, “call Ann Jones at work”, or “dial Bill on mobile phone”). If the user does not specify the location of the party or the device to call, the system can automatically prompt the user for the location of the party and/or the device (i.e., “the valid locations for Bob are home, work, and mobile phone”). Alternatively, the user can program the system to automatically call a default or designated number of the party.

The system can also be programmed to simultaneously call all of the phone numbers of the communication devices of a selected party, or sequentially call various phone numbers of the selected party. For example, the system can first call the party at home, and if there is no answer, the system can dial the party at the office. The user can also place a call to a particular party by speaking a string of digits of the phone number of the party (i.e., “dial 630 408 4357”).

The telecommunication system 14 also allows a user to place a series of calls to different parties or numbers without hanging up or terminating the original call to the system. For example, when the user has finished a call or the called party has hung up, the system will ask the user if he or she wishes to hold, pause, or drop the call. If the call is dropped, the system will prompt the user for the next request. The user can then request the system to place a call to another number or party.

In addition to the calling capabilities of the system, the system enables the user to access content information via a communication device, such as, a paging device, a PDA, A PIM, a mobile phone, a network access device (i.e., a computer), etc. The user can access content information using speech commands or DTMF tones. For example, the user can access up-to-date information, such as, for example, news updates, designated city weather, traffic conditions, stock quotes, and stock market indicators. The system can also send reminders or updates to the user about various events and can allow the user to perform various transactions (i.e., order flowers, pizza, etc.) The user can also access the telecommunication system 14 through an electronic network and can navigate web pages using voice commands.

The telecommunication system can also notify a user of voice or text messages, such as, voice mail messages, emails, faxes, etc. The user can play, delete, store and forward the messages. The messages can be delivered to the system from integrated messaging services and/or external messaging services.

The system further enables a user to initiate pages through speech or voice commands (i.e., “page Bob”). When a user pages a party or contact, the system can automatically provide the ANI or CLI of the communication device that the user is using as a callback number. Alternatively, the user can enter a desired callback number. The user can also access and display information provided by the telecommunication system.

Furthermore, a user can access a personal file or address book stored in the telecommunication node through any suitable communication device. The address book preferably stores names of parties along with their addresses and phone numbers. Once the subscriber accesses his or her personal address book, the system can read information about one or more of the parties stored in the address book and can provide various details to the user (i.e., addresses, etc.) of each party. After the system has read the name of the party, the user can call the party by using a voice command (i.e., “call”). The subscriber can also enter frequently dialed numbers for voice activated dialing using voice commands or through an electronic network.

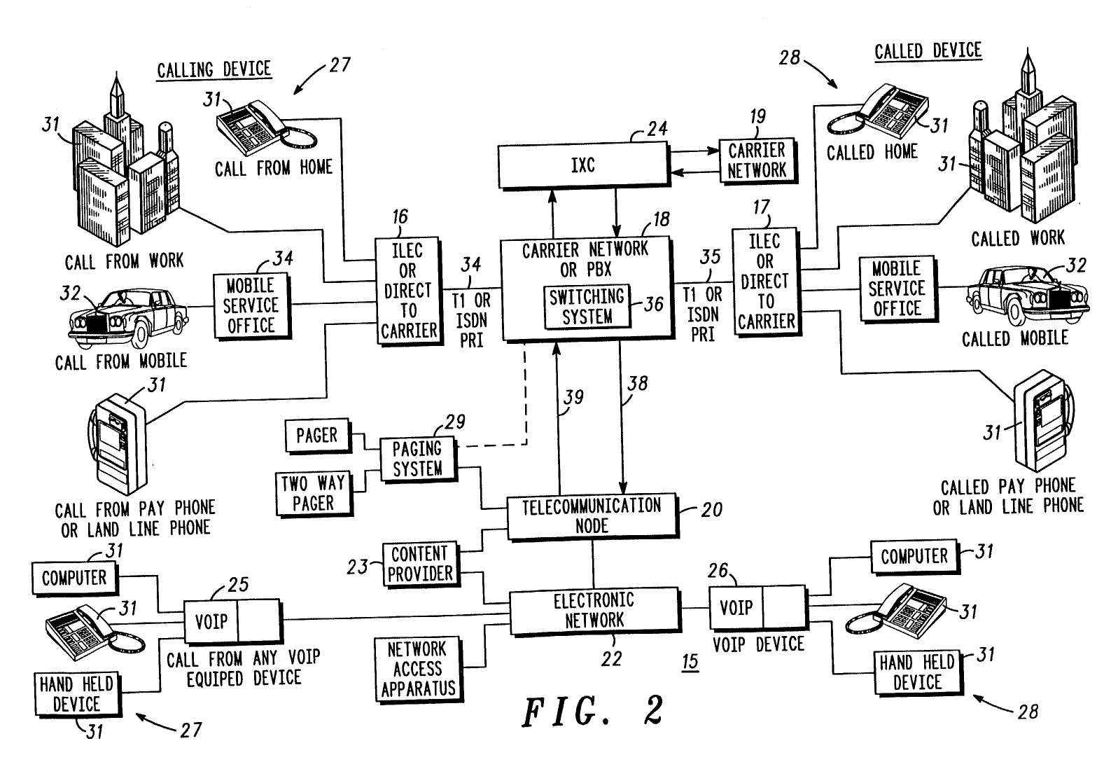

As shown in FIG. 2, an exemplary block diagram of one embodiment of a telecommunication system 15 is illustrated in accordance with the present invention. The telecommunication system 15 generally includes international or local exchange networks (ILEC) 16 and 17, a carrier network or private branch exchange (PBX) network 18, other carrier networks 19 (one being shown), a telecommunications node 20, an electronic network 22, one or more content or sponsor providers 23 (one being shown), interexchange carrier network (IXC) or long distance carrier network 24, voice over internet protocol (VOIP) devices 25 and 26, one or more calling communication devices 27, one or more called communication devices 28, and a paging system 29. The communication devices 27 and 28 can include one or more landline devices 31 (i.e., home phones, work phones, computers, facsimile machines, pay phones), wireless devices 32 (i.e., mobile phones, trunked radios, handheld devices, PIM etc.), network access device (i.e. computers), and pagers.

The ILECs 16 and 17 of the telecommunication system 15 are preferably connected to the carrier network 18 by a plurality of telephone trunks or lines 34 and 35, such as, T1 lines or an integrated services digital networks (ISDN PRI). The ILECs 16 and 17 are also connected to the landline communication devices 31 and are in communication with the wireless devices 32 via a mobile switching center (MSC) 34. The ILECs 16 and 17 can also be connected to various satellite systems and other switching centers, such as, conventional or trunked radio systems (not shown).

The ILEC 16 routes incoming calls from the calling communication devices 27 to the carrier network 18, and the ILEC 17 routes outgoing calls from the carrier network 18 to the called communication device 28. It will be recognized that incoming calls from the calling communication devices 27 can be routed directly to the carrier network 18, and outbound calls from the carrier network 18 can be routed directly to the called communication devices 28.

The IXC 24 of the telecommunication system 15 is preferably connected to the carrier network 18. The IXC 24 can receive outgoing calls from the carrier network 18 and can route to the outgoing call back to the carrier network 18 or to other carrier networks 19. The IXC 24 can also receive incoming calls from the carrier networks 19 and route the calls to the carrier network 18. The IXC 24 is preferably a long distance carrier network provider, such as, Sprint, AT&T, Qwest Communications, or MCI.

The carrier network 18 of the telecommunication system 15 generally includes a telephone switching system or central office 36. It will be recognized that the telephone switching system 36 can be any suitable telephone switching system. The carrier network 18 preferably routes incoming or inbound calls from the ILEC 16 or IXC 24 to the telecommunication node 20 over one or more telephone lines or trunks 38. The incoming calls directed to the telecommunication node 20 preferably enter the carrier network 18 through one or more “888” or “800” INWATS trunk lines, local exchange trunk lines, or long distance trunk lines. The carrier network 18 also routes outbound calls from the telecommunication node 20 over one or more telephone lines or trunks 35 to the ILEC 17 or the IXC 24. When the carrier network 18 receives an outbound call from the telecommunication node, the carrier network 18 routes the call to an appropriate destination (i.e., a called party's home phone, work phone, mobile phone, etc.) via the ILEC 17 or IXC 14. It is contemplated that the carrier network 18 can be any suitable system that can route incoming calls to the telecommunication node 20 and can route outbound calls to the proper destination.

The telecommunication node 20 of the telecommunication system 15 is preferably connected to the carrier network 18, the electronic network 22, and the content provider 23. The telecommunication node 20 processes inbound calls from the carrier network 26 and the electronic network 22 and receives paging requests from the paging system 29 as further described below.

The VOIP device 25 of the telecommunication system 15 is preferably connected to the electronic network 22 and to one or more of the called communication devices 27 (i.e., telephones, computers, handheld devices, etc.). The VOIP device 25 converts voice communications to VOIP protocol (i.e., H.323 protocol). The VOIP protocol is then transmitted to the telecommunication node 20 via the electronic network 20. The telecommunication node 20 preferably converts the VOIP protocol to voice communications.

The VOIP device 26 of the telecommunication network 15 is preferably connected to the electronic network 22 and to one or more of the called communication devices 28 (i.e., computers, handheld devices, etc.). The VOIP 26 receives a VOIP protocol from the telecommunication node 20 via the electronic network 22 and converts the VOIP protocol to voice communications. The voice communications are transmitted to one or more of the communication devices 28. It will be recognized that the VOIP devices 25 and 26 can be incorporated into the calling and called communication devices 27 and 28. The electronic network can also be connected to a network access apparatus 22. The network access apparatus can access the node via the electronic network. The network access apparatus 22 can navigate or access information provided by the node. The network access apparatus can be any suitable device to access the electronic network and can include an optical scanner or bar code reader to read machine readable data, magnetic data, optical data, etc. Therefore, the network access apparatus could read or scan a bar code and then access a particular designation or database of the node (i.e., a menu of a restaurant, banking information, a web page of the telecommunication node, weather information, etc.).

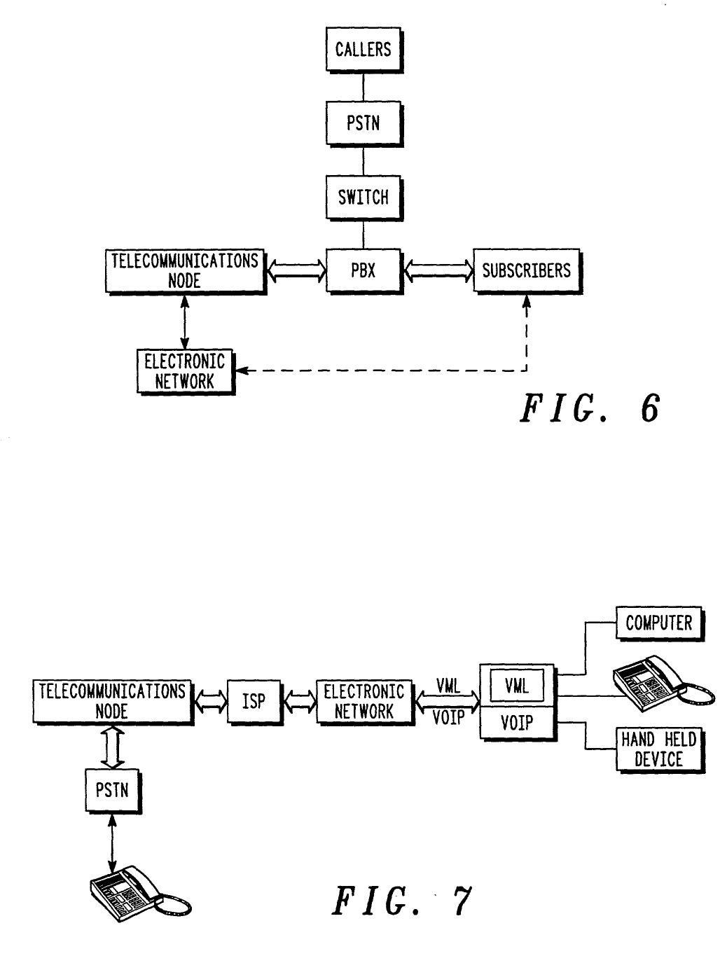

Although one embodiment of the telecommunication system 15 is shown in FIG. 2, the telecommunication system 15 can be arranged in a variety of configurations. For example, the telecommunication node can be remotely located from a carrier network as shown in FIG. 3 or the carrier network and the telecommunication node can be co-located or integrated in the same central office or MSC as shown in FIG. 4. The telecommunication node can also be configured as a standalone system to allow users to dial directly into a telecommunication node via a toll free number or a direct access number (see FIG. 5). Furthermore, the telecommunication node can be implemented with a PBX (i.e., an enterprise network or a local area network) (see FIG. 6.) In this configuration, the system can be implemented to automatically connect a user to the telecommunication node when the user picks a communication device, such as, the phone. As shown in FIG. 7, the telecommunication node is illustrated receiving inbound calls through an electronic network (i.e., an intranet or the internet) and placing outbound calls through the electronic network.

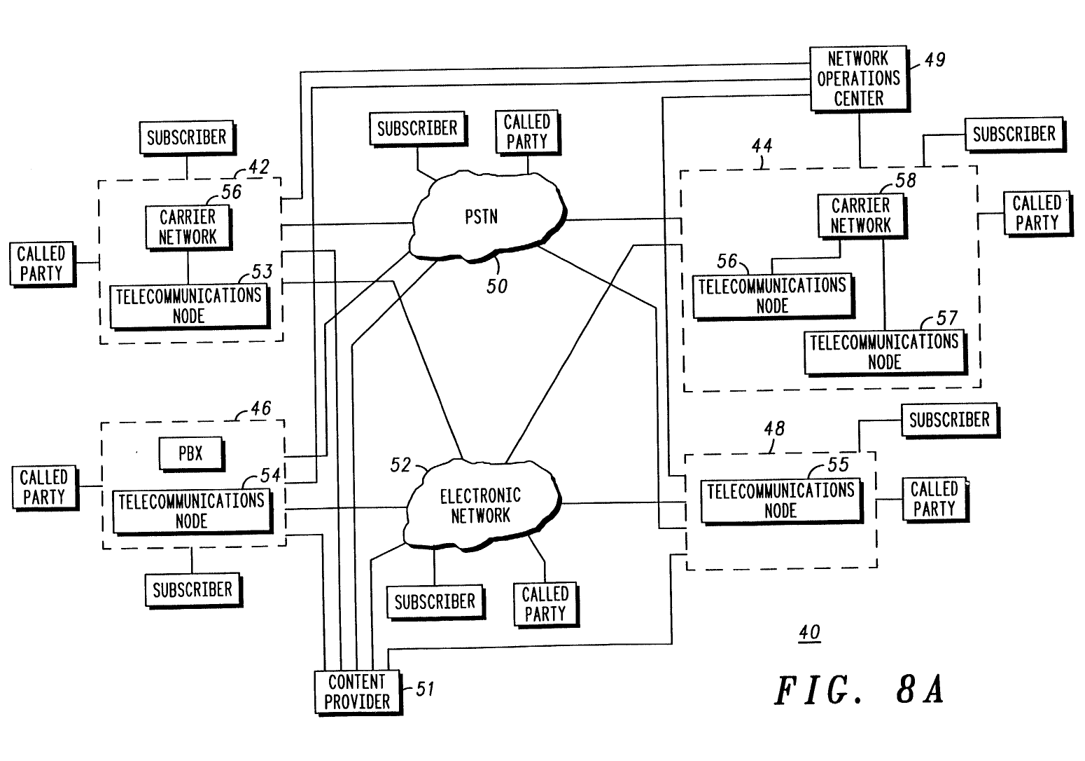

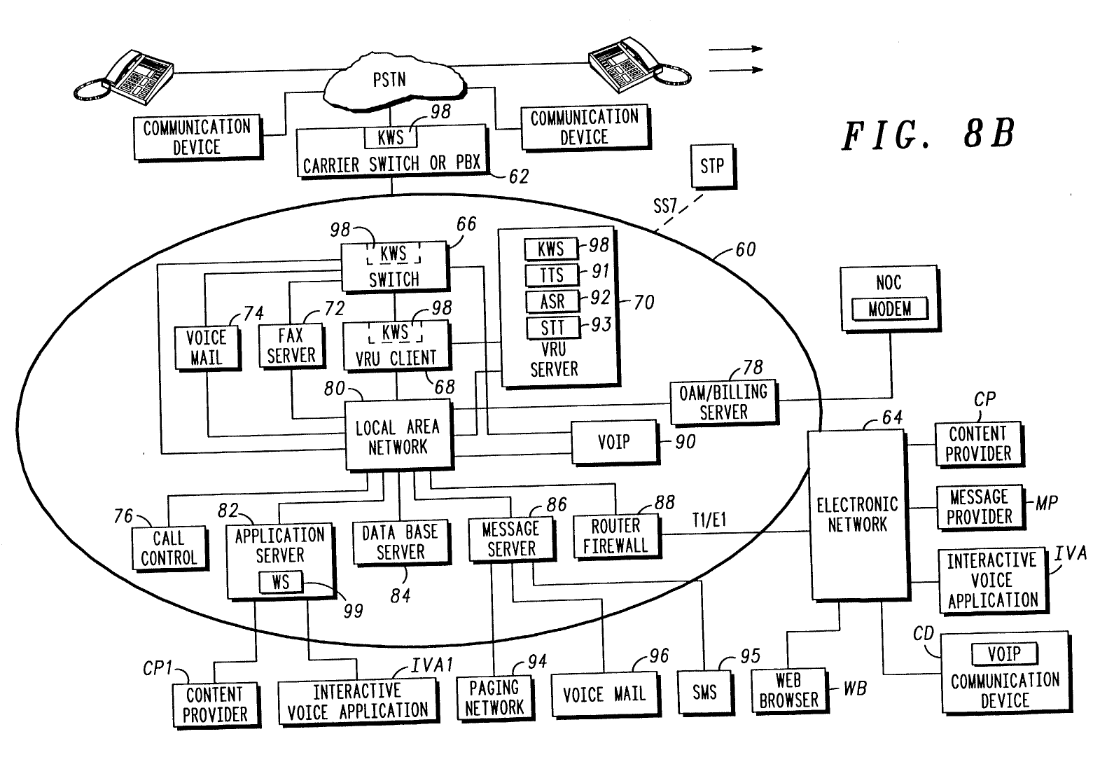

FIG. 8a illustrates an exemplary block diagram of one embodiment of a communication network 40 including a variety of different telecommunication systems configurations. As show in FIG. 8a, the communication network 40 includes a plurality of telecommunication systems 42, 44, 46 and 48, a network operations center (NOC) 49, a public switched telephone network (PSTN) 50, one or more content providers 51 (one being shown), and an electronic network 52. The communication network 40 allows a subscriber or user to access a telecommunication node of one of the telecommunication systems via the electronic network 52 and the PSTN 50. The user may also access a telecommunication node by dialing directly into one of the telecommunication systems or through a paging system. The communication network 40 can also allow users to navigate databases or web pages using speech commands or text commands (i.e., a two-way pager).

The telecommunication systems 42, 44, 46, and 48 are preferably connected to the NOC 49, the electronic network 52, the PSTN 50, and the content provider 51. Each of the telecommunication systems preferably includes one or more telecommunication nodes 53, 54, 55, 56, and 57. It is contemplated that the telecommunication systems 42, 44, 46, and 48 may include any suitable number of telecommunication nodes. For example, the telecommunication system 44 includes two telecommunication nodes 56 and 57.

As shown in FIG. 8a, the telecommunication node 53 of the telecommunication system 42 is connected to a carrier network 56, and the telecommunication nodes 56 and 57 of the telecommunication system 44 are connected to a carrier network 58. The carrier networks 56 and 58 route incoming calls to the respective telecommunication node. The telecommunication nodes of the telecommunication systems 66 and 68 are preferably accessed by dialing a toll free number, direct access number, or a PBX number or via the electronic network or the paging system.

FIG. 8b shows an exemplary block diagram of a telecommunication node 60 in accordance with a preferred embodiment of the present invention. The telecommunication node 60 is preferably configured to receive and process incoming calls from a carrier switch or PBX 62 and an electronic network 64, such as, an intranet, the internet, or the WWW. The node also processes paging requests from the paging network. The node 60 can place outgoing calls to the carrier switch 62 and/or the electronic network 64 and send textual messages to the paging network. It will be recognized that the carrier switch 62 can be part of a carrier network.

The telecommunication node 60 preferably includes a telephone switch 66, a voice or audio recognition (VRU) client 68, a voice recognition (VRU) server 70, a facsimile server unit 72, a voice mail server unit 74, a controller or call control unit 76, a Operation and Maintenance Office (OAM), billing server unit 78, a local area network (LAN) 80, an application server unit 82, a database server unit 84, a message server unit 86, a gateway server or router firewall server 88, and a voice over internet protocol (VOIP) unit 90. It will be recognized that the telecommunication node 60 can be co-located with a carrier network (i.e., an integral part of the network) as shown in FIG. 4 or can be located at a remote site from a carrier network as shown in FIG. 3.

Although the telecommunication node 60 is shown as being constructed with various types of independent and separate units or devices, the telecommunication node 60 can be implemented by one or more integrated circuits, microprocessors, microcontrollers, or computers which may be programmed to execute the operations or functions equivalent to those performed by the circuits or units shown. It will also be recognized that the node 60 can be carried out in the form of hardware components and circuit designs, software or computer programming, or a combination thereof. The telecommunication node 60 can also be implemented with a PBX or enterprise connection, or a standalone system (i.e., direct number access) as described above.

The telephone switch 66 of the telecommunication node 60 is preferably connected to the VRU client 68, the VOIP unit 90, the LAN 80, the voice mail unit 74, and the fax server unit 72. The telephone switch 66 receives incoming calls from the carrier switch over a digital transmission line (i.e., a T1 line). The switch 66 also receives calls routed over the electronic network via the VOIP unit 90. The telephone switch 66 is preferably a digital cross-connect switch, Model No. LNX, available from Excel Switching Corporation, 255 Independence Drive, Hyannis, Mass. 02601. It will be recognized that the telephone switch 66 can be any suitable telephone switch.

When the telephone switch 66 receives an incoming call from the carrier network 62, the call control unit 76 sets up a connection in the switch 66 to the VRU client 68. The telecommunication node 60 then enters into a dialog with the user regarding various services and functions. The VRU client 68 preferably generates prerecorded voice announcements and/or messages stored in the database server unit 84 to prompt the user to provide information to the telecommunication node using speech or voice commands or DTMF tones.

The VRU client 68 of the telecommunication node 60 is preferably connected to the VRU server 70 and the LAN 80. The VRU client processes speech communications from the user and DTMF tones from various communication devices. Upon receiving speech communications, the VRU client routes the speech communications to the VRU server. When the VRU client 68 detects DTMF tones, the VRU client 68 sends a command to the call control 76.

The VRU client 68 preferably comprises a computer, such as, a Windows NT compatible computer with hardware capable of connecting individual telephone lines or directly to the switch 66. The VRU client preferably includes a microprocessor, random access memory, read-only memory, a T1 or ISDN interface board, and one or more voice communication processing board (not shown). The voice communication processing boards of the VRU client 68 are preferably Dialogic boards, Model No. Antares, available from Dialogic Corporation, 1515 Route 10, Parsippany, N.J. 07054. The voice communication boards may include a voice recognition engine with a limited vocabulary for detecting a speech pattern (i.e., a key word or phrase). The voice recognition engine is preferably a RecServer software package, available from Nuance Communications, 1380 Willow Road, Menlo Park, Calif. 94025.

The VRU client can also include an echo canceler to reduce or cancel text-to-speech or playback echoes transmitted from the PSTN due to hybrid impedance mismatches. The echo canceler is preferably included in an Antares Board Support Package, available from Dialogic.

The call control unit 76 of the telecommunication node 60 is preferably connected to the LAN 80. The call control unit 76 sets up the telephone switch 66 to connect incoming calls to the VRU client 68. The call control unit 76 also sets up the telephone switch 66 to route outgoing calls to the carrier switch 62 or to the electronic network 64 via the VOIP unit 90. The call control unit further sets up incoming calls into the node 60 from the electronic network 64 and sets up paging requests from the paging network. The control call unit 74 preferably comprises a computer, such as, a Window NT compatible computer.

The LAN 80 of the telecommunication node 60 allows the various components and devices of the node 60 to communicate with each other via a twisted pair, a fiber optic cable, or coaxial cable.

The LAN 80 is preferably a 100 Megabit per second Ethernet switch, available from Cisco Systems, San Jose, California. It will be recognized that the LAN 80 can comprise any suitable network system and the telecommunication node 60 may include a plurality of LANs.

The VRU server 70 of the telecommunication node 60 is connected to the VRU client 68 and the LAN 80. The VRU server 70 receives speech communications from the user via the VRU client 68. The VRU server 70 processes the speech communications and compares the speech communications against a vocabulary or grammar stored in the database server unit 84.

The VRU server 70 provides output signals, representing the result of the speech processing to the LAN 80. The LAN 80 routes the output signal to the call control unit 76. The call control unit 76 processes the output signals and causes the telecommunication node 60 to perform a specific function associated with the output signals.

The VRU server 70 preferably includes a text-to-speech (TTS) unit 91, an automatic speech recognition (ASR) unit 92, and a speech-to-text (STT) unit 93. The TTS unit 91 of the VRU server 70 receives textual information from the application server unit 82, the database server unit 84, the message server unit 86, the call control unit 76, and the gateway server 88. The TTS unit 91 processes the information and converts the textual data or information, to voice data or information (i.e., e-mail, web pages, faxes, etc.).

The TTS unit 91 can provide the voice information to the VRU client 68 which reads the voice information to the user. For example, when the user requests content information (i.e., news updates, stock information, traffic conditions, etc.), the telecommunication node 60 retrieves the desired textual information and converts the textual information via the TTS unit 91 into voice information. The voice information is then sent to the VRU client 68. The VRU client processes the voice information and reads the voice information to the user. The TTS unit 91 is preferably a TTS 2000 software package, available from Lernout and Hauspie Speech Product NV, 52 Third Avenue, Burlington, Mass. 01803.

The ASR unit 92 of the VRU server 70 provides speaker independent automatic speech recognition of speech communications from the user. The ASR unit 92 processes the speech communications from the user to determine whether the words or speech pattern match any of the grammars or vocabulary stored in the database server unit 84. When the ASR unit 92 identifies a selected speech pattern of the user, the ASR unit 92 sends an output signal to the call control unit 76 to implement the specific function associated with the recognized voice pattern. The ASR unit 91 is preferably a speaker independent speech recognition software package, Model No. RecServer, available from Nuance Communications. It is contemplated that the ASR unit 92 can be any suitable speech recognition unit to detect voice communications from a user.

The STT unit 93 of the VRU server 70 receives speech communications from the user and converts the speech communications to textual information (i.e., a text message). The text information can be sent or routed to various communication devices or designations. For example, the textual information can be routed to a paging network 94, a short message service (SMS) 95, and/or an external voice mail system 96 via the message server unit 86. The textual message can also be routed to the electronic network via the gateway server 88. The electronic network 64 can route the text information to message providers MP (i.e., an email address), communication devices CD, (i.e., a cell phone, a computer, a PIM, etc.), content providers CP, and/or an interactive voice applications service providers IVA. The STT unit 93 is preferably a Naturally Speaking software package, available from Dragon Systems, 320 Nevada Street, Newton, Mass. 02160-9803.

The message server unit 86 of the telecommunication node 60 is preferably connected to the LAN 80 and to various messaging networks and/or systems. The message server unit 86 can preferably route messages to the paging network 94, the voice mail system 96, and the SMS 95. The message server unit 86 can also automatically forward the ANI number of the communication device to the messaging networks 94, 96, and 95. The message server unit can include a paging encoder that encodes the messages into selected call communication protocols, such as POCSAG protocol or Motorola's FLEX protocol. The message server unit 86 preferably comprises a computer, such as, an NT Window compatible computer.

The voice mail unit 74 of the telecommunication node 60 is preferably connected to the telephone switch 68 and the LAN 80. The voice mail unit 74 can store voice mail messages from users or other parties trying to send messages to users of the node. When a user accesses the telecommunication node 60, the voice mail unit 74 can notify the user of new and stored messages. The user can access the messages to play, delete, store and forward the messaged. When the user accesses a message, the message can be read to the user or can be displayed as textual information on a communication device (i.e., a pager, a SMS, or a PDA, etc.). The user can also access and operate external messages or mail systems remote from the telecommunication node 60.

The fax server unit 72 of the telecommunication node 60 is preferably connected to the telephone switch 66 and the LAN 80. The fax server unit 72 receivers and stores facsimile information sent via the electronic network 64 or the carrier switch 62. The users can access the facsimile information to play, store, delete, and forward the information. The facsimile information can be read to the user via the TTS unit 91 or can be displayed as textual information on a suitable communication device. The fax server unit 72 preferably comprises a computer such as, an NT compatible computer or a Dialogue Fax Server.

The VOIP unit 90 of the telecommunication node 60 is preferably connected to the telephone switch 66 and the LAN 80. The VOIP unit 90 can receive speech communications from the user and preferably convert the speech communication to a VOIP protocol (i.e., a H.323 protocol) that can be transmitted over the electronic network 64 to other called parties and communication devices. The VOIP unit 90 can also receive VOIP protocols transmitted over the electronic network 64 and can convert the VOIP protocols to speech information or data. The speech information can then be read to the user via the VRU client 68. The VOIP unit 90 is preferably a Voice Net software package, available from Dialogic Corporation.

The VOIP unit 90 allows a user to access the node 60 via the carrier switch 62 or the electronic network 64 using voice commands. For example, when the user requests to place a call to a communication device 97 connected to the electronic network 64, the call is connected to the VOIP unit 90. The VOIP unit 90 converts the voice information from the user to a VOIP protocol. The VOIP unit 90 sends the VOIP protocol to the electronic network 64 via the gateway server unit 88. The electronic network 64 routes the VOIP protocol to a VOIP unit associated with the communication device CD. The VOIP unit converts the VOIP protocol to voice communications and transmits the voice communications to the called party.

The telecommunication node 60 also includes a detection unit 90 (four being shown). The detection unit 90 is preferably a phrase or key word spotter unit to detect incoming voice communications from the user. The detection unit records the voice communications and compares the voice communications to the vocabulary or grammar stored in the database server unit 84. The detector unit continuously monitors the user's speech for a key phase or word after the user is connected to an outbound call. When the key phrase or word is detected by the detection unit 98, the VRU client 68 plays a pre-recorded message to the user. The VRU client then responds to speech commands or DTMF tones provided by the user. The detector unit 99 is preferably incorporated into the switch 66, but can be incorporated into the VRU client 68, the carrier switch 62, or the VRU server 70. The detection unit 98 is preferably included in a RecServer software package, available from Nuance Communications.

The billing server unit 78 of the telecommunication node 60 is preferably connected to the LAN 80. The billing server unit 78 can record data about the use of the node by a user (i.e., length of calls, long distance charges, features accessed by the user, etc.). Upon completion of a call by a user, the call control unit 76 sends data to the billing server unit 78. The data can be subsequently processed by the billing server unit in order to prepare customer bills. The billing server unit 78 uses the ANI or CLI to properly bill the user. The billing server unit 78 preferably comprises a Windows NT compatible computer.

The gateway server unit 88 of the telecommunication network 60 is preferably connected to the LAN 80 and the electronic network 64. The gateway server unit 88 provides access CD via the electronic network 64 to the content service providers CP, message providers MP, interactive voice applications service providers IVA, and communication devices. The content providers, the message providers, and an interactive voice applications service providers can provide various information to the node 60 and allow the user to implement various functions and services. For example, the user can access the interactive voice applications to order flowers, pizza, etc. The telecommunication node 60 can also retrieve messages from the message providers and provide the messages to the user as textual information or voice communications.

The gateway unit 88 also allows users to access the telecommunication node over the electronic network 64. For example, the user can access the database server unit using a web browser WB, such as, for example, a Netscape Navigator® web browser, a Microsoft Internet Explorer® web browser, a Mosaic® web browser, etc. The gateway unit 88 can also function as a firewall to control access to the telecommunication node to authorized users. The gateway unit 88 is preferably a Cisco Router, available from Cisco Systems.

The application server 82 of the telecommunication node 60 is preferably connected to the LAN 80, content providers CPI, and interactive voice application service providers IVAL. The application server 82 preferably includes a voice browser. The application server 82 allows the node 60 to communicate with the content providers and the interactive voice applications service providers. For example, the application server 82 can process request from the user (i.e., speech commands, textual commands, DTMF tones, etc.) and can retrieve information from the content providers and databases of the telecommunication node (i.e., weather reports, stock information, traffic reports, restaurants, flower shops, Banks, etc.). The application server 82 processes the retrieved information to allow users to access the information from a communication device, such as a pager, a mobile phone, an network access device, etc. The application server 82 can also send requests from the user to the content providers (i.e., a request to place an order for a pizza) and interactive voice applications service providers. In addition, the application server 8L includes a web site (WS) 99 that can be accessed by the user. The software routines shown in the flow diagrams below are executed by the application server.

The database server unit 84 of the telecommunication node 60 is preferably connected to the LAN 80. The database server unit 84 preferably includes a plurality of storage areas to store data relating to users, contacts of the users, and other information. Preferably, the database server unit 84 stores a personal file or address book. The personal address book contains information required for the operation of the system, including phone numbers of contacts, user reference numbers, personal access codes, personal account information, etc. The database server unit 84 is preferably a computer, such as an NT Window compatible computer.

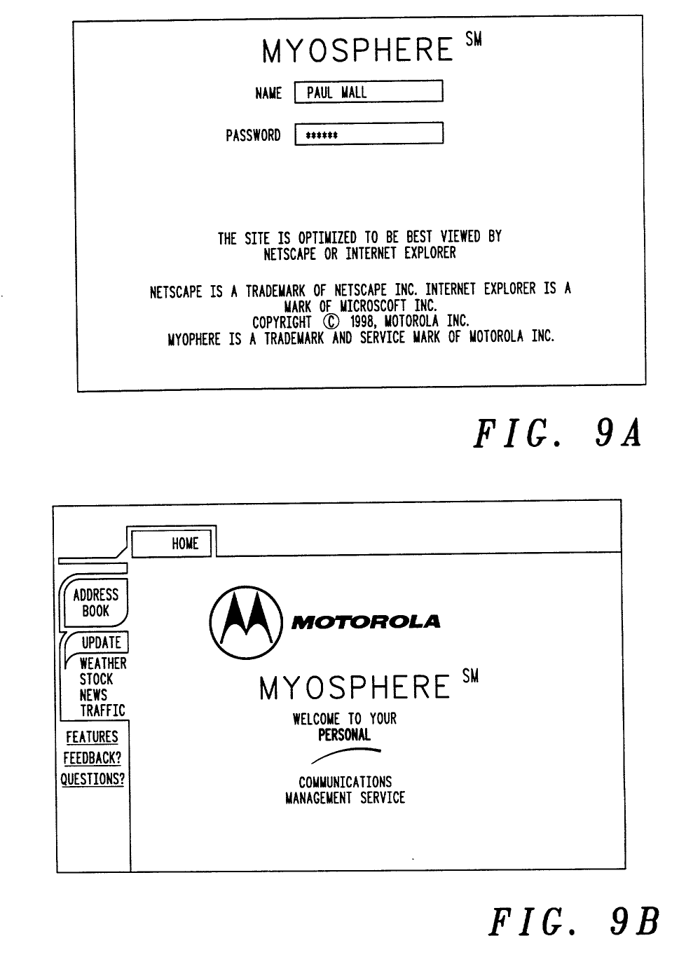

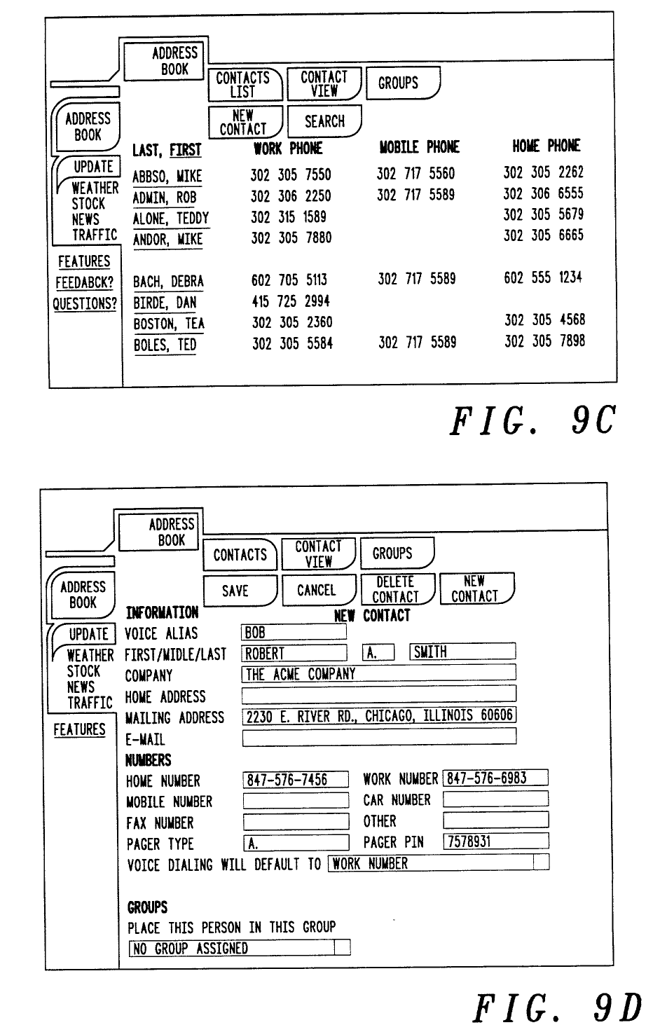

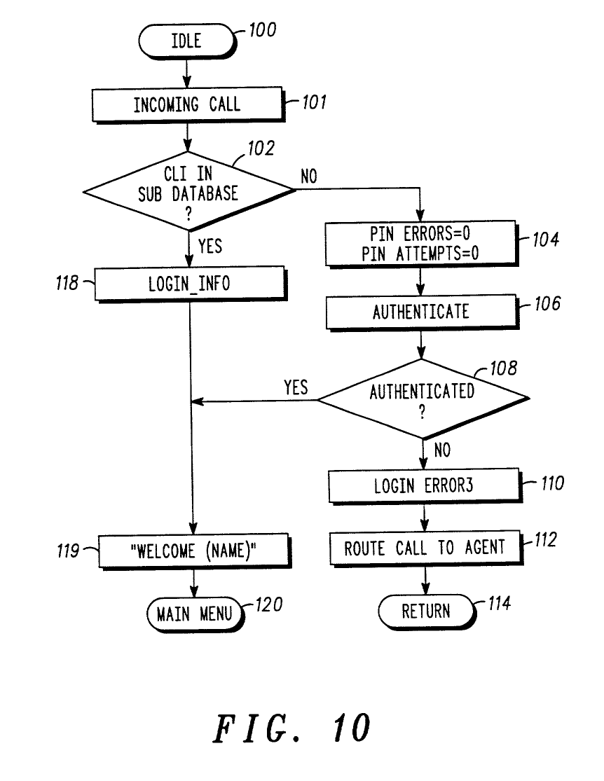

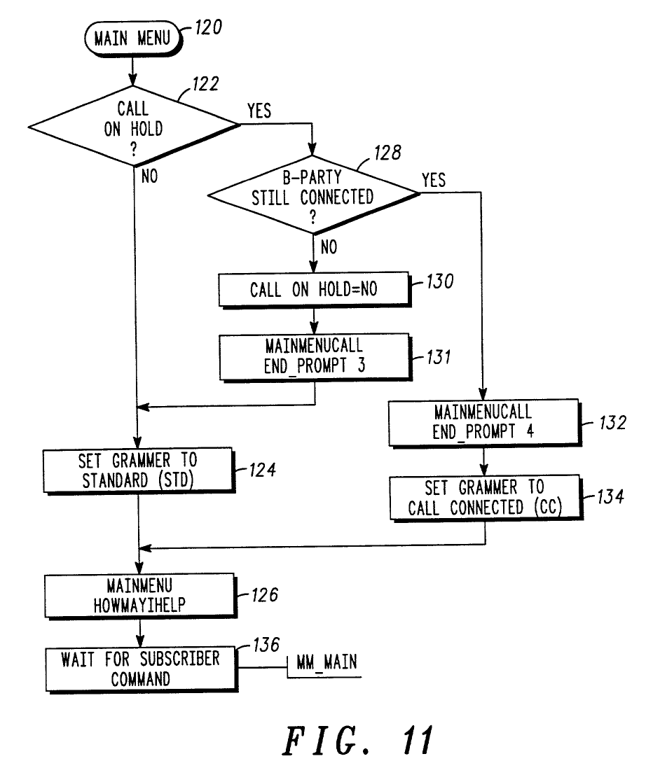

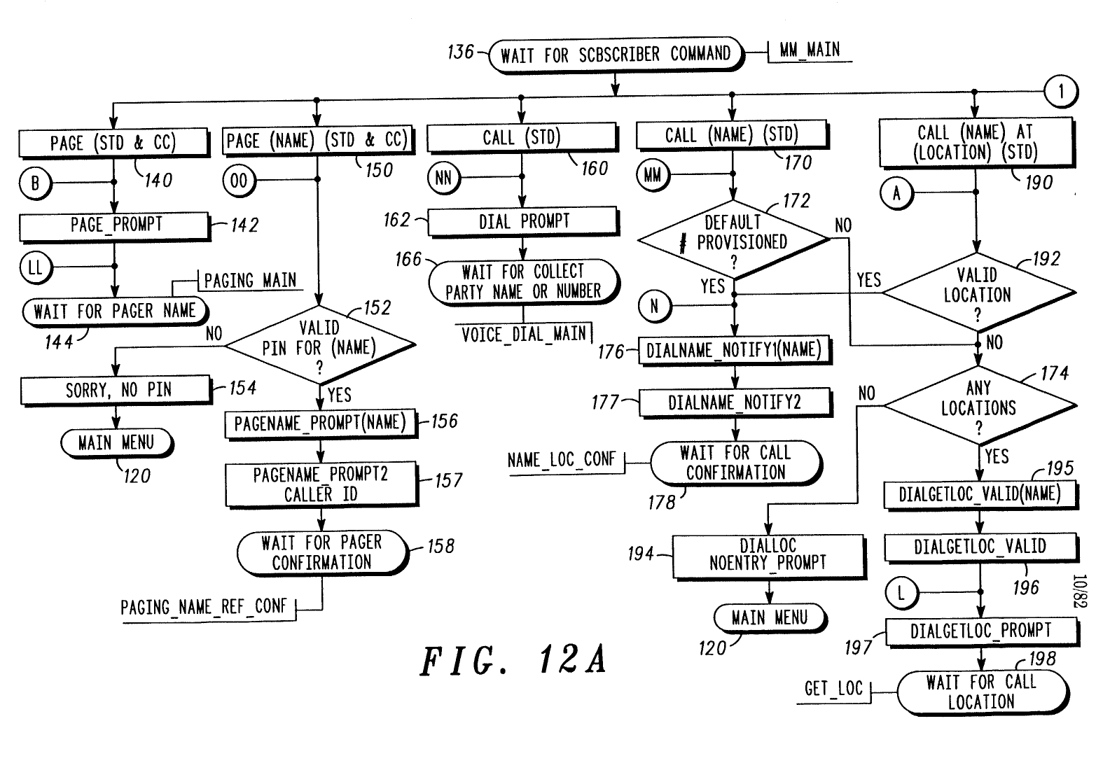

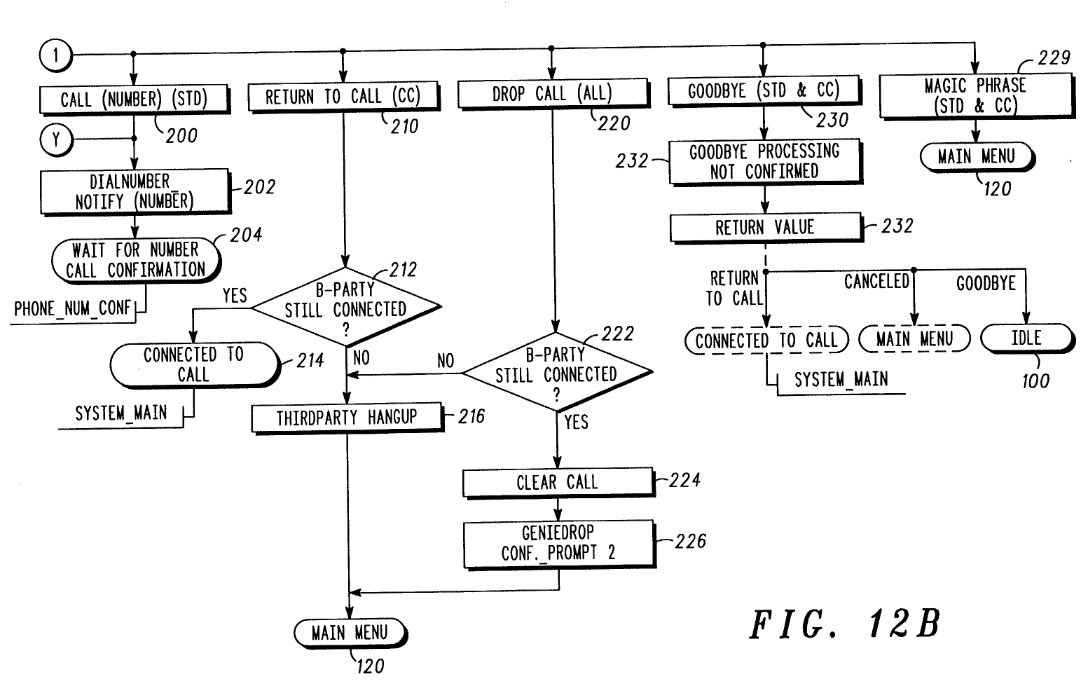

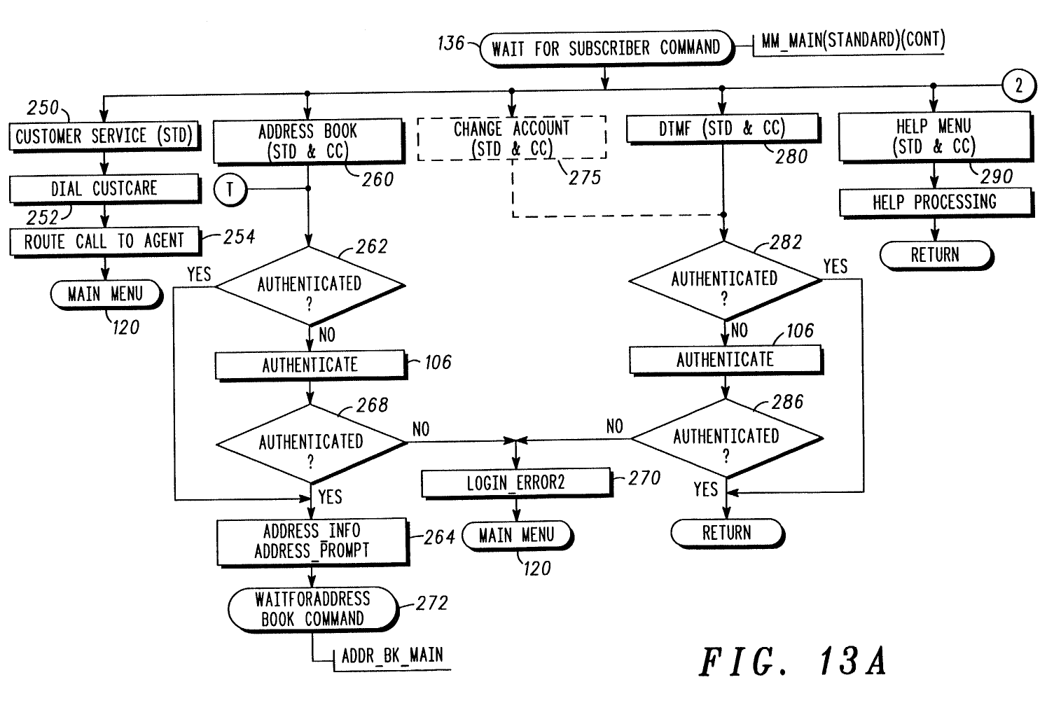

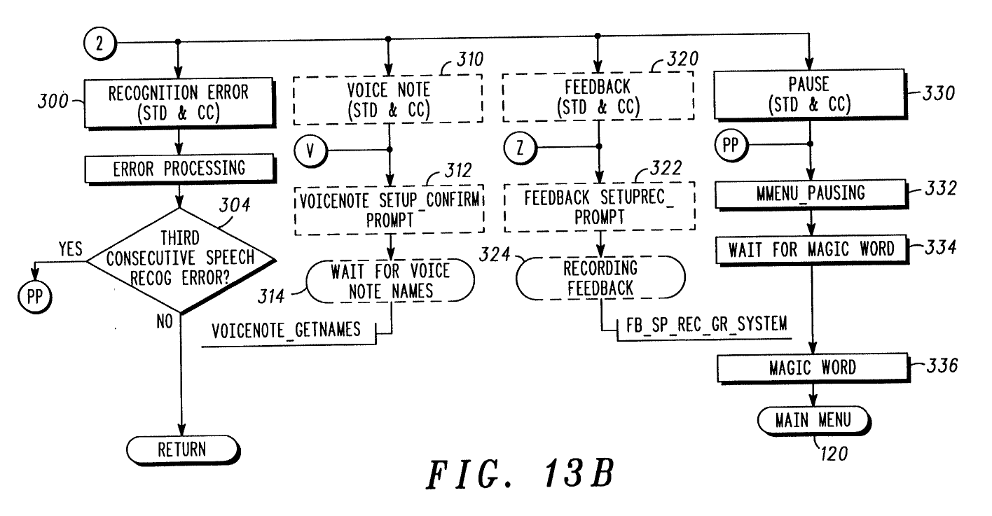

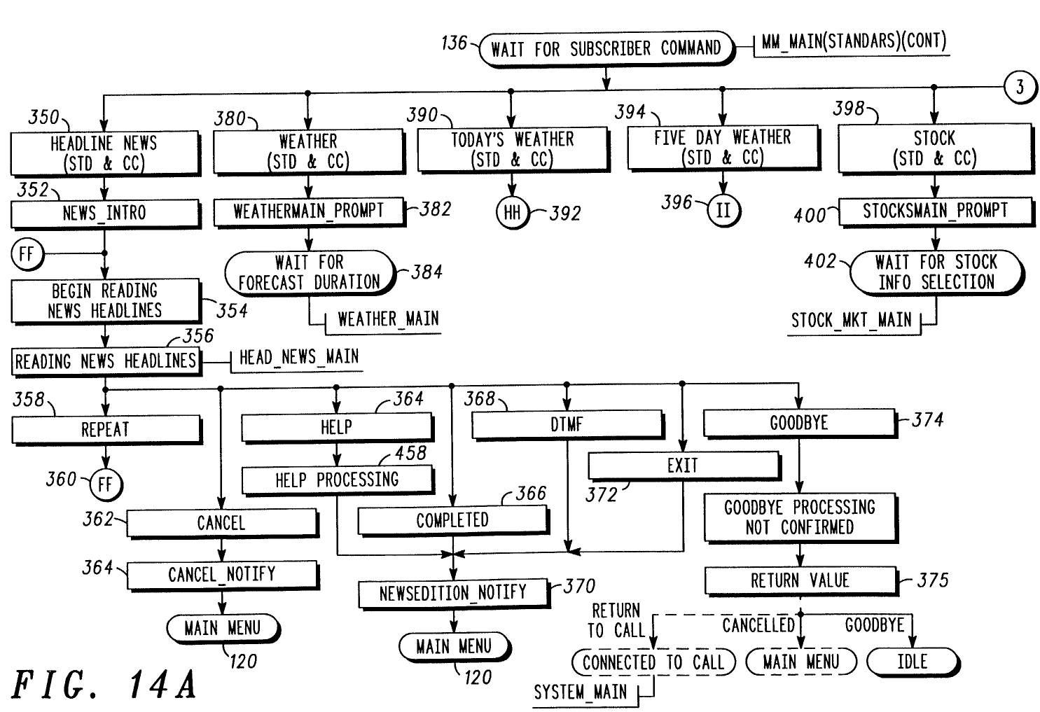

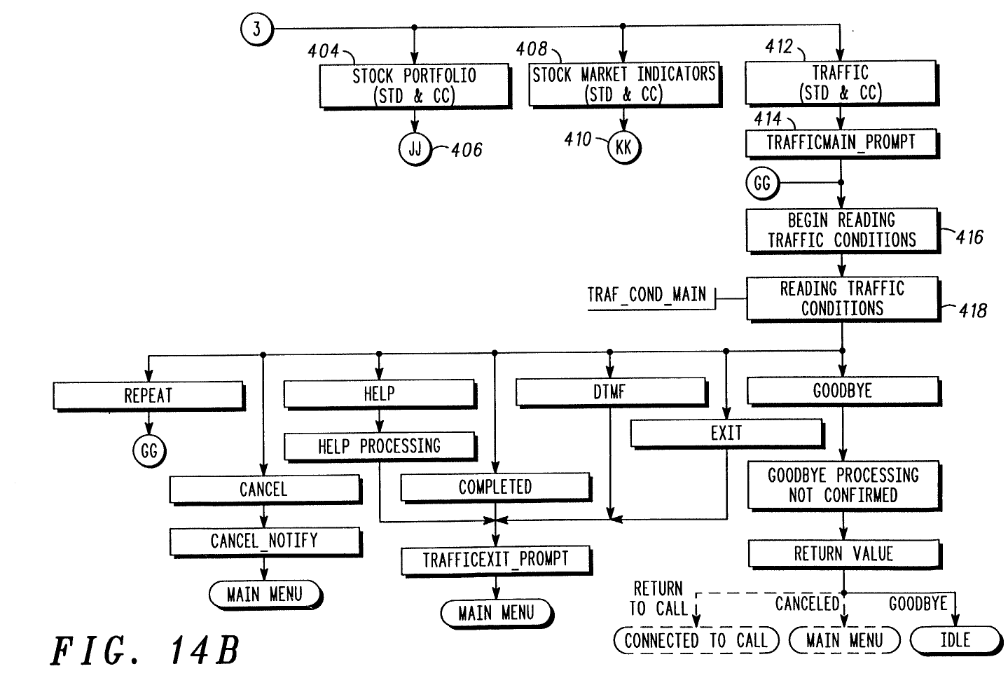

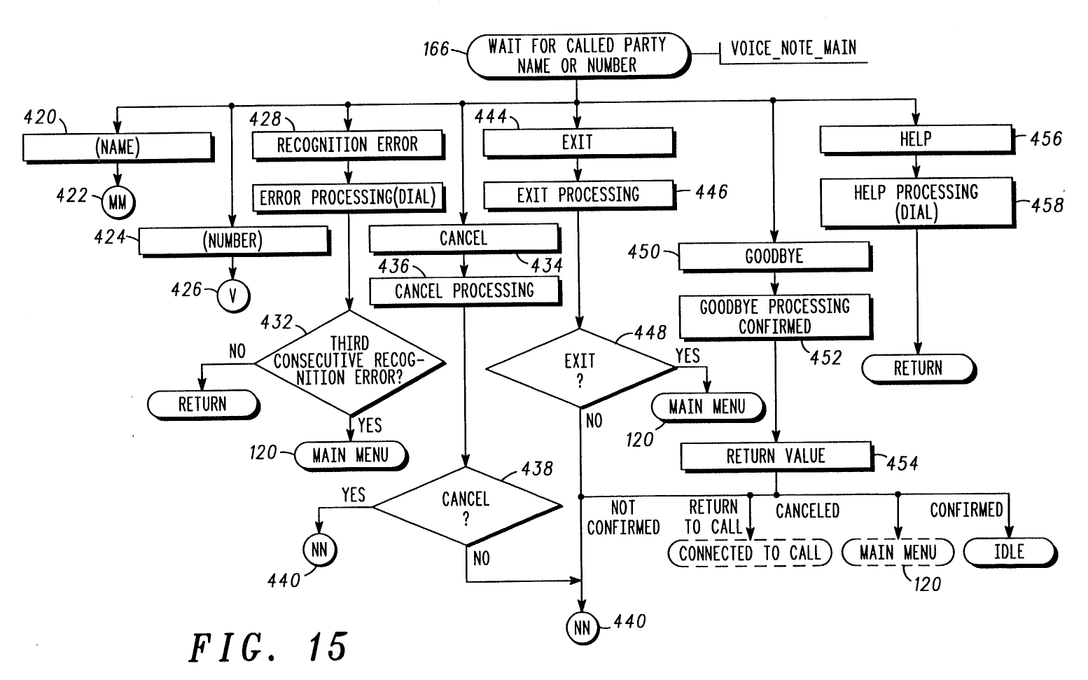

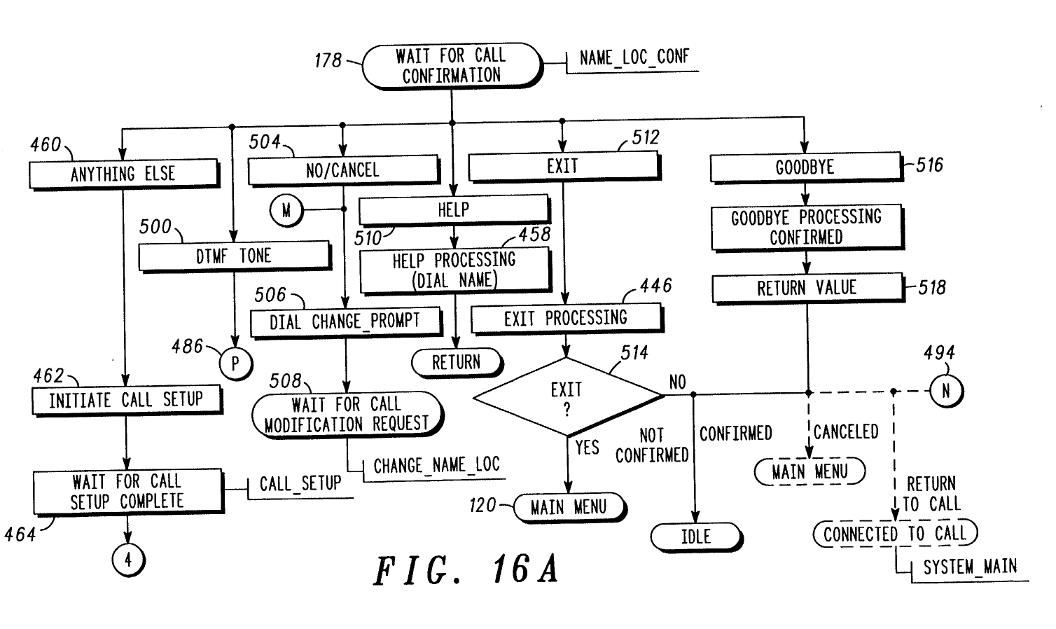

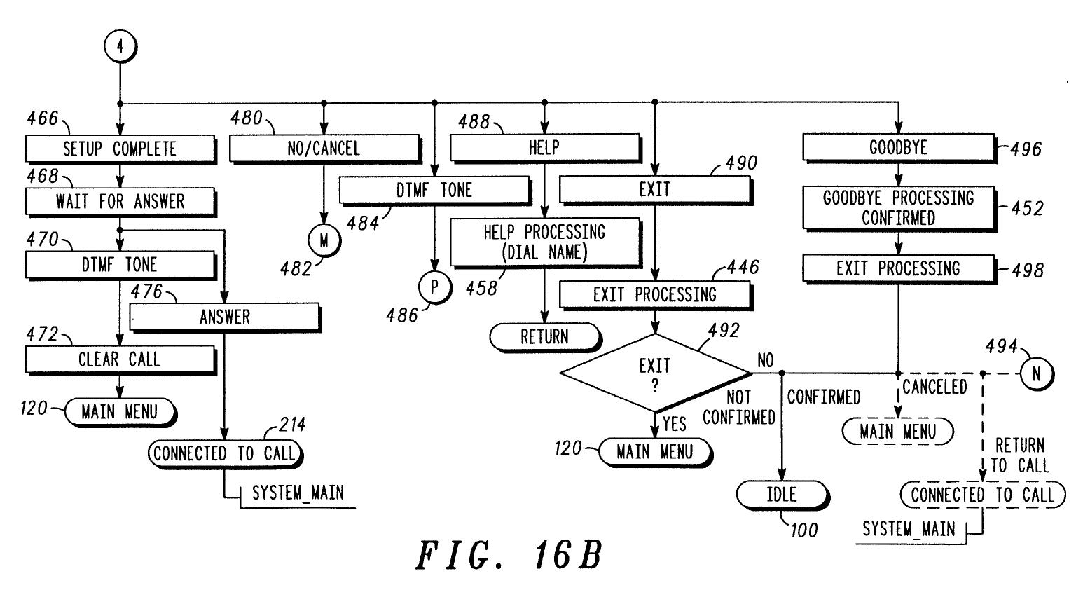

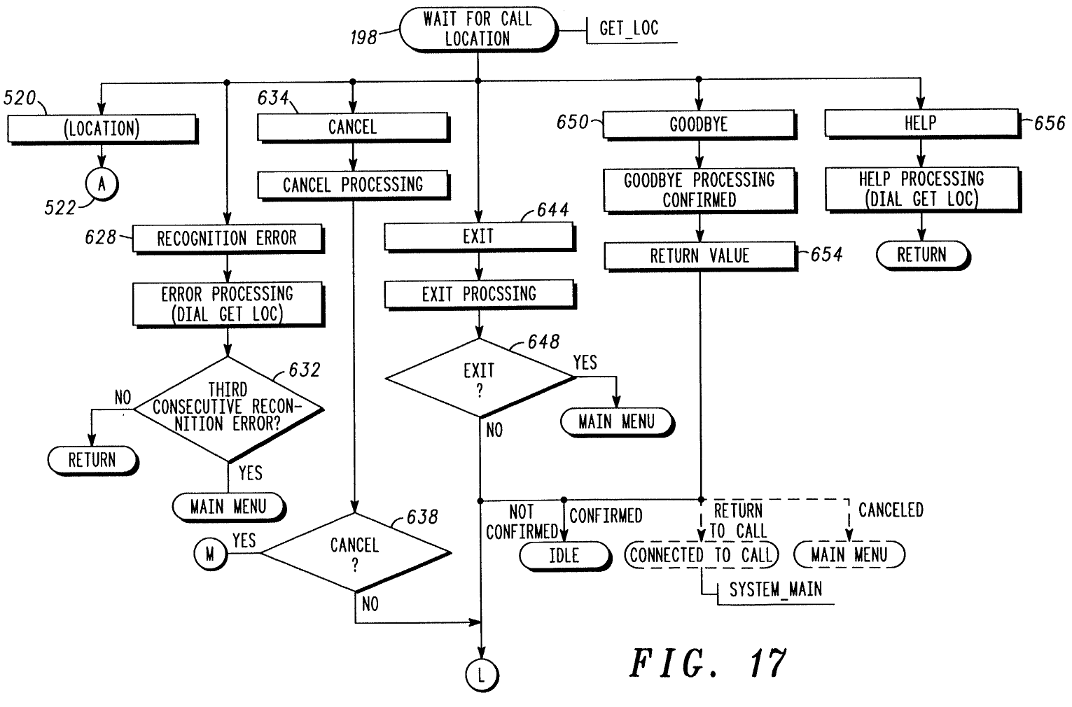

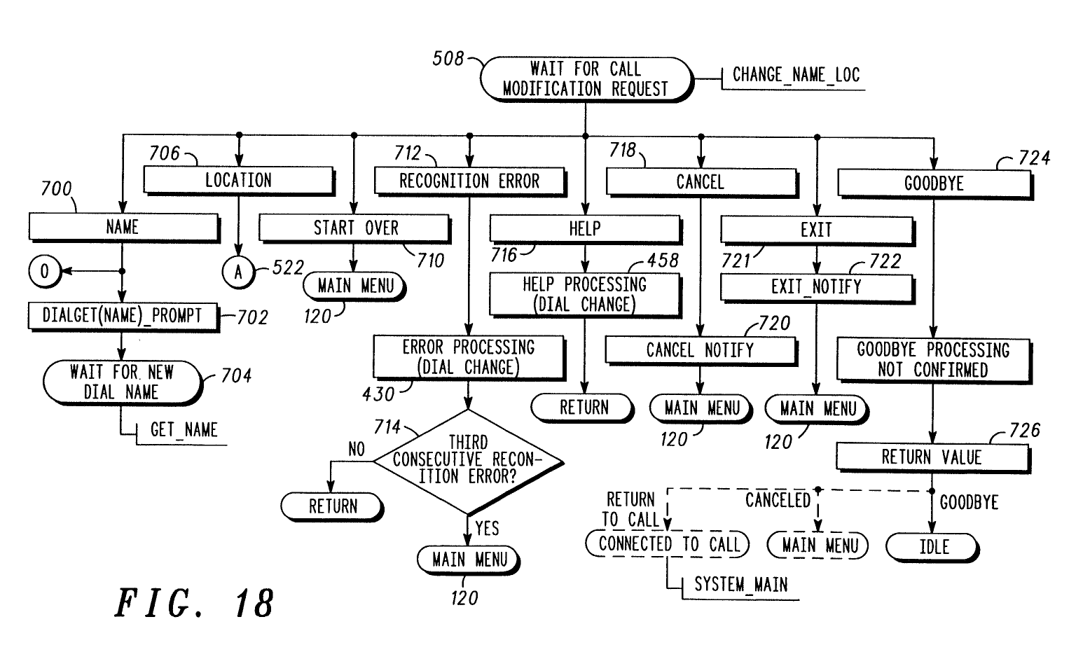

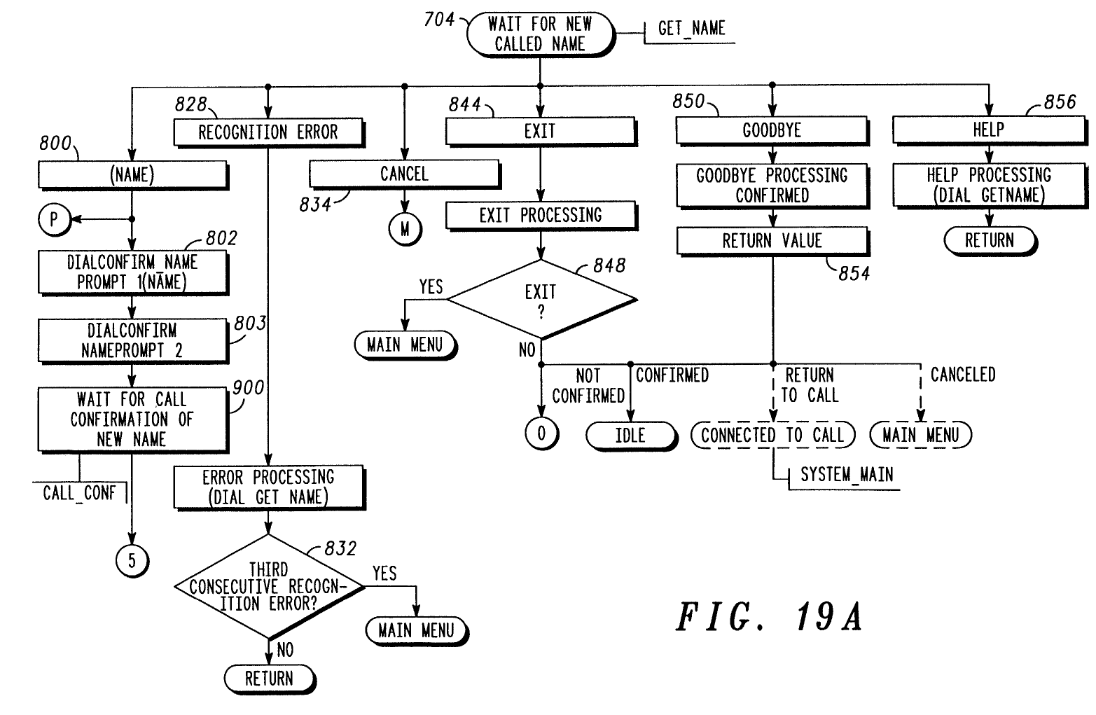

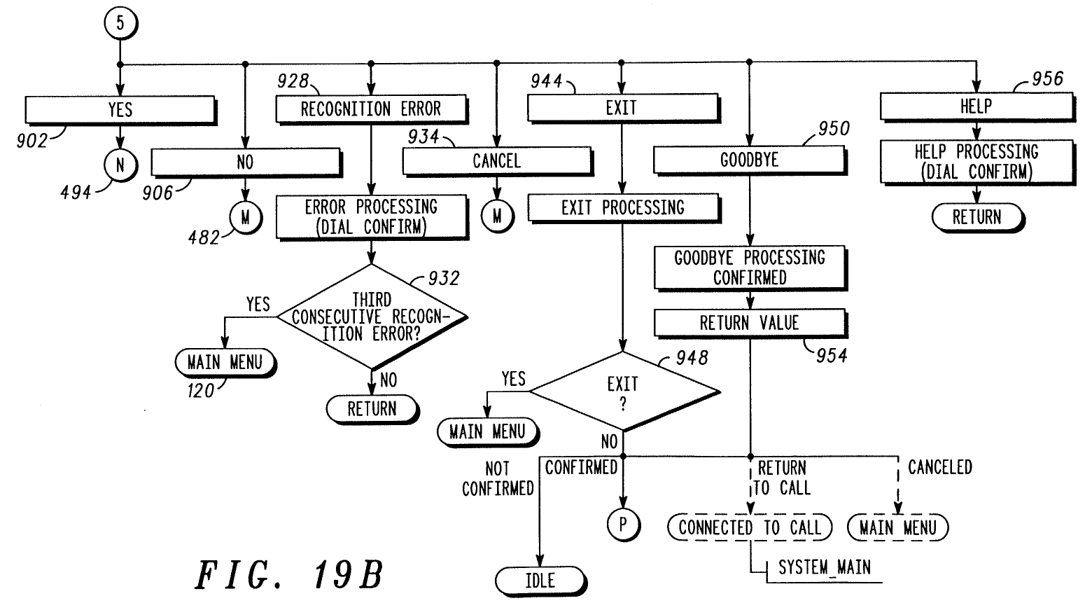

The user can access his or her personal address book by entering the uniform resource location (URL) address of the web site 99 of the telecommunication node 60 (i.e., Error! Bookmark not defined.) into a web browser (i.e., a Netscape Navigator® web browser, a Microsoft Internet Explorer® web browser), or into any suitable internet service (i.e., America On-Line® service). Once the user accesses the web site 99, a welcome page will be displayed by the web browser as shown in FIG. 9a. At the welcome page, the user can enter his or her name and password or PIN. Once the user enters his or her name and password, the user can then access the home page of the web site as shown in FIG. 9b.

At the home page, the user can interact, for example, by clicking on images or text displayed on the home page to access various services of the telecommunication node. For example, the user can click on: (1) “news” to review the current news headlines; (2) “weather” to review the weather forecasts for a particular geographic region (i.e., current weather or extended weather forecasts for Chicago); (3) “traffic” to review the current traffic conditions for a selected geographic area (i.e., the traffic reports for the Chicago area or traffic reports for a specific highway or expressway, such as, the Eisenhower expressway); and (4) “stocks” to review stock information (i.e., market indicators and stock portfolios).

When the user clicks on “My Account” on the home page, the web browser will display a personal account web page (not shown) that stores the home, office, mobile, and other phone numbers of the user. The telecommunication node can use these phone numbers to automatically identify the user through CLI when the user dials into the system from a communication device having one of the phone numbers stored in the user's personal account. The personal account web page can also store the pager PIN number and fax number of the user and display account status, usage, and billing information. It is also contemplated that the user can enter various information to customize the system for his or her use. For example, the user can select various personalities (i.e., male or female voices), languages (i.e. English, French, etc.), accents, speech patterns, communication device types, environments, grammars, dialogs, speech models, etc.

At the home page of the web site as shown in FIG. 9b, the user can click on “address book” to view contacts and add information in the personal address book. When the user accesses his or her personal address book, the web browser will display a personal address book web page. The personal address book page shows a stored list of the user's contacts as shown in FIG. 9c. The personal address book web page displays the first and last name of each of the user's contacts. The personal address book web page also shows the various phone numbers for each contact (i.e., home phone, work phone, mobile phone, etc.). In a preferred embodiment, the user can program up to 150 contacts in the address book.

At the address book web page, the user can interact, for example, by clicking on images or text displayed on the web page to access various features of the personal address book. For example, the user can view the information of a contact (i.e., home and work addresses), search for a particular contact, and display particular groups of contacts (i.e., business contacts, family members, etc.). The user can also view weather reports, news reports, stock information, and traffic conditions as described above. In addition, the user can add new contacts to his or her personal address book and modify information about contacts contained in the personal address book. The personal address book can also be accessed by other users through a communication device and can add and modify the information contained in the personal address book using voice commands.

When the user clicks on “new contact” on the personal address book web page, the web browsers displays a new contact form as shown in FIG. 9d. The user can then enter the first, middle, and last name of the contact as well as a voice alias. The voice alias allows the user to call or page the contact without saying a contact's first and last name. For example, if the contact's name is Robert Smith, the user may enter “Bob” or “Robert” in the voice alias field. Therefore, when the user instructs the system to “call Bob” or “call Robert”, the system will dial the appropriate phone number for Robert Smith. If a name is not entered into the voice alias field, the system can identify the contact by the first and last names.

The user also can enter the following information for a contact into the new contact form: (1) company name; (2) home address; (3) mailing address; (4) e-mail address; (5) home phone number; (6) work phone number; (7) mobile phone number; (8) car phone number; (9) fax number; (10) pager type (i.e., Airtouch American Paging, Arch Communications, Metrical, PageMart, Pagenet, Skytel®, etc.) and pager PIN; (11) another phone number; (12) a long distance carrier (not shown); (13) a calling card number (not shown); and (14) a credit card number (not shown). The new contact form also allows a user to designate a particular phone number that the node automatically dials upon detection of the contact's name or voice alias (i.e., “call Bob”). The user can also place a contact into a particular group or category, such as, for example, a business or personal contact. The category can be used to screen calls to a called party.

Once the user is finished entering the information, the node can store the information in the user's address book in the database server unit. The node can access the information stored in the address book to perform various functions. For example, the node can access the user's long distance carrier in the order to route a long distance call to the user's long distance carrier. The node can also transmit the user's credit card number or calling card number to place a call or to perform a desired transaction.

FIGS. 10-42 illustrate flow diagrams showing software routines of the telecommunication node 60. The software routines are preferably executed by the application server. Referring to FIG. 10, a flow diagram of an Idle routine 100 is illustrated. The Idle routine 100 processes incoming calls from users and attempts to verify that the user is a subscriber. When the user dials the access number of the node, the incoming call is routed to the telephone switch 66 of the node 60. The call is then connected to the VRU client 68.

After the incoming call enters the node at block 101, the node reads and decodes the ANI or CLI of the call and accesses a CLI list of the subscribers stored in the database server unit of the node. The node determines whether the CLI of the call is found in the CLI list at block 102. If the CLI of the call is not found in the CLI list or the CLI cannot be obtained (i.e., a call block feature is invoked on the caller's line), the node sets the value of a “PIN Errors” flag and the value of a “PIN attempts” flag equal to zero at block 104 and proceeds to an Authenticate subroutine 106 (see FIG. 38). The Authenticate subroutine 106 can identify the user by detecting a unique speech pattern from the user(i.e., speaker verification) or a PIN entered using voice commands or DTMF tones as further described below.

If the user is not identified as a subscriber of the node by the Authenticate subroutine 106 at block 108, the node responds “Trouble verifying PIN, transferring to agent” at block 110 then routes the call to a customer service representative at block 112. The node then returns to the beginning of the Idle routine 100 at block 114.

When the user is identified as a subscriber of the node by the Authenticate subroutine 106 or the CLI of the call is found in the CLI list at block 102, the node responds “Hello” at block 118 and personally welcomes the caller by his her name at block 119 (i.e., “Welcome Bob”). The node then proceeds to an Main Menu routine 120 as further described below.

FIG. 11 shows a flow diagram of the Main Menu routine 120. The Main Menu routine 120 sets up the VRU client and VRU server of the node, loads the grammars or vocabulary (i.e., English language, Spanish language, etc.) into the VRU server, and loads the dialogs (i.e., female voice, male voice, etc.). Initially, the node determines whether a call is on hold at block 122. If the call is not on hold, the node proceeds to block 124 as further described below. If the call is on hold at block 122, the node determines whether a second party is still connected to the node at block 128.

If the second party is not on hold at block 128, the node sets the value of a “call on hold” flag equal to “no” at block 130 and announces to the user “The party you have called has hung up” at block 131. The node then sets the grammars and dialogs at block 124. Preferably, the grammars and dialogs can be set or loaded depending upon the type of device (i.e., a wireless phone), the gender of the caller (i.e., male or female), the type of language (i.e., English, Spanish, etc.) and the accent of the caller (i.e., a New York accent, a southern accent, an English accent, etc.). The node can automatically load the grammars and dialogs based upon the CLI, the calling communication device, or the identity of the user. It is also contemplated that the dialogs and grammars may be changed by the user or changed by the node based upon the voice communications detected by the node.

As shown in FIG. 11, if the second party is still connected to the node at block 128, the node announces to the caller “You have a call on hold, say return to return to the call” at block 132. The node then selects the call connected grammars and dialogs for the call at block 134. The node then announces “How may I help you?” to the user at block 126. The node waits for a command from the user and then proceeds to a MM_Main routine 136.

FIGS. 12-14 illustrate flow diagrams of the MM_Main routine 136. The MM_Main routine 136 allows a user to access various functions and services of the node. Initially, the node waits for a command to be entered or spoken by the user and then responds according to the user's request. The node continues to initiate and respond with messages which are activated by the user's spoken or DTMF tones.

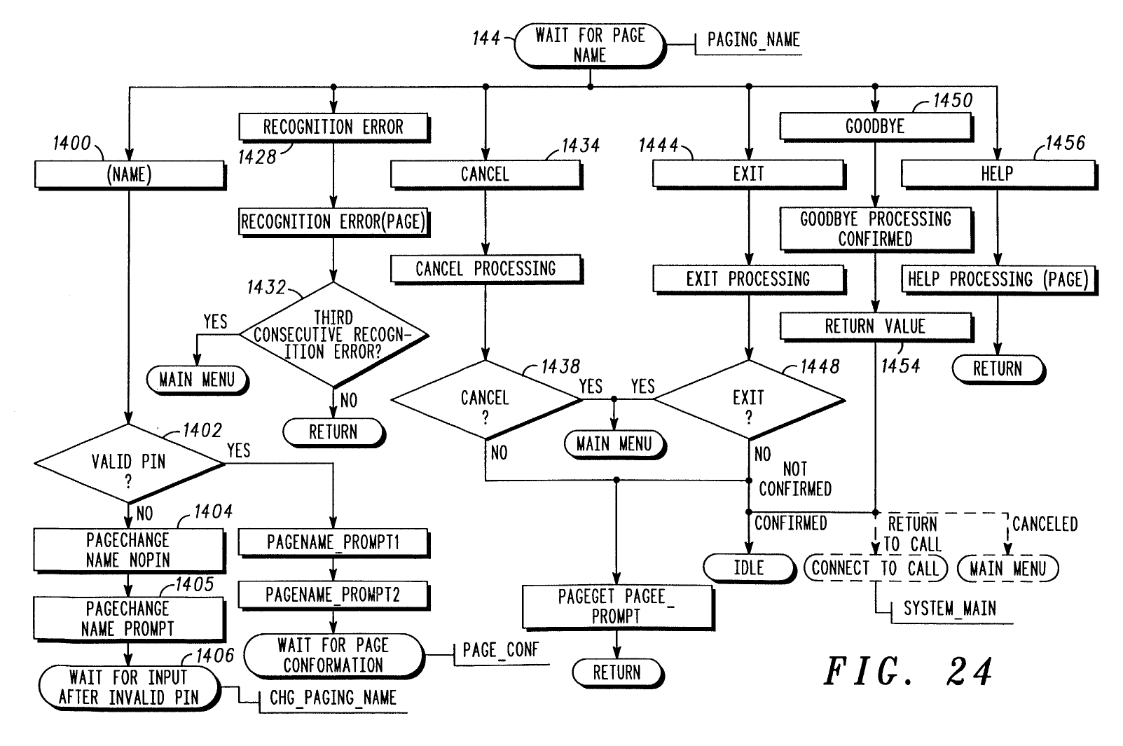

As shown in FIG. 12, if the node receives a “Page” command from the user at block 140, the node announces “Please say name” to the user at block 142. The node waits for the user to speak the party's name and then proceeds to a Paging_Main routine 144 to process the paging request from the user as further described below (see FIG. 24).

If the node receives a “Page” command from a caller followed by a name of a party (i.e., Bob) at block 150, the node accesses the personal file of the user and retrieves the PIN associated with the name of the party. The node then determines whether the PIN is valid at block 152. If the node could not access a valid PIN for the party at block 152, the node responds “Sorry, no PIN” for the party at block 154. The node then proceeds to the Main Menu routine 120.

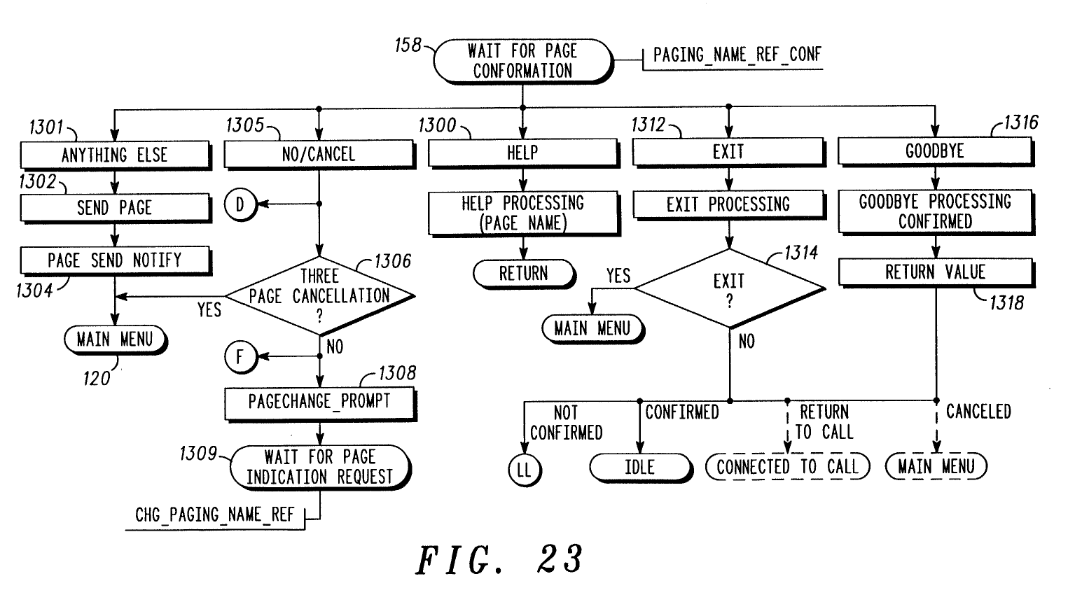

If there is a valid PIN for the party at block 152, the node sends a paging request via the messaging server unit to a paging node (i.e., the SkyTel® network, etc.) and the node responds “Paging (name) to current location” (i.e. Paging Bob to home phone) at block 156 and 157. The node then waits for a page confirmation from the user and then proceeds to a Paging_Name_Ret_Conf routine 158 as described below (see FIG. 23). The phone number of the calling communication device can be sent as the call back number when selected by the user. Otherwise, the node can prompt the user to enter a callback number. The node can also send a voice or text message or any other suitable message information via the message server unit to the party.

As shown in FIG. 12, when the node receives a “Call” command from a user at block 160, the node responds “Please say name or number to call” at block 162. The node then waits for the user to enter a name or number of a party and proceeds to a Voice_Dial_Main routine 166 as further described below (see FIG. 15).

When the node receives a “Call” command from a user followed by a name of a party (i.e., call Nancy) at block 170, the node access the personal file of the user to determine whether a default phone number has been designated for the party at block 172. If a default number has not been designated by the user, the node proceeds to block 174 as further described below. If a default number has been designated for the party by the user at block 172, the node responds “Dialing (name) at the (location)” (i.e., “dialing Bob on mobile phone”) at blocks 176 and 177. The node then waits for a call confirmation from the user and proceeds to a Name_Loc_Conf routine 178 as further described below (see FIG. 16).

When the node receives a “Call” command followed by a name (i.e., Bill) and a location (i.e., home) at block 190, the node accesses the personal file of the user to determine whether location for the name of the party is valid at block 192. If the location is valid at block 192, the node responds “Dialing (party) at (location)” (i.e., “dialing Bill at home”) at block 176 as described above.

If the location of the party is not valid at block 192, the node then determines whether any locations are associated with the party at block 174. If there are no locations for the party at block 174, the node responds “no valid locations” at block 194 and proceeds to the Main Menu routine 120. If there is a valid location for the party at block 174, the node responds “Valid locations for (name) are (locations)” (i.e., “the valid locations for Bill are work, home, and mobile phone”) at block 195. At blocks 196 and 197, the node responds “Please say the location” of the party. The node then waits for a location from the user and proceeds to a Get_Loc routine 198 as further described below (see FIG. 17).

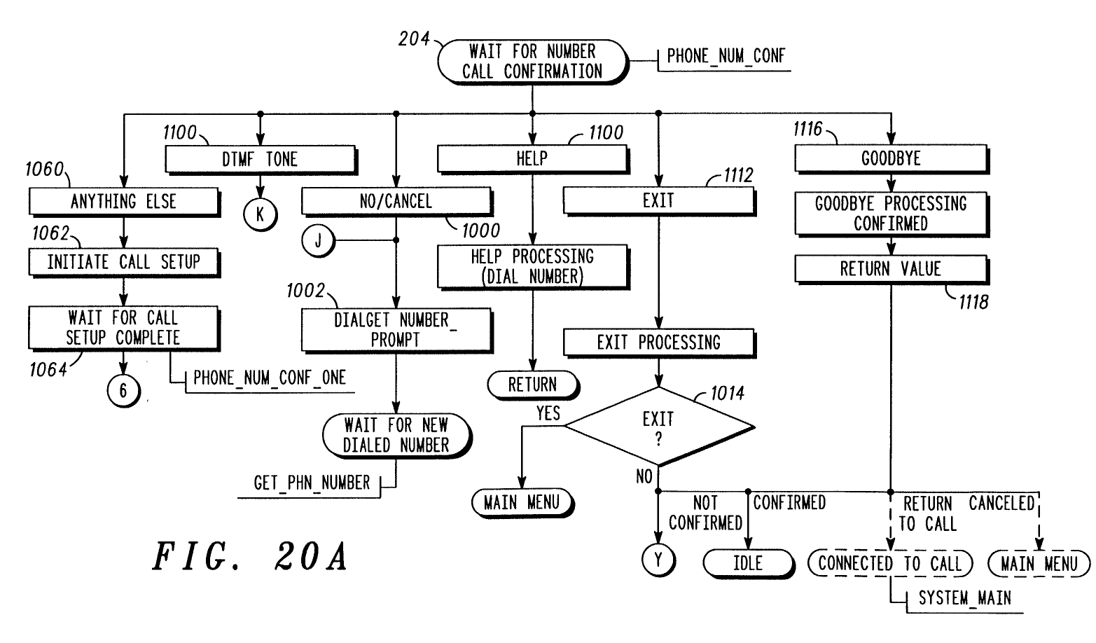

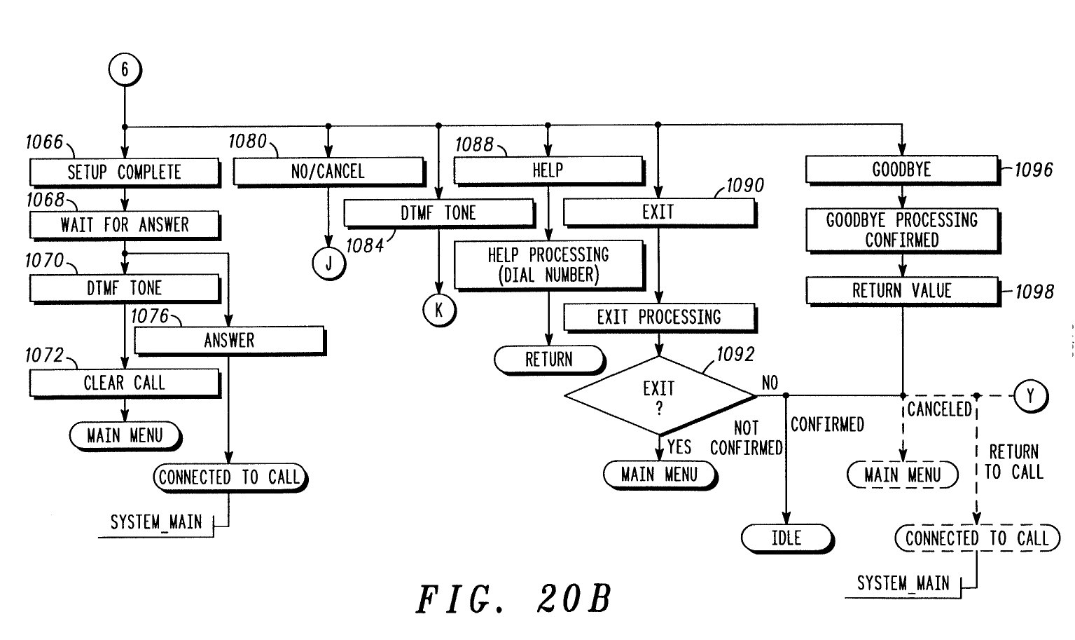

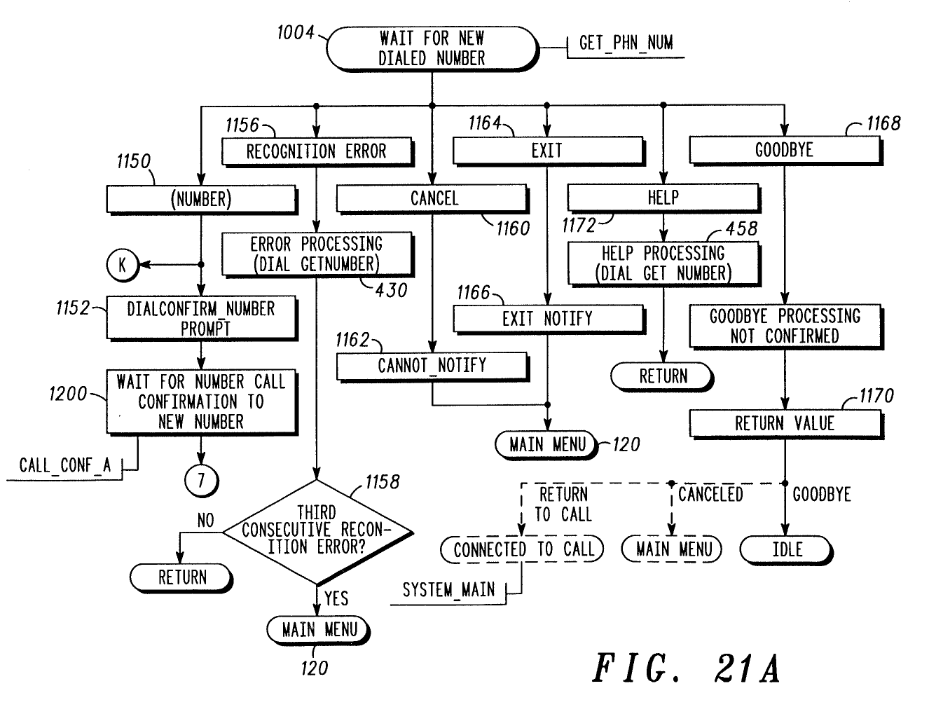

Referring still to FIG. 12, when the node receives a “Call” command from the user followed by a string of digits of a phone number (i.e., 630 123 4567) at block 200, the node responds “Dialing (number)” (i.e., “dialing 630 123 4567”) at block 202. The node then waits for a call confirmation from the user and proceeds to a Phone_Num_Conf routine 204 as described below (see FIG. 20).

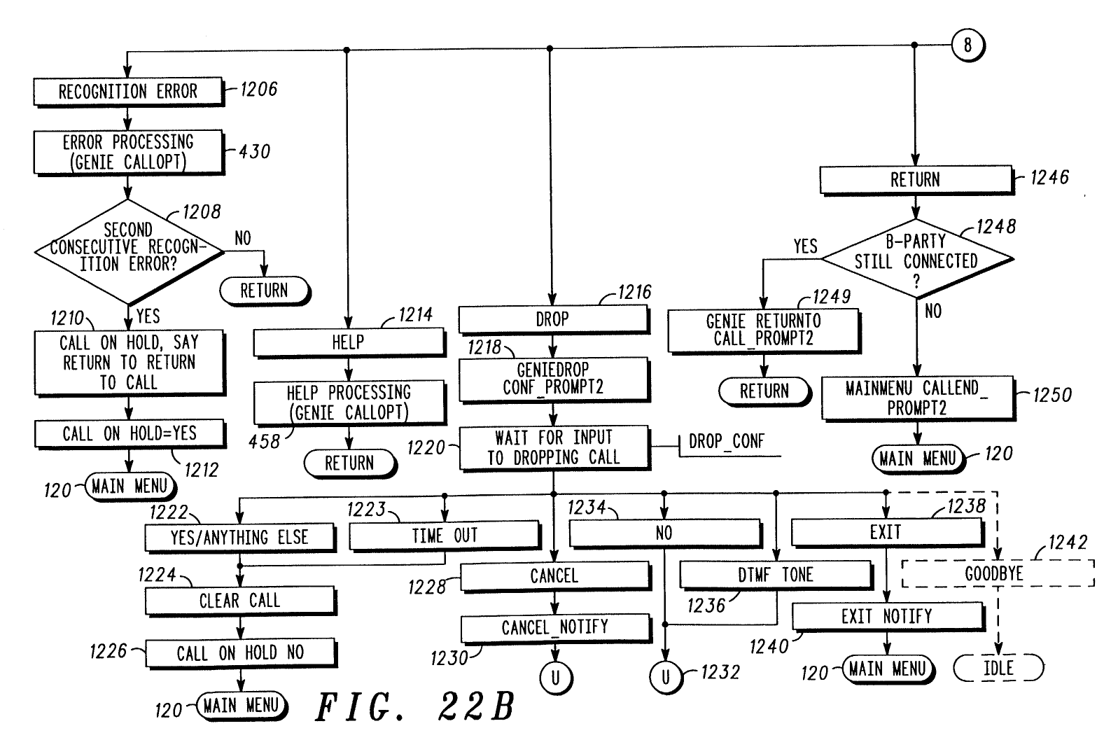

When the node receives a “Return to call” command from the user at block 210, the node determines whether the second party is still connected to the call at block 212. If the second party is still connected at block 212, the node connects the user to the call and proceeds to a System Main routine 214 as further described below (see FIG. 22). If the second party is not connected to the call at block 212, the node announces “The second party has hung up” at block 216 and then proceeds to beginning of the Main Menu routine 120 as described above.

When the node receives a “Drop call” command from the user at block 220, the node determines whether the second party is connected to the call at block 222. If the second party is not connected at block 222, the node proceeds to block 216 as described above. If the second party is still connected to the call at block 222, the node clears the call at block 224 and responds “Dropping call” at block 226. The node then proceeds to the Main Menu routine 120 as described above.

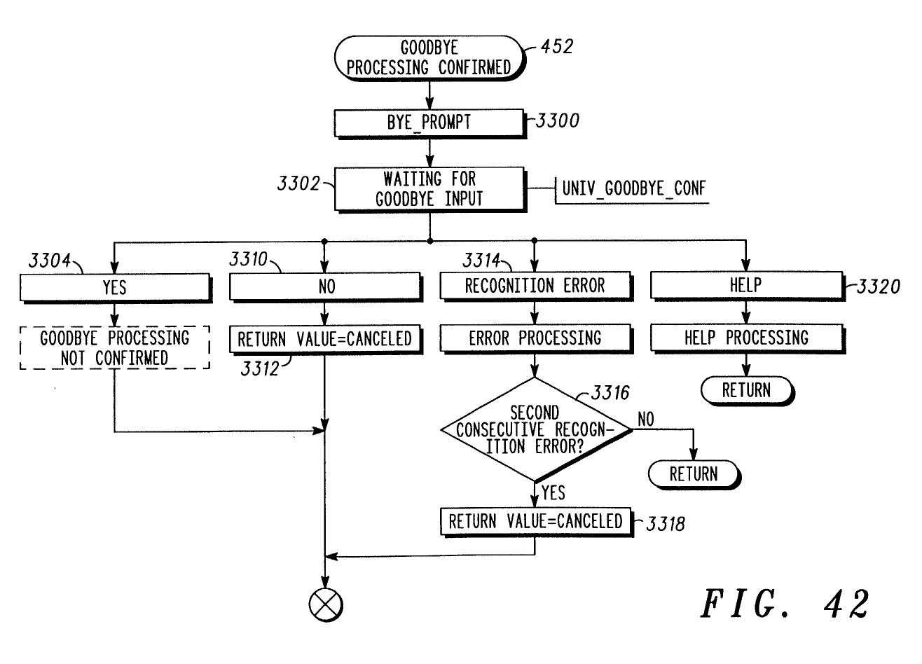

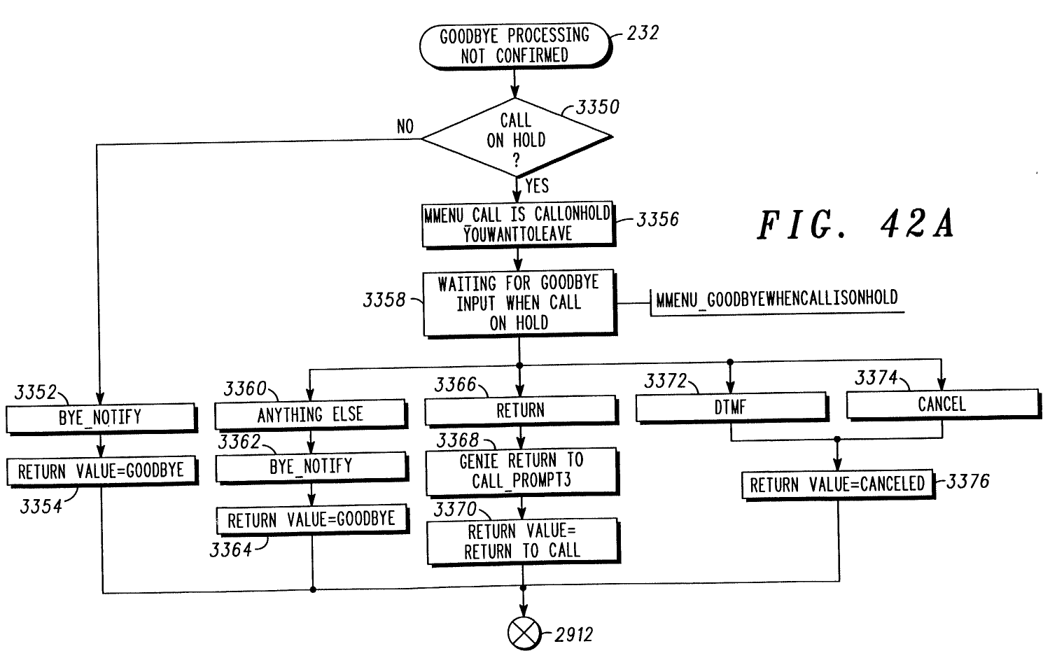

When the node receives a selected phrase (i.e., “Start over”, “Good-bye”, etc.) from the user at block 229, the node proceeds to the Main Menu routine 120. When the node receives a “Goodbye” command from the user at block 230, the node proceeds to a Goodbye Processing Not Confirmed subroutine 232 as further described below (see FIG. 42a). The node then determines the value of a “return value” flag at block 232. If the value of the “return value” flag equals “Goodbye”, the node then proceeds to the Idle routine 100 as described above (see FIG. 10) at block 116. When the value of the “return value” flag is equal to “return to call” at block 232, the node connects the user to the call and then proceeds to the System_Main routine 214 as further described below (see FIG. 22). When the “return value” flag is equal to “canceled” at block 232, the node proceeds to the Main Menu routine 120 as described above (see FIG. 11).

Referring now to FIG. 13, when the node receives a “Customer service” command from the user at block 250, the node announces “Calling customer service” at block 252 and routes the call to a customer service agent at block 254. The node then proceeds to the Main Menu routine 120.

When the node receives an “Address book” command from the user at block 260, the node determines whether the user has been authenticated (i.e., authorized to access the node) at block 262. If the user has been authenticated at block 262, the node proceeds to block 264 as further described below. If the user has not been authenticated at block 262, the node proceeds to the Authenticate subroutine 106 as further described below to attempt to identify the user.

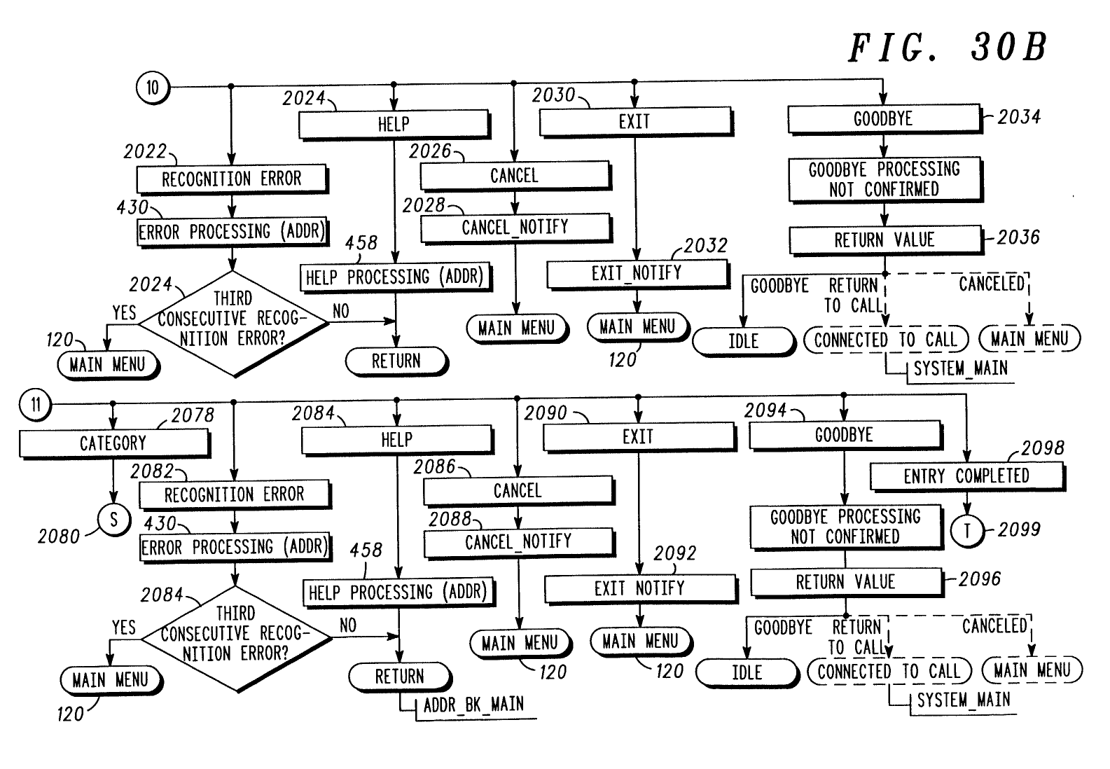

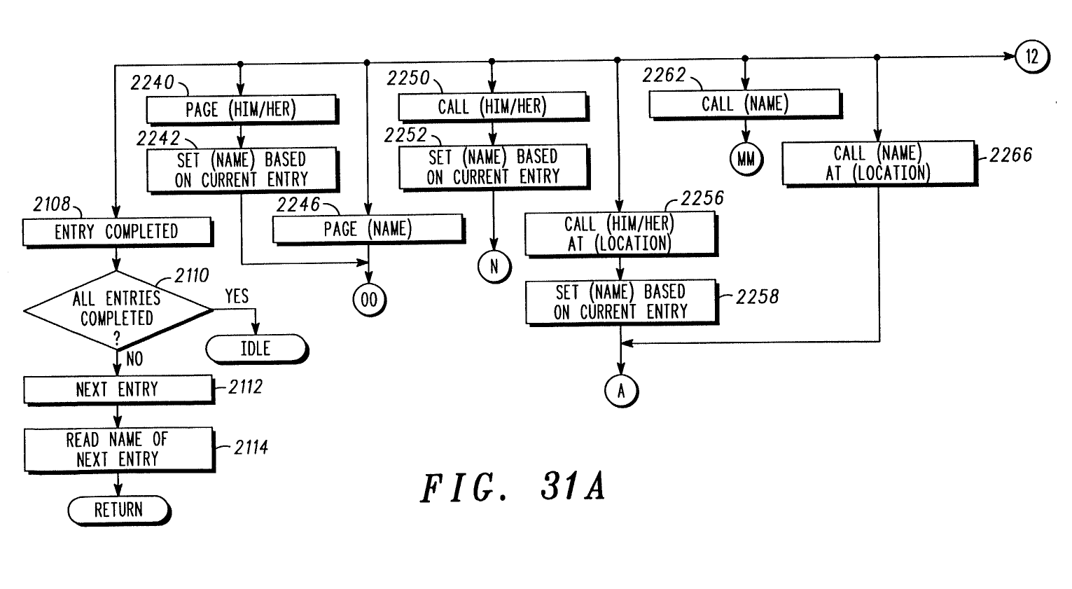

At block 268, the node determines whether the user has been authenticated. If the call has not been authenticated at block 268, the node announces “Having difficulty verifying PIN” at block 270. The node then proceeds to the Main Menu routine 120 as described above. If the call is authenticated at block 268, the node states “Please state a name, category, or all” at block 264. The node then waits for a command from the user and proceeds to an Addr_Bk_Main routine as further described below (see FIG. 30).

As shown in FIG. 13, when the node receives a “Change account” command from the user at block 275 or a DTMF tone at block 280, the node determines whether the user has been authenticated at block 282. If the user has been authenticated at block 282, the node then waits for a command from the user and proceeds to the beginning of the MM_Main routine 136. If the user has not been authenticated at block 282, the node proceeds to the Authenticate subroutine 106 to attempt to identify the user. The node then determines whether the user has been authenticated at block 286. If the user has not been authenticated at block 286, the node proceeds to block 270 as described above. If the user has been authenticated at block 286, the node then waits for a command from the user and proceeds to the beginning of the MM_Main routine 136.

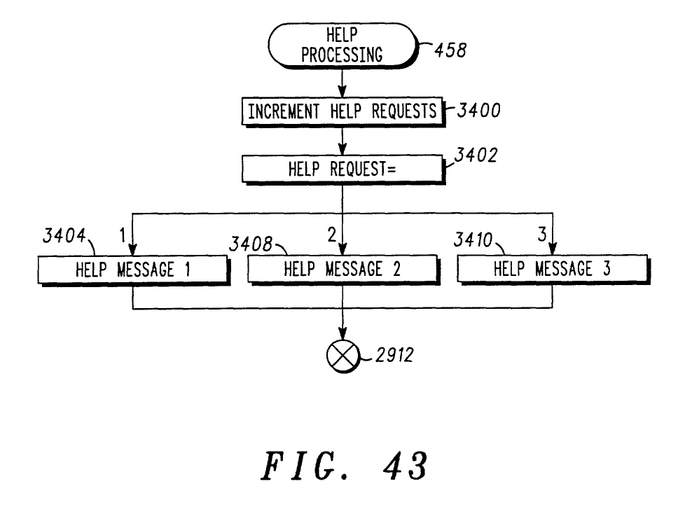

When the node receives a “Help” command or a “Menu” command from the user at block 290, the node proceeds to a Help Processing subroutine as further described below (see FIG. 43). The node then waits for a command from the user and proceeds to the beginning of the MM_Main routine 136.

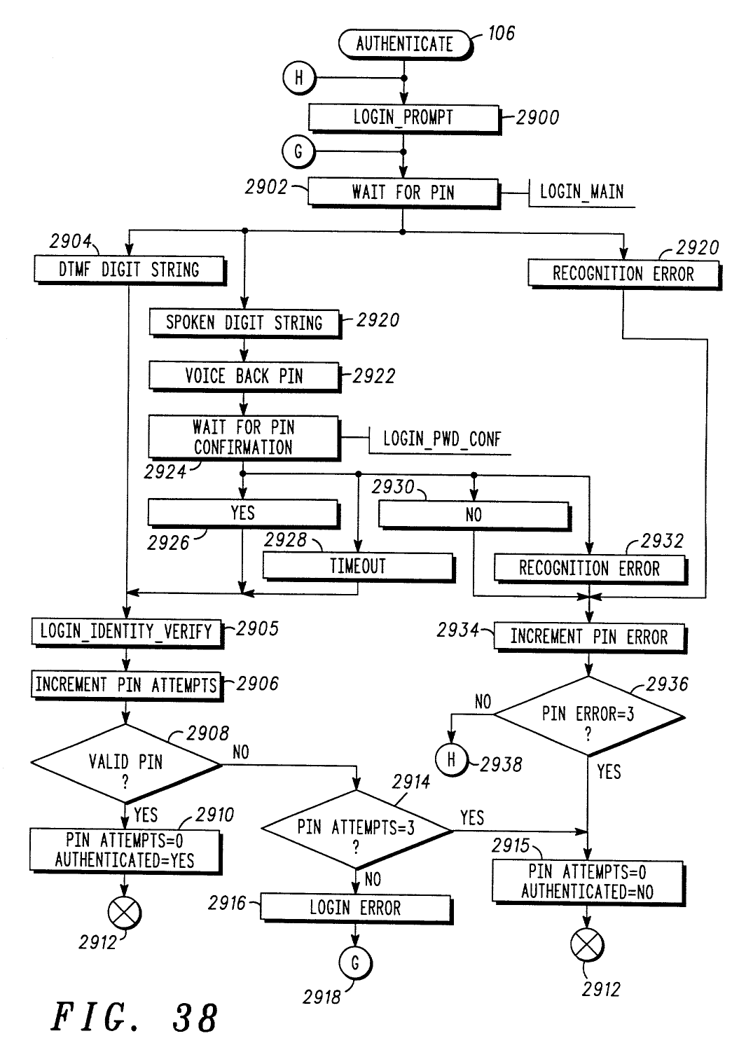

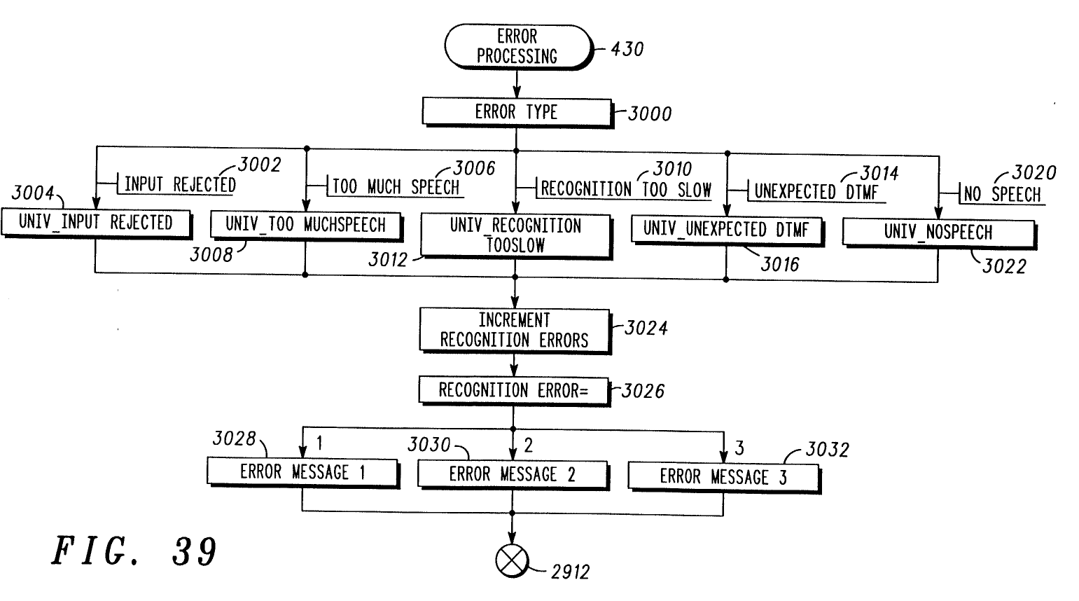

If the node is having difficulty recognizing the voice commands from the user or detects a recognition error at block 300, the node proceeds to an Error Processing subroutine to process recognition errors as further described below (see FIG. 39). At block 304, the node determines if three consecutive recognition errors have been detected by the node. If three consecutive recognition errors have been detected by the node at block 304, the node proceeds to block 306. If three consecutive recognition errors have not been detected by the node at block 304, the node waits for a command from the user and proceeds to the beginning of the MM_Main routine 136.

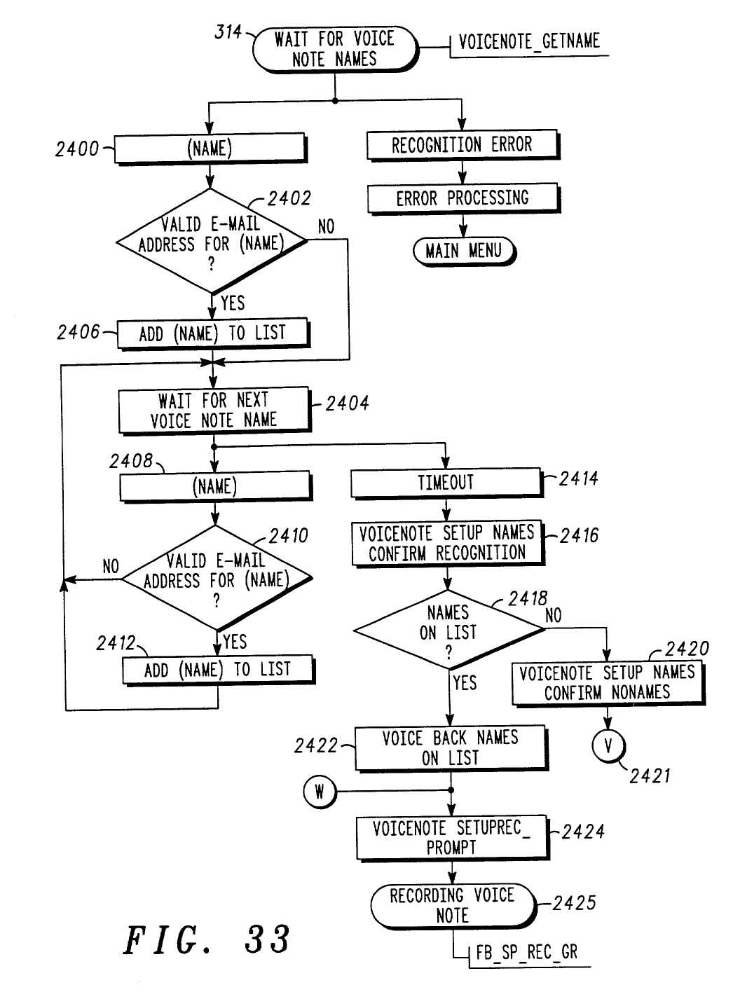

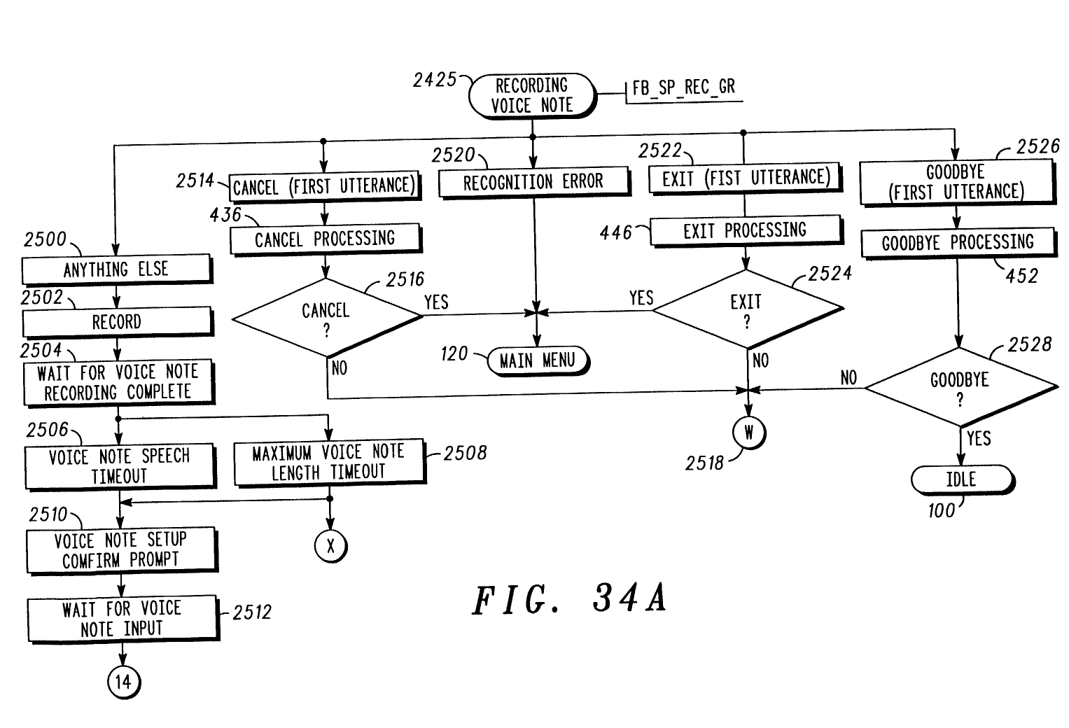

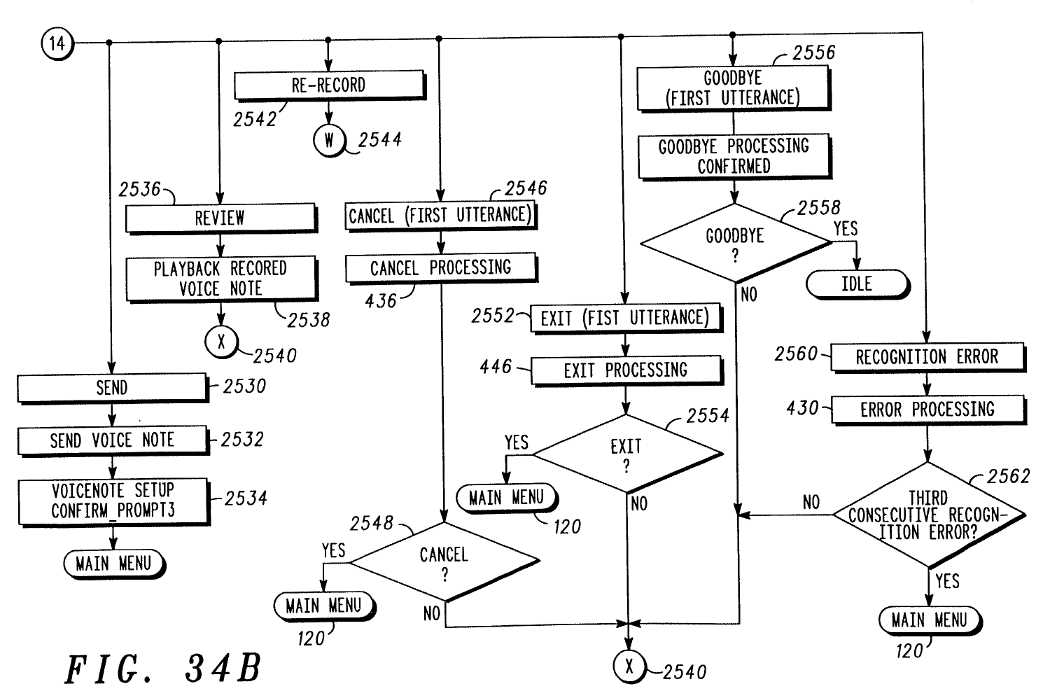

When the node receives a “Voice Note” command from the user at block 310, the node responds “Please say the list of names” at block 312. The node then waits for a list of the names and proceeds to a Voice_Note_GetNames routine 314 as further described below (see FIG. 33).

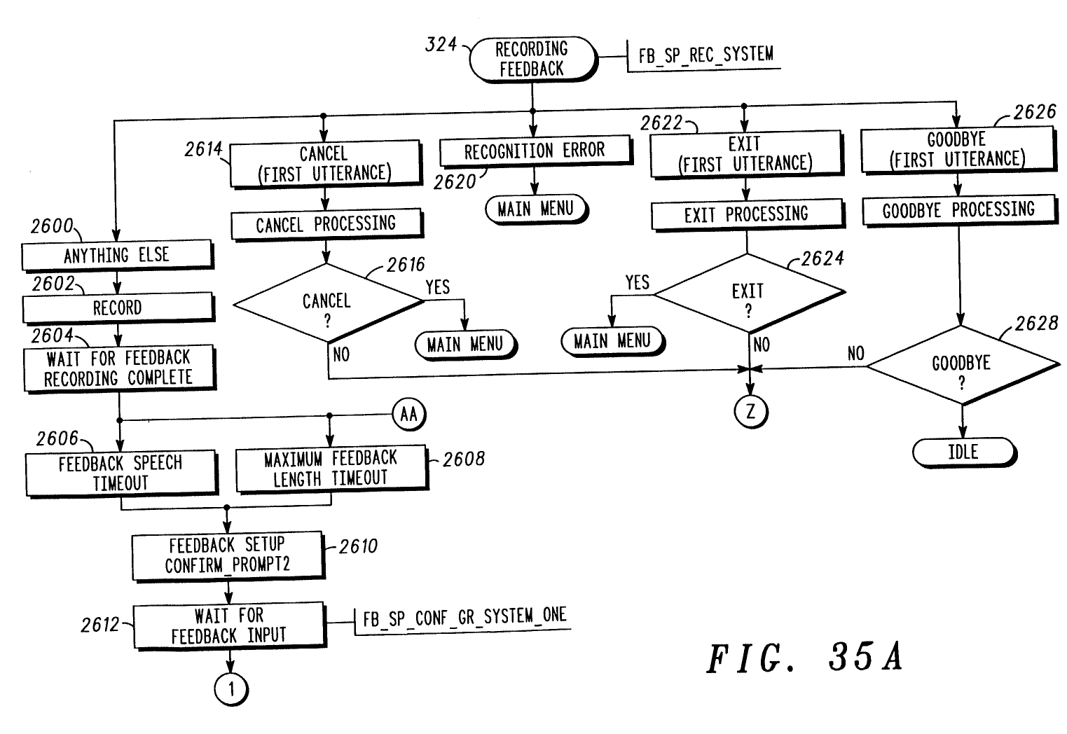

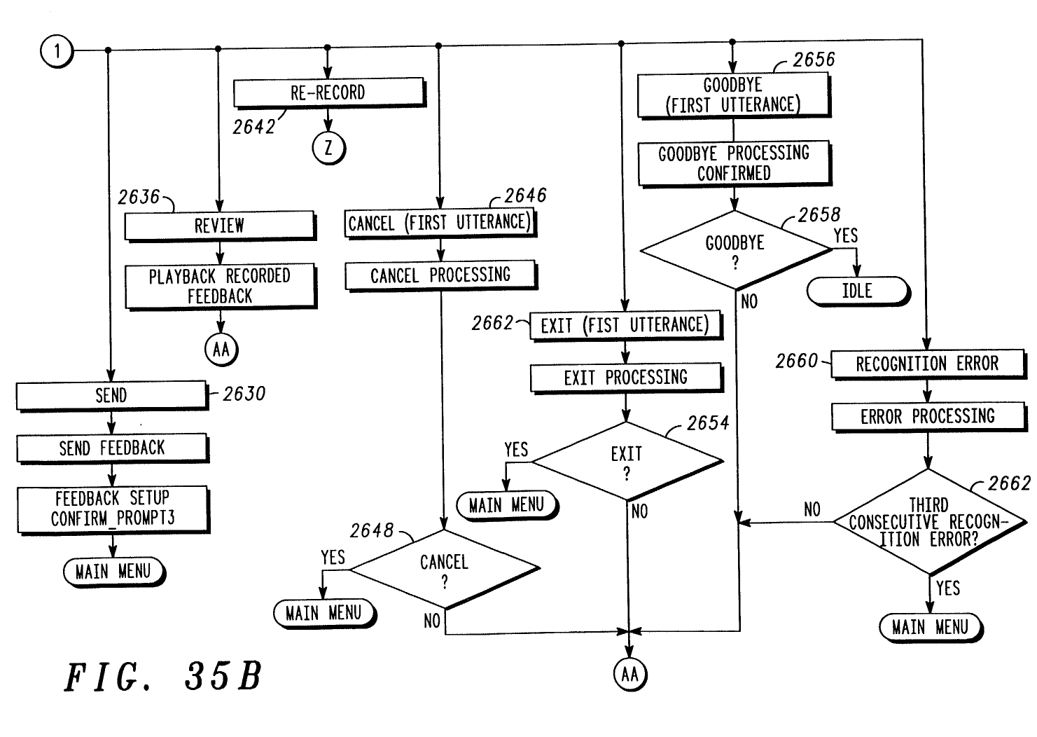

When the node receives a “Feedback” command from the user at block 320, the node responds “Please record your feedback after the tone” at block 322. The node then records the voice feedback or communications from the user and proceeds to a Fb_Sp_Rec_Gr System routine 324 as further described below (see FIG. 35).

When the node receives a “Pause” command from the user at block 330, the node responds “Going to sleep” at block 332. The node can then play music for the user. At block 334, the node monitors the voice communications of the user and waits for a key phrase or word from the user (i.e., start over, cancel, etc.) or a DTMF tone. Once the node detects the key word from the user via the detection unit 99 at block 336, the node proceeds to the Main Menu routine 120.

Referring now to FIG. 14, when the node receives a “Headline news” command from the user at block 350, the node responds “News headlines” at block 352. The node begins to read the news headlines (i.e., National news reports, etc.) to the user at block 354 and then proceeds to a Head_News_Main routine 356.

The Head_News_Main routine 356 allows a user to select a variety of features while the node is reading the headline news and after the node has finished reading the news. When the node receives a “Repeat” command from the user at block 358, the node proceeds to block 360. Upon receiving a “Cancel” command from the user at block 362, the node responds “Canceling” at block 364 and then proceeds to the Main Menu routine 120 as described above.

When the node receives a Help command from the user at block 364, the node proceeds to a Help Processing subroutine and then proceeds to block 370 as further described below. If the node receives a “Completed” command at block 366, a DTMF tone at block 368, or an “Exit” command from the user at block 372, the node responds “Exiting headline news” at block 370 and proceeds to the Main Menu routine 120.

When the node receives a “Good-bye” command from the user at block 374, the node proceeds to a Goodbye Processing Not Confirmed subroutine 232 as further described below (see FIG. 42a). The node then determines the value of a “return value” flag at block 375. If the value of the “return value” flag equals “Goodbye”, the node proceeds to the Idle routine 100. When the value of the “return value” flag is equal to “return to call” at block 375, the node connects the user to the call and then proceeds to the System_Main routine 214 as further described below (see FIG. 22). When the “return flag” is equal to “Canceled” at block 375, the node proceeds to the Main Menu routine 120 as described above (see FIG. 11).

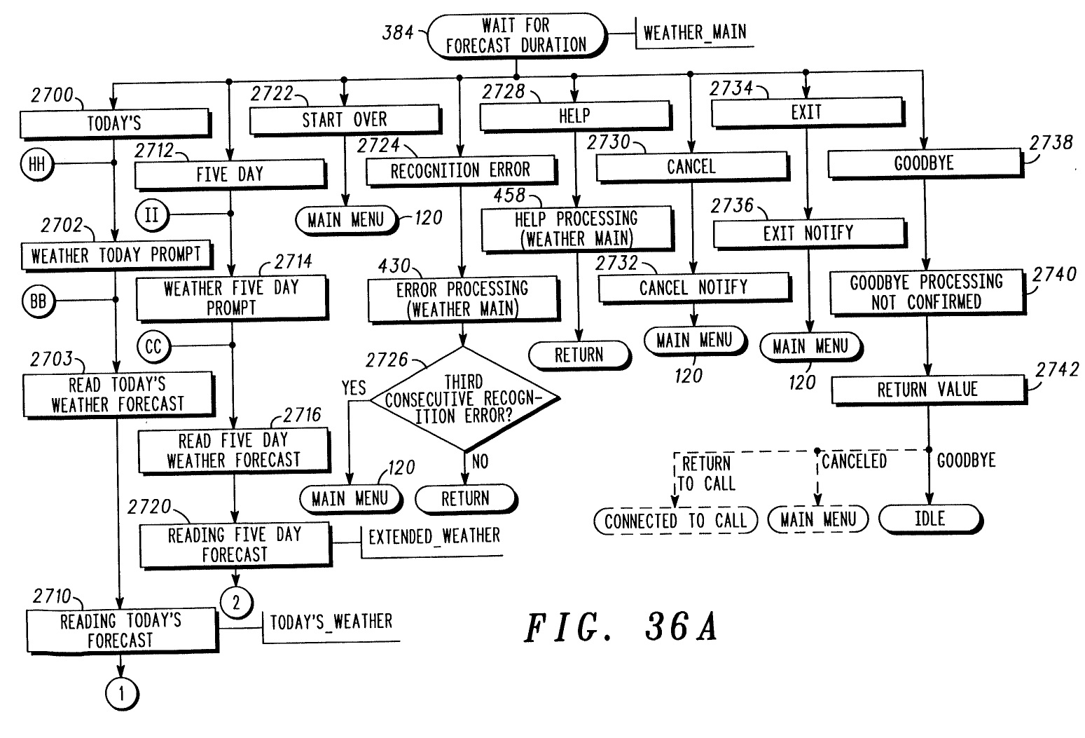

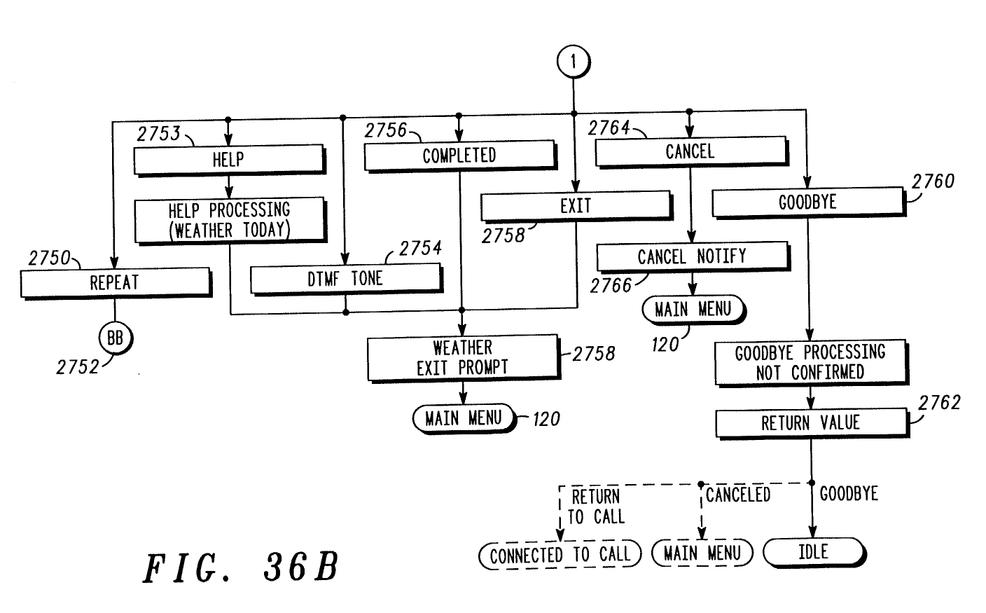

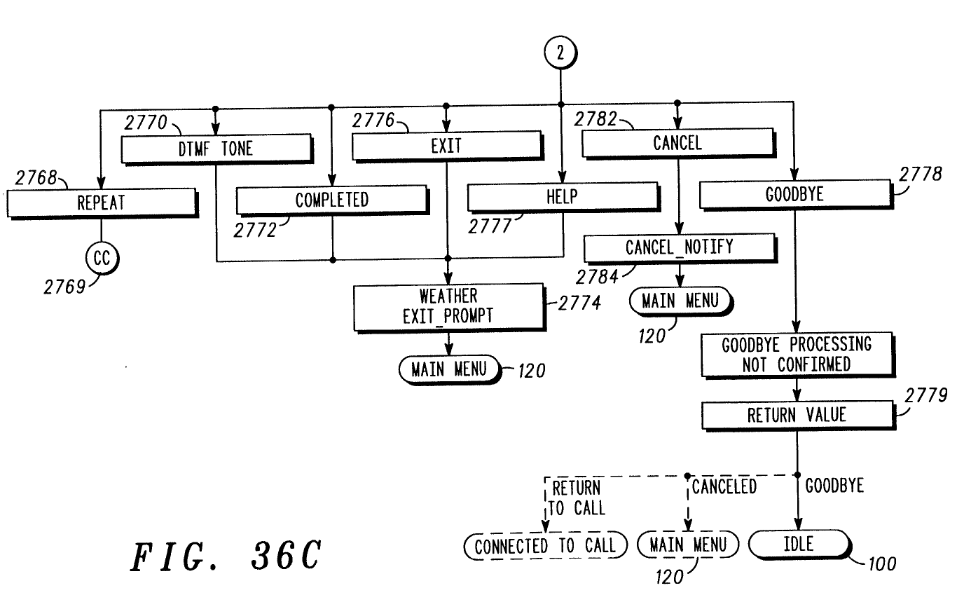

As shown in FIG. 14, when the node receives a “Weather” command from the user at block 380, the node responds “Today's or five day forecast” at block 382. The node waits for a command from the user and then proceeds to a Weather_Main routine 384 as further described below (see FIG. 36). When the node receives a “Today's weather” command from the user at block 390, the node proceeds to block 392. When the node receives a “Five day weather” command from the user at block 394, the node proceeds to block 396.

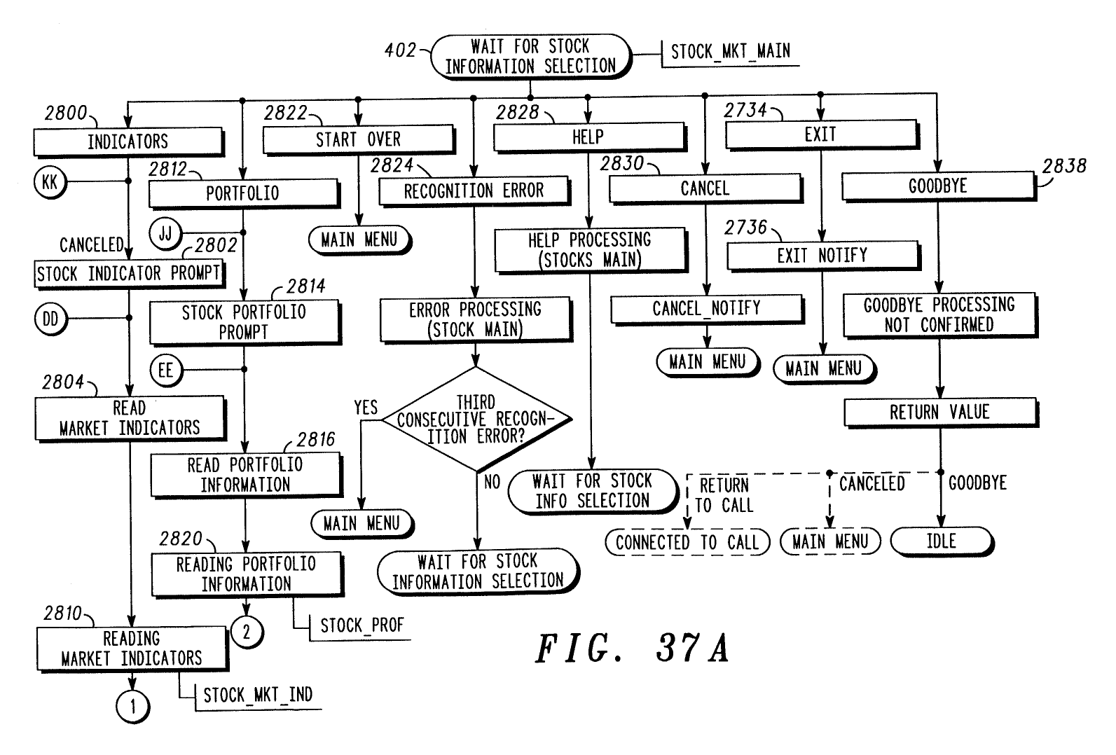

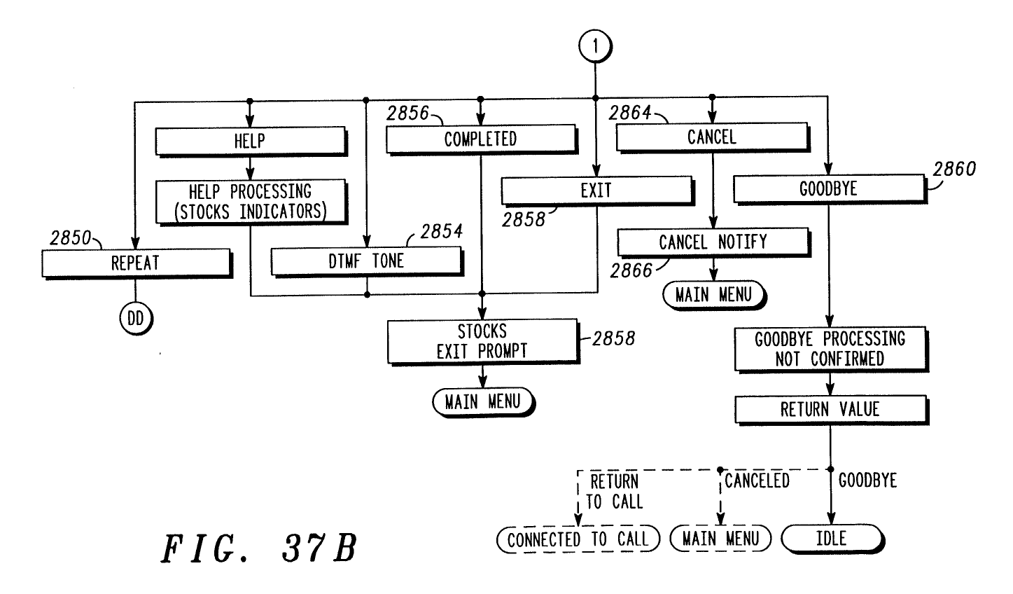

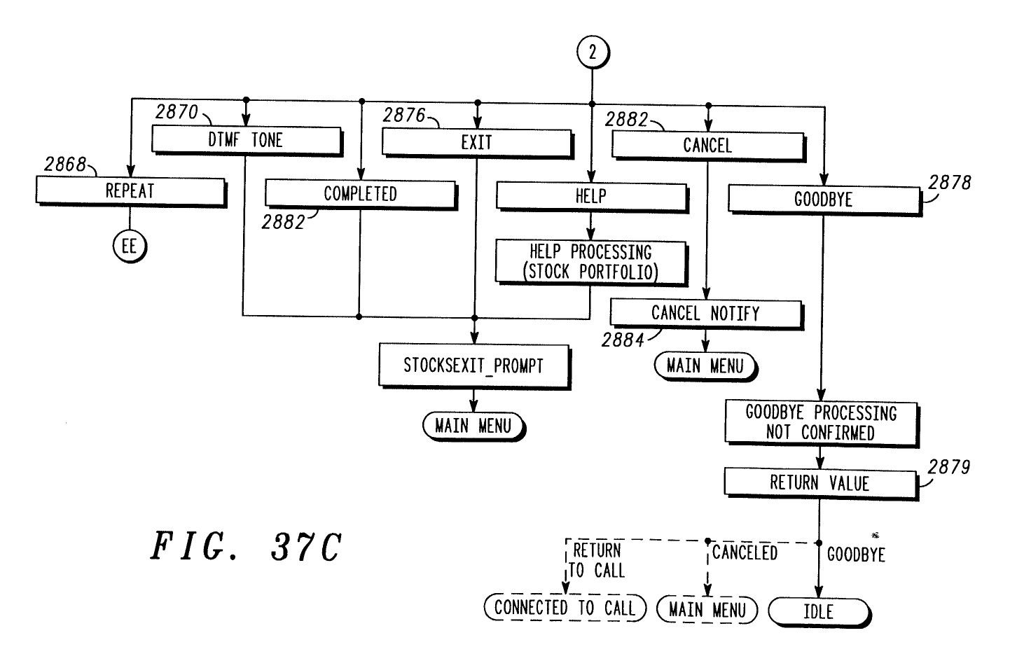

As shown in FIG. 14, when the node receives a “Stock” command from the user at block 398, the node responds “Indicators or portfolio” at block 400. The node waits for a command from the user and then proceeds to a Stock_Mkt_Main routine 402 as further described below (see FIG. 37) If the node receives a “Stock portfolio” command from the user at block 404, the node proceeds to block 406. When the node receives a “Stock market indicators” command from the user at block 408, the node proceeds to block 410.

When the node receives a “Traffic” command from the user at block 412, the node responds “Traffic conditions” at block 414 and begins reading the traffic conditions at block 416 via the TTS unit of the node. The node then proceeds to a Traff_Cond_Main routine 418.

The Traff_Cond_Main routine 418 allows a user to select a variety of features while the node is reading the traffic conditions and after the node has finished reading the traffic conditions. The steps of the Traff_Cond_Main 418 correspond, in many respects, in operation and function to the previously described steps of the Head_New_Main routine 356 of FIG. 14. Accordingly, further description of the steps of the Traff_Cond_Main routine 418 is unnecessary for a complete understanding of the present embodiment.

FIG. 15 shows a flow diagram of the Voice_Dial_Main routine 166. The Voice_Dial_Main routine 166 processes a name of a party (i.e., Bob) or a string of digits of a phone number (i.e., 123 4567) from the user. At block 420, when the node receives the name of a party from the user, the node proceeds to block 422. When the node receives a string of digits of a phone number from the user at block 424, the node proceeds to block 426.

When the node is having difficulty recognizing the voice commands from the user or detects a recognition error at block 428, the node proceeds to an Error Processing subroutine 430 as further described below (see FIG. 39). At block 432, the node determines whether three consecutive recognition errors have been detected by the node. If three consecutive recognition errors have not been detected by the node at block 432, the node waits for a name of a party or a string of digits of a phone number from the user and then proceeds to the beginning of the Voice_Dial_Main routine 166. If three consecutive recognition errors have been detected by the node at block 432, the node proceeds to the Main Menu routine 120 as described above.

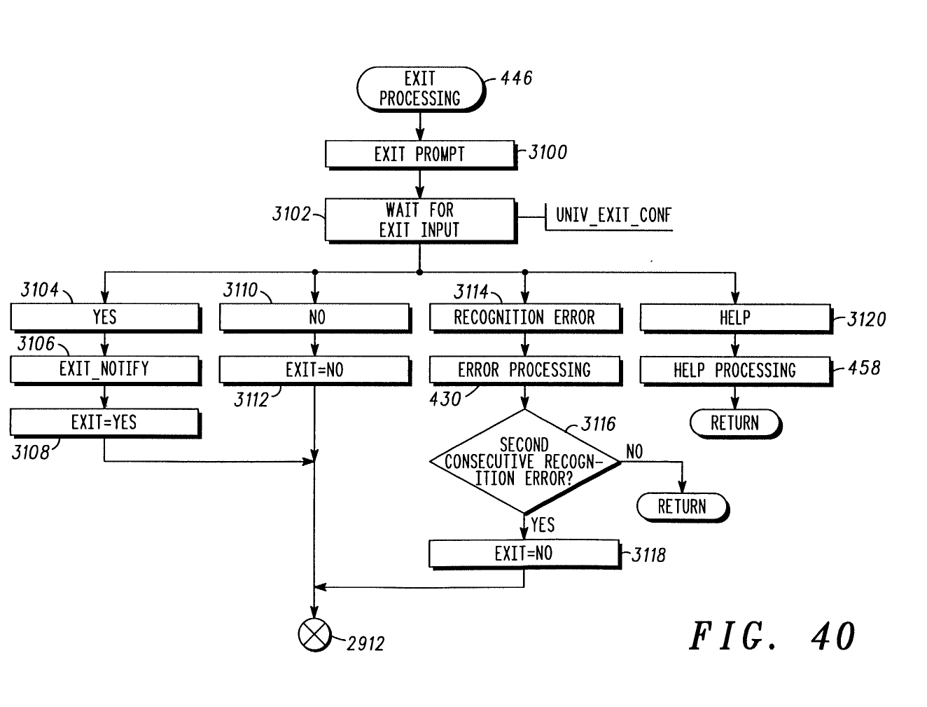

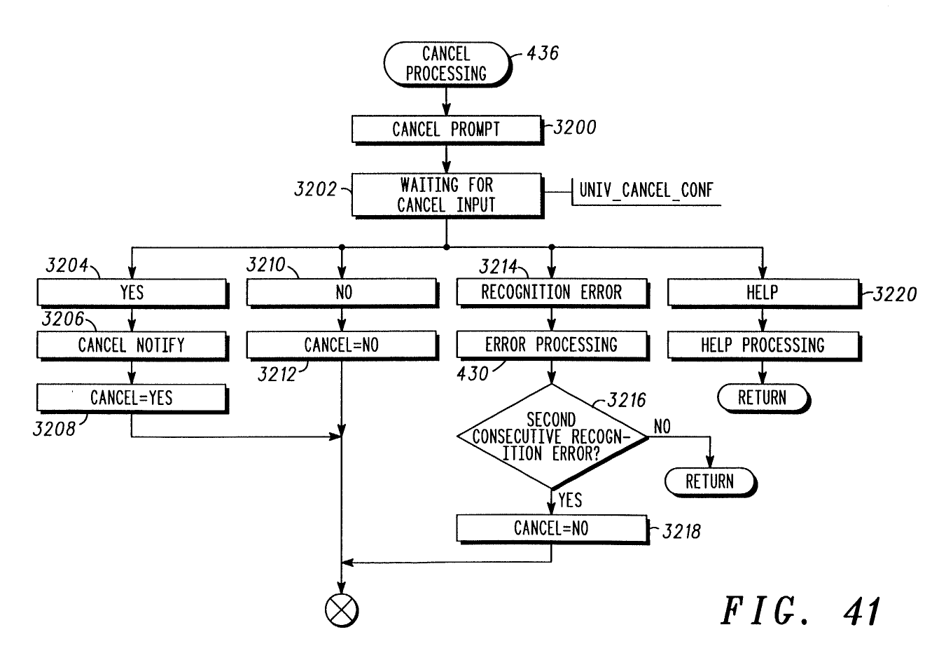

When the node receives a “Cancel” command from the user at block 434, the node proceeds to a Cancel Processing subroutine 436 as further described below (see FIG. 41). At block 438, the node responds “Do you wish to cancel the current operation?” If the node receives a “yes” command from the user, the node proceeds to block 440. If the node receives a “no” command from the user, the node will proceed to block 440.

When the node receives an “Exit” command from the user at block 444, the node proceeds to an Exit Processing subroutine 446 as further described below (see FIG. 40). At block 448, the node responds “Do you wish to exit?” When the node receives a “yes” command from the user at block 448, the node proceeds to the Main Menu routine 120. When the node receives a “no” command from the user at block 448, the node proceeds to block 440.

When the node receives a “Good-bye” command from the user at block 450, the node proceeds to a Goodbye Processing Confirmed subroutine 452 as described below (see FIG. 42). At block 454, the node determines the value of a “return value” flag. When the value of the “return value” flag is equal to “confirmed” at block 454, the node proceeds to the Idle routine 100 as described above. When the value of the “return value” flag is equal to “return to call” at block 454, the node connects the user to the call and proceeds to the System_Main routine 214 as further described below (see FIG. 22). When the value of the “return flag” is equal to “canceled” at block 454, the node proceeds to the Main Menu routine 120.

When the node receives a “Help” command from the user at block 456, the node proceeds to the Help Processing subroutine 458 as further described below (see FIG. 43). The node then waits for a name of a party or a string of digits of a phone number from the user and proceeds to the beginning of the Voice_Dial_Main routine 166.

FIG. 16 is a flow diagram of the Name_Loc_Conf routine 178. The Name_Loc_Conf routine 178 waits for the user to confirm he or she wishes to place the call and sets up an outgoing call to a party or contact at a selected location. As shown in FIG. 16, when the node does not receive a DTMF tone or a recognized command from the user at block 460, the node initiates a call set up sequence at the call control at block 462. The node then waits for the call set up to be completed and proceeds to a Call_Setup routine 464.

The Call_Setup routine 464 connects the user to the called party and processes various requests from the user. After the call set up is completed at block 466, the node waits for an answer from the called party at block 468. If the node detects a DTMF tone at block 470, the node clears the call at block 472 and then proceeds to the Main Menu routine 120. If the node detects an answer from the called party at block 476, the node connects the user to the call and then proceeds to the System_Main routine 214 as described below (see FIG. 22).

As shown in FIG. 16, when the node receives a “No” command or a “Cancel” command at block 480, the node proceeds to block 482. If the node receives a DTMF tone at block 484, the node proceeds to block 486. When the node receives a “Help” command from the user at block 488, the node proceeds to the Help Processing subroutine 458 as described below (see FIG. 43). The node then proceeds to the beginning of the Name_Loc_Conf routine 178.

When the node receives an “Exit” command from the user at block 490, the node proceeds to the Exit Processing subroutine 446 as further described below (see FIG. 40). At block 492, the node responds “Do you wish to exit the current operation?” If the user desires to exit the current operation at block 492, the node proceeds to the Main Menu routine 120. If the user does not wish to exit the current operation, the node proceeds to block 494.

When the node receives a “Good-bye” command from the user at block 496, the node proceeds to the Goodbye Processing Confirmed subroutine 452 as further described below (see FIG. 42). At block 498, the node determines the value of a “return value” flag. When the value of the “return value” flag is equal to “confirmed” at block 498, the node proceeds to the Idle routine 100. When the value of the “return value” flag is equal to “return to call” at block 498, the node proceeds to the System_Main routine 214 (see FIG. 22). When the value of the “return value” flag is equal to “canceled” at block 498, the node proceeds to the Main Menu routine 120 (see FIG. 11).

Referring still to FIG. 16, when the node receives a DTMF tone at block 500, the node proceeds to block 486. When the node receives a “No” command or a “Cancel” command from the user at block 504, the node responds “Start Over, location, or name?” at block 506. The node then waits for a call modification from the user and proceeds to a Change_Name_Loc routine 508 as further described below (see FIG. 18).

When the node receives a “Help” command from the user at block 510, the node proceeds to the Help Processing subroutine 458 as described below (see FIG. 43). The node then waits for a call confirmation input from the user and proceeds to the beginning of the Name_Loc_Conf routine 178.

When the node receives an “Exit” command from the user at block 512, the node proceeds to the Exit Processing subroutine 446 as further described below (see FIG. 40). At block 514, the node responds “Do you wish to exit the system?” If the user desires to exit the node, the node proceeds to the Main Menu routine 120. If the user does not wish to exit the node at block 514, the node proceeds to block 494.

When the node receives a “Good-bye” command from the user at block 516, the node proceeds to the Goodbye Processing Confirmed subroutine 452 as further described below (see FIG. 42). At block 518, the node determines the value of a “return value” flag. When the value of the “return value” flag is equal to “confirmed” at block 518, the node proceeds to the Idle routine 100 as described above (see FIG. 10). When the value of the “return value” flag is equal to “return to call” at block 518, the node connects the user to the call and proceeds to the System_Main routine 214 (see FIG. 22). When the value of the “return value” flag is equal to “canceled” at block 518, the node proceeds to the Main Menu routine 120 (see FIG. 11).

FIG. 17 shows a flow diagram of the Get_Loc routine 198. The Get_Loc_routine 198 processes a location of a party that the user wishes to call. Initially, the node waits for a call location from the user. When the node receives a location of the party (i.e., home phone, mobile phone, etc.) from the user, the node proceeds to block 522. The remaining steps of the Get_Loc_routine 198 correspond, in many respects, in operation and function to the previously described steps of the Voice_Dial_Main routine 168 of FIG.15. Accordingly, further description of the step of the Get_Loc routine 198 is unnecessary for a complete understanding of the present embodiment. The steps of the Get_Loc_routine 198 which generally correspond to the Voice_Dial_Main routine 168 of FIG. 15 are designated by like reference and numerals in the six hundred series.

FIG. 18 shows a flow diagram of the Change-Name_Loc routine 508. The Change_Name_Loc routine 508 allows a user to change the name and/or location of the party the user desires to call. Initially, the node waits for call modification request from the user. When the node receives a “Name” command from the user at block 700, the node responds “Please say the name of the party” at block 702. The node then waits for a new name of a party from the user and proceeds to a Get_Name routine 704 as further described below (see FIG. 19).

When the node receives a “Location” command from the user at block 706, the node proceeds to block 522. If the node receives a “Start over” command from the user at block 710, the node proceeds to the Main Menu routine 120 as described above.

If the node is having difficulty recognizing the commands from the user or detects a recognition error at block 712, the node proceeds to the Error Processing subroutine 430 as further described below (see FIG. 39). At block 714, the node determines whether three consecutive recognition errors have been detected by the node. If three consecutive recognition errors have not been detected by the node at block 714, the node proceeds to beginning of the Change_Name_Loc routine 508. If the node has detected three consecutive recognition errors at block 714, the node proceeds to the Main Menu routine 120.

When the node receives a “Help” command from the user at block 716, the node proceeds to the Help Processing subroutine 458 as further described below (see FIG. 43). The node then waits for a call modification request from the user and proceeds to the beginning of the Change_Name_Loc routine 508.

When the node receives a “Cancel” command from the user at block 718, the node responds “Canceling” at block 720 and then proceeds to the Main Menu routine 120. When the node receives an “Exit” command from the user at block 721, the node announces “Returning to Main Menu” at block 722 and then proceeds to the Main Menu routine 120. When the node receives a “Goodbye” command from the user at block 724, the node determines the value of a “return value” flag. When the value of a “return value” flag is equal to “Goodbye” at block 726 and the node proceeds to the Idle routine 100. When the value of a “return value” flag is equal to “return to call” at block 726, the node connects the user to the call and proceeds to the System_Main routine 214 (see FIG. 22). When the value of the “return value” flag is equal to “Canceled” at block 726, the node proceeds to the Main Menu routine 120 (see FIG. 11).

FIG. 19 illustrates a flow diagram of the Get_Name routine 704. The Get_Name routine 704 processes a call when the user enters a new name of a party and confirms that the user wishes to place a call to the selected party. Initially, the node waits for a new name of a party from the user.

When the node receives a name of a party from the user (i.e., Bill) at block 800, the node announces “Do you wish to place this call to (name) at (location)?” at blocks 802 and 803. The node then proceeds to a Call_Conf routine 900 as further described below. The remaining steps of the Get_Name routine 704 correspond, in many respects, in operation and function to the previously described steps of the Voice_Dial_Main routine 166 of FIG. 15. Accordingly, further description of the steps of the Get_Name routine 704 is unnecessary for a complete understanding of the present embodiment. The steps of the Get_Name routine 704 which generally correspond to the steps of the Voice_Dial_Main routine 166 of FIG. 15 are designated by like reference numerals in the eight hundred series.

The Call_Conf routine 900, as shown in FIG. 19, confirms a new name of a party from the user. When the node receives a “Yes” command from the user at block 902, the node proceeds to block 494. When the node receives a “No” command from the user at block 906, the node proceeds to block 482. The remaining steps of the Call_Conf routine 900 correspond, in many respects, in operation and function to the steps of the Get-Name routine 704 of FIG. 19. Accordingly, further description of the steps of the Call_Conf routine 900 is unnecessary for a complete understanding of the present embodiment. The steps of the Call_Conf routine 900 which generally correspond to the steps of the Get_Name routine 704 of FIG. 19 are designated by like reference numerals in the nine hundred series.

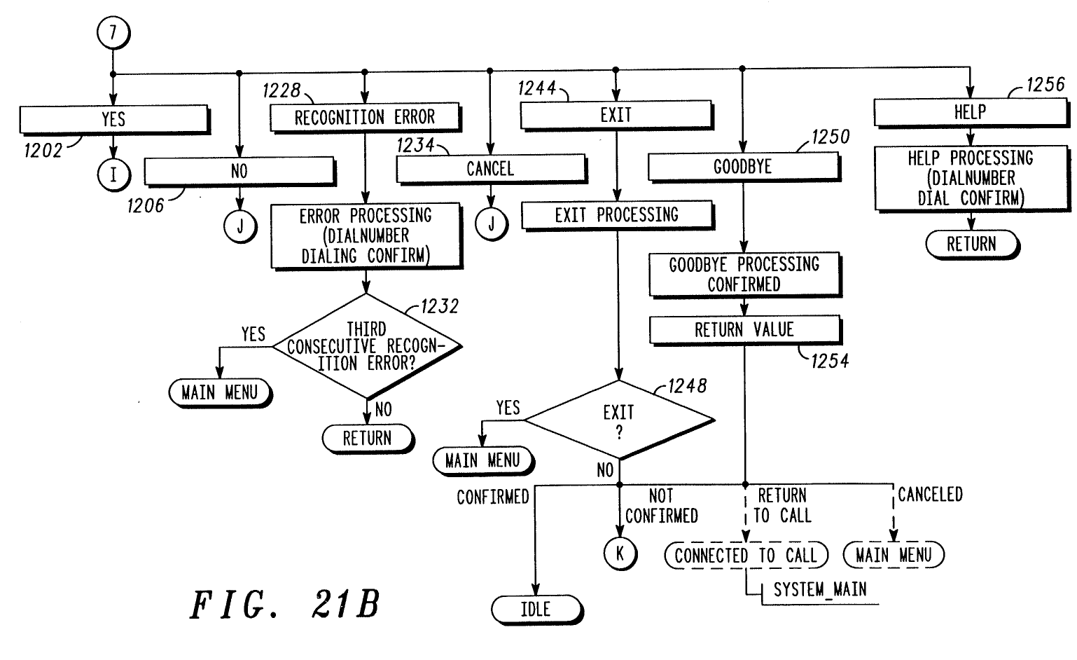

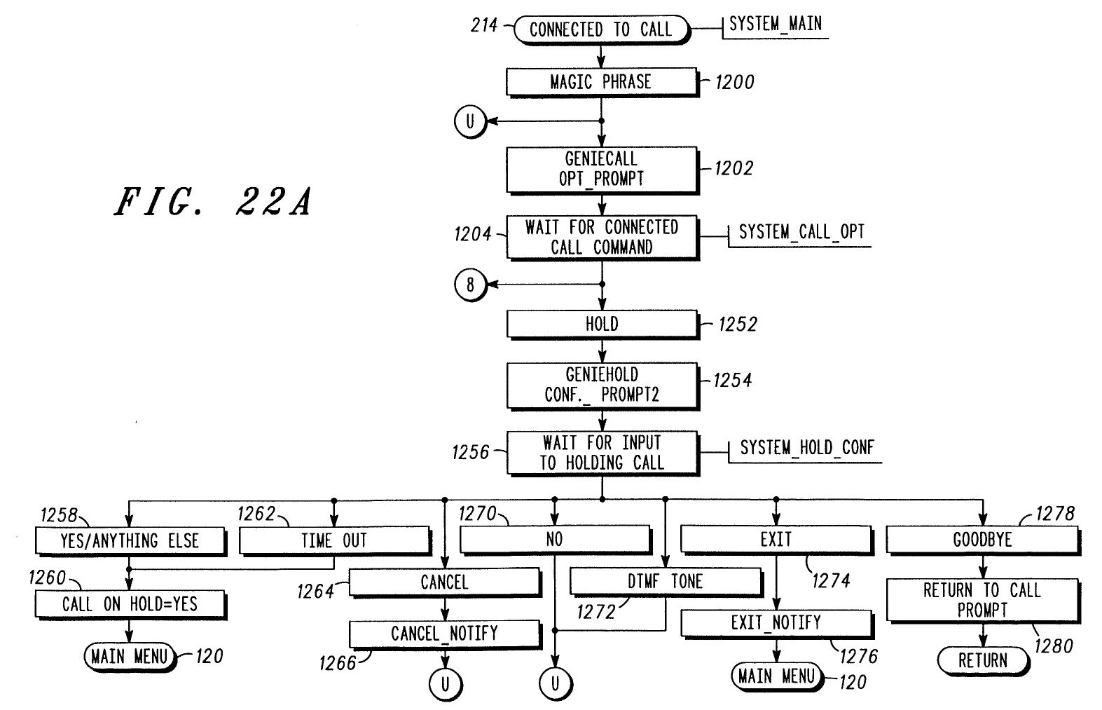

FIG. 20 shows a flow diagram of the Phone_Num_Conf routine 204. The Phone_Num_Conf routine confirms the phone number entered by the user and places an outgoing call to the phone number of the selected party. As shown in FIG. 20, when the node receives a “No” command or a “Cancel” command from the user at block 1000, the node responds “Please say the number you wish to dial” at block 1002. The node waits then for a new dialed number from the user and proceeds to a Get_Phn_Num routine 1004 as further described below (see FIG. 21).

The remaining steps of the Phone_Num_Conf routine 204 correspond, in many respects, in operation and function to the previously described steps of Name_Loc_Conf routine 178 of FIG. 16. Accordingly, further description of the steps of the Phone_Num_Conf routine 204 is unnecessary for a complete understanding of the present embodiment. The steps of the Phone_Num_Conf routine 204 which generally correspond to the Name_Loc_Conf routine 178 of FIG. 16 are designated by like reference numeral in the one thousand and eleven hundred series.

FIG. 21 shows a flow diagram of the Get_Phn_Num routine 1004. The Get_Phn_Num routine 1004 processes a new phone number of a party from the user and places an outgoing call to the phone number of the new party. When the node receives a digit string of a phone number (i.e., 123 4567) from the user at block 1150, the node responds “Do you wish to place this call to (number)?” at block 1152. The node then waits for a call confirmation of the phone number from the user and proceeds to the Call_Conf_A routine 1200.

The steps of the Call_Conf_A routine 1200 correspond, in many respects, in operation and function to the steps of the Call_Conf routine 900 of FIG. 19. Accordingly, further description of the steps of the Call_Conf_A routine 1200 is unnecessary for a complete understanding of the present embodiment. The steps of the Call_Conf_A routine 1200 which generally correspond to the Call_Conf routine 900 of the FIG. 19 are designated by like reference numbers in the twelve hundred series.

As shown in FIG. 21, when the node has difficulty recognizing the commands from the user or detects a recognition error at block 1156, the node proceeds to the Error Processing subroutine 430 as further described below (see FIG. 39). If three consecutive recognition errors have been detected by the node at block 1158, the node proceeds to the Main Menu routine 120. If three consecutive recognition errors have not been detected by the node at block 1158, the node proceeds to the beginning of the Get_Phn_Num routine 1004.

When the node receives a “Cancel” command from the user at block 1160, the node responds “Canceling” at block 1162 and proceeds to the Main Menu routine 120. When the node receives an “Exit” command from the user at block 1164, the node responds “Returning to the Main Menu” at block 1166 and proceeds to the Main Menu routine 120.

When the node receives a “Good-bye” command from the user at block 1168, the node determines the value of a “return value” flag at block 1170. When the value of the “return value” flag is equal to “Goodbye” at block 1170, the node proceeds to the Idle routine 100. When the value of the “return value” flag is equal to “return to call” at block 1170, the node connects the user to the call and proceeds to the System_Main routine 214 (see FIG. 22). When the value of the “return value” flag is equal to “Canceled” at block 1170, the node proceeds to the Main Menu routine 120.

When the node receives a “Help” command from the user at block 1172, the node proceeds to the Help Processing subroutine 458 as further described below (see FIG. 43). The node then waits for a new dialed phone number from the user and proceeds to the beginning of the Get_Phn_Num routine 1004.

FIG. 22 shows a flow diagram of the System_Main routine 214. The System_Main routine 214 monitors the speech and audio communications from the user for one or more key words or phrases while the user is connected to a call at block 1200. When the node detects one of the key words or phrases, the node interrupts (i.e., barges in) the call to determine how to handle the call based upon commands from the user and responds “Do you wish to hold, drop, or return to the call” at block 1202. The node then waits for a command from the user and proceeds to a System_Call_Opt routine 1204.

The System_Call_Opt routine 1204 allows a user to drop or put a call on hold as well as return to the call. As shown in FIG. 22, when the node is having difficulty recognizing the speech communications from the user or detects a recognition error at block 1206, the node proceeds to the Error Processing subroutine 430 as further described below (see FIG. 39). If two consecutive recognition errors have not been detected by the node at block 1208, the node proceeds to the beginning of the System_Call_Opt routine 1204. If two consecutive recognition errors have been detected by the node at block 1208, the node responds “Call on hold, say return to return to call” at block 1210. At block 1212, the node sets the value of a “call on hold” flag equal to “yes”. The node then proceeds to the Main Menu routine 120.

When the node receives a “Help” command from the user at block 1214, the node proceeds to the Help Processing subroutine 458 as further described below (see FIG. 43). The node then waits for a connected call command from the user and proceeds to the beginning of the System_Call_Opt routine 1204. When the node receives a “Drop” command from the user at block 1216, the node responds “Dropping call” at block 1218 and then proceeds to a Drop_Conf routine 1220.

The Drop_Conf routine 1220 confirms that the user wishes to drop the call. When the node receives a “Yes” command at block 1222 or does not receive a recognized command after a certain time period at block 1223, the node clears the call at block 1224 and sets the value of a “call on hold” flag equal to “no” at block 1226. The node then proceeds to the Main Menu routine 120. When the node receives a “Cancel” command from the user at block 1228, the node responds “Canceling” at block 1230 and then proceeds to block 1232. Upon receiving a “No” command from the user at block 1234 or a DTMF tone at block 1236, the node proceeds to block 1232. When the node receives an “Exit” command from the user at block 1238, the node responds “Returning to Main Menu” at block 1240 and proceeds to the Main Menu routine 120. If the node receives a “Good-bye” command from the user at block 1242, the node proceeds to the Idle routine 100 (see FIG. 10).

Referring still to FIG. 22, when the node receives a “Return” command from the user at block 1246, the node determines whether the second party is still connected to the call at block 1248. If the second party is connected to the call at block 1248, the node responds “returning to the call” at block 1249 and then proceeds to the beginning of the System_Main routine 214. If the second party is not connected to the call at block 1248, the node responds “The second party has hung” at block 1250 and the node proceeds to the Main Menu routine 120.

When the node receives a “Hold” command from the user at block 1252, the node responds “Holding call” at block 1254 and then proceeds to a System_Hold_Conf routine 1256. The System_Hold_Conf routine 1256 confirms that the user wants to place the call on hold.

When the node receives a “Yes” command from the user at block 1258 or does not receive a recognized command from the user after a certain time period at block 1262, the node sets the value of a “call on hold” flag equal to “yes” at block 1260 and then proceeds to the Main Menu routine 120. When the node receives a “Cancel” command from the user at block 1264, the node responds “Canceling” at block 1266 and then proceeds to block 1232. When the node receives a “No” command from the user at block 1270 or a DTMF tone at block 1272, the node proceeds to block 1232.

When the node receives an “Exit” command from the user at block 1274, the node announces “Returning to Main Menu” at block 1276 and then proceeds to the Main Menu routine 120. When the node receives a “Goodbye” command from the user at block 1278, the node responds “Returning to call” at block 1280 and then proceeds to the System Main routine 214.

FIG. 23 shows a flow diagram of the Paging_Name_Ret_Conf routine 158. The Paging-Name_Ret_Conf routine 158 confirms that the user wishes to send a page to a selected party. When the node does not receive a recognized command from the user at block 1301, the node sends a page request to a paging system at block 1302 and then responds “Page sent” at block 1304. The node then proceeds to the Main Menu routine 120.

When the node receives a “No” command or a “Cancel” command from the user at block 1305, the node determines whether three page cancellations have been detected by the node at block 1306. If three page cancellations have been detected by the node at block 1306, the node proceeds to the Main Menu routine 120. If the node has not detected three page cancellations at block 1306, the node responds “Start over, return location, or name?” at block 1308.

The node then waits for a page modification request from the user and proceeds to a Chg_Paging_Name_Ret routine 1309 as further described below (see FIG. 28).

The remaining steps of the Paging_Name_Ret_Conf routine 158 correspond, in many respects, in operation and function to the previously described steps of the Phone_Num_Ret_Conf routine 204 of FIG. 20. Accordingly, further description of the steps of the Paging_Name_Ret_Conf routine 158 is unnecessary for a complete understanding of the present embodiment. The steps of the Paging_Name_Ret_Conf routine 158 which generally correspond to those steps of the Phone_Num_Conf routine 204 of FIG. 20 are designated by like reference numerals in the thirteen hundred series.

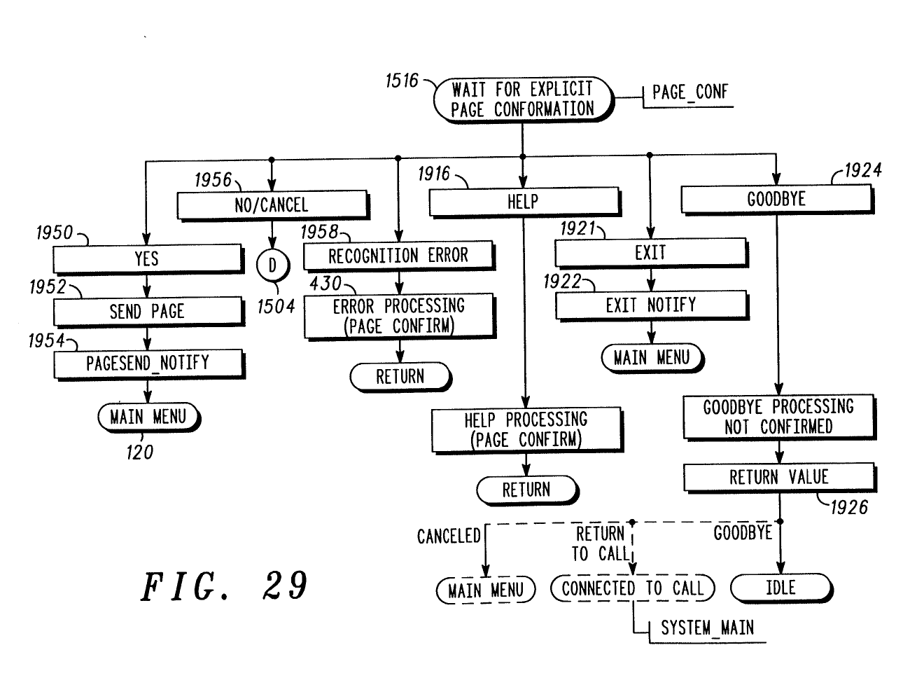

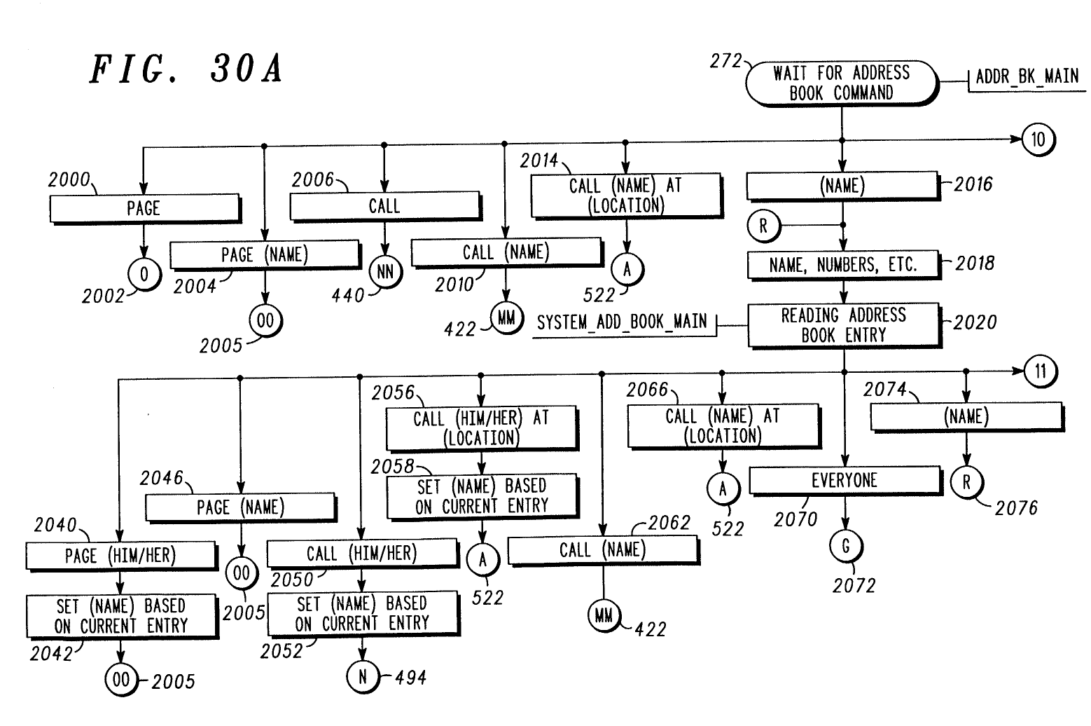

FIG. 24 shows a flow diagram of the Paging_Main routine 144. The Paging_Main routine 144 allows a user to page a party stored in the personal address book of the user. Initially, the node waits for a name of a party from the user. When the node receives a name of a party (i.e., Bob) from the user at block 1400, the node access the user's personal file to determine whether the party has a valid pager PIN number at block 1402. If there is no valid pager PIN number for the party at blocks 1402 and 1404, the node responds “Sorry, invalid pager PIN, new name or start over?” The node then waits for a command from the user and proceeds to a Chg_Paging_Name routine 1406 as further described below (see FIG. 26). If the node accesses a valid pager PIN for the party at block 1402, the node responds “Paging (name) to current location” at blocks 1408 and 1409. The node then waits for a page confirmation from the user and proceeds to the Page_Conf routine 1516 as further described below (see FIG. 29).

The remaining steps of the Paging_Main routine 144 correspond, in many respects, in operation and function to the steps of the Get_Loc routine 198 of FIG. 17. Accordingly, further description of the steps of the Pagin_Main routine 144 is unnecessary for a complete understanding of the present embodiment. The steps of the Paging_Main routine 144 which generally correspond to the steps of the Get_Loc routine 198 of FIG. 17 are designated by like reference numerals in the fourteen hundred series.

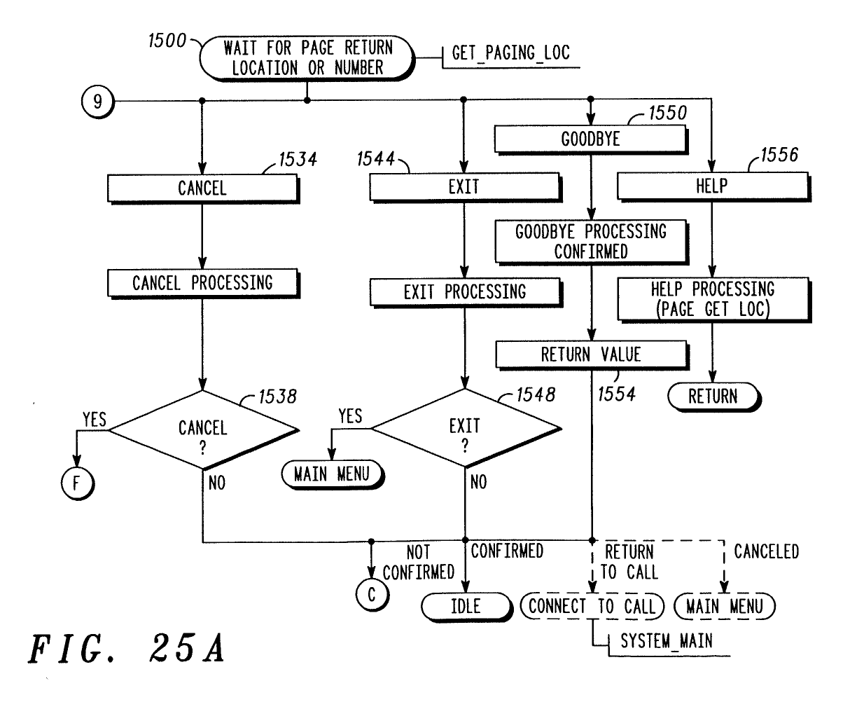

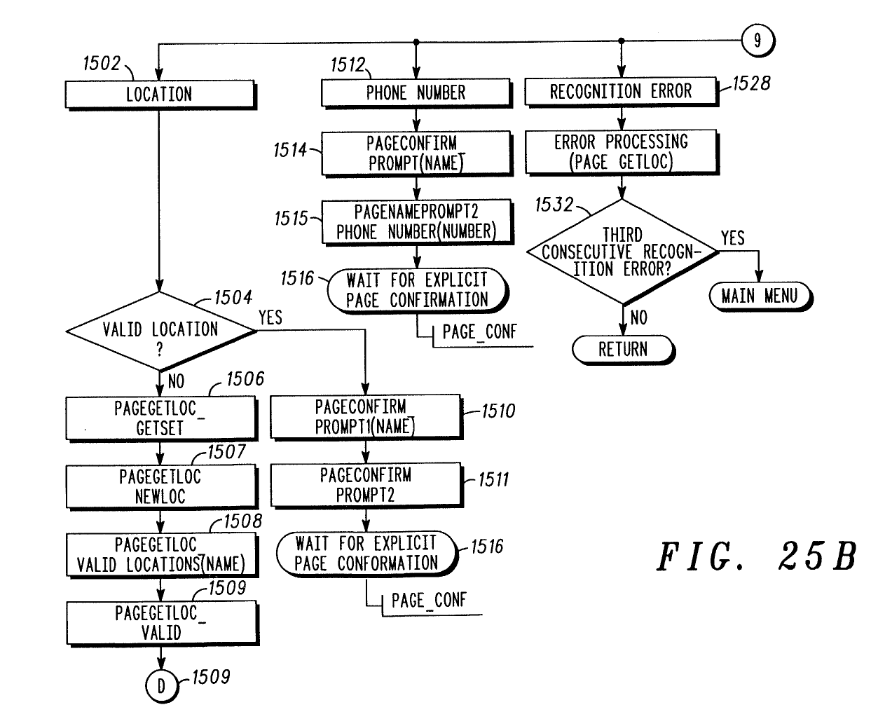

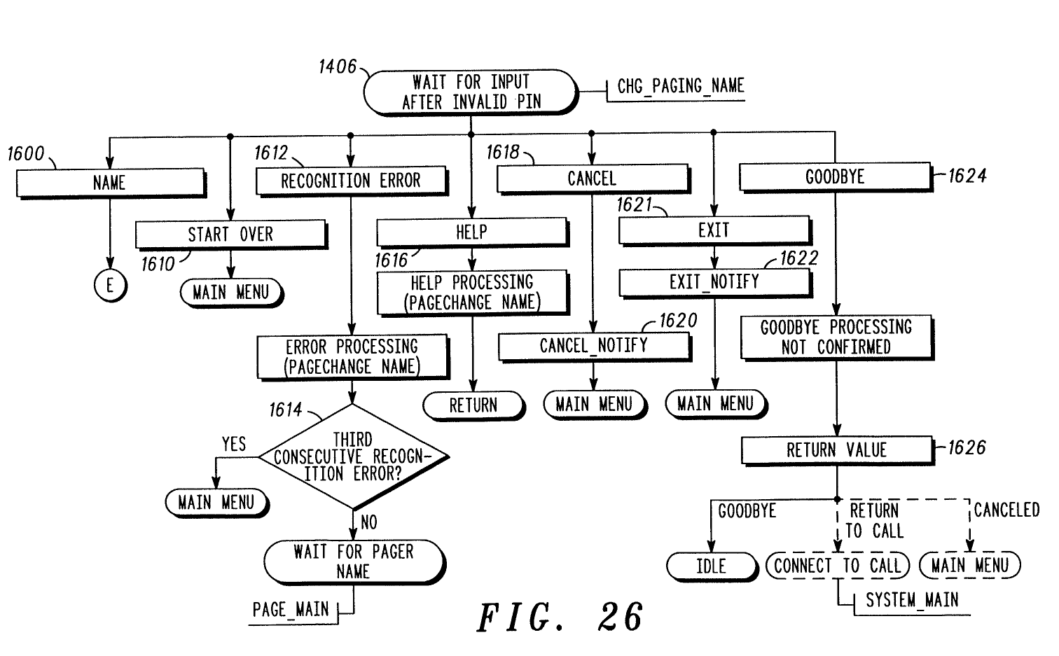

FIG. 25 shows a flow diagram of a Get_Paging_Loc routine 1500. The Get_Paging_Loc routine 1500 allows a user to provide a specific phone number or location from the user's personal address book to use as a call back number. Initially, the node waits for a page return location or call back number from the user.

When the node receives a location (i.e., home, office, etc.) from the user at block 1502, the node determines whether the location is valid at block 1504. If the location is not valid at block 1504, the node responds “No number for that location, say another location or number” at blocks 1506 and 1507 and announces “the valid locations for (name) are (locations)” at blocks 1508 and 1509. The node then proceeds to block 1509. If the location is valid at block 1504, the node responds “Do you wish to page (name) to return call to (location)?” at blocks 1510 and 1511. The node then waits for a command from the user and proceeds to the Page_Conf routine 1516 as further described below (see FIG. 29).

When the node receives a digit string of a phone number (i.e., 630 123 4567) from the user at block 1512, the node responds “Do you wish to page (name) to return call to (location)?” at blocks 1514 and 1515. The node then waits for a command from the user and proceeds to the Page_Conf routine 1516 as further described below.

The remaining steps of the Get_Paging_Loc routine 1500 correspond, in many respects, to the operation and function of the steps of the Paging_Main routine 144 of FIG. 24. Accordingly, further description of the steps of the Get_Paging_Loc routine 1500 is unnecessary for the complete understanding of the present embodiment. The steps of the Get_Paging_Loc routine 1500 which generally correspond to the steps of the Paging_Main routine 144 of FIG. 24 are designated by like reference numerals in the fifteen hundred series.

FIG. 26 shows a flow diagram of a Chg_Paging_Name routine 1406. The Chg_Paging_Name routine 1406 allows a user to enter a new party that the user wishes to page. Initially, the node waits for a command from the user after the node identifies an invalid PIN. The steps of the Chg_Paging_Name routine 1406 correspond, in many respects, in operation and function to the previously described steps of the Change_Name_Loc routine 508 of FIG. 18. Accordingly, further description of the steps of the Chg_Paging_Name routine 1406 is unnecessary for a complete understanding of the present embodiment. The steps of the Chg_Paging_Name routine 1406 which generally correspond to those steps of the Change_Name_Loc routine 508 of FIG. 18 are designated in the sixteen hundred series.

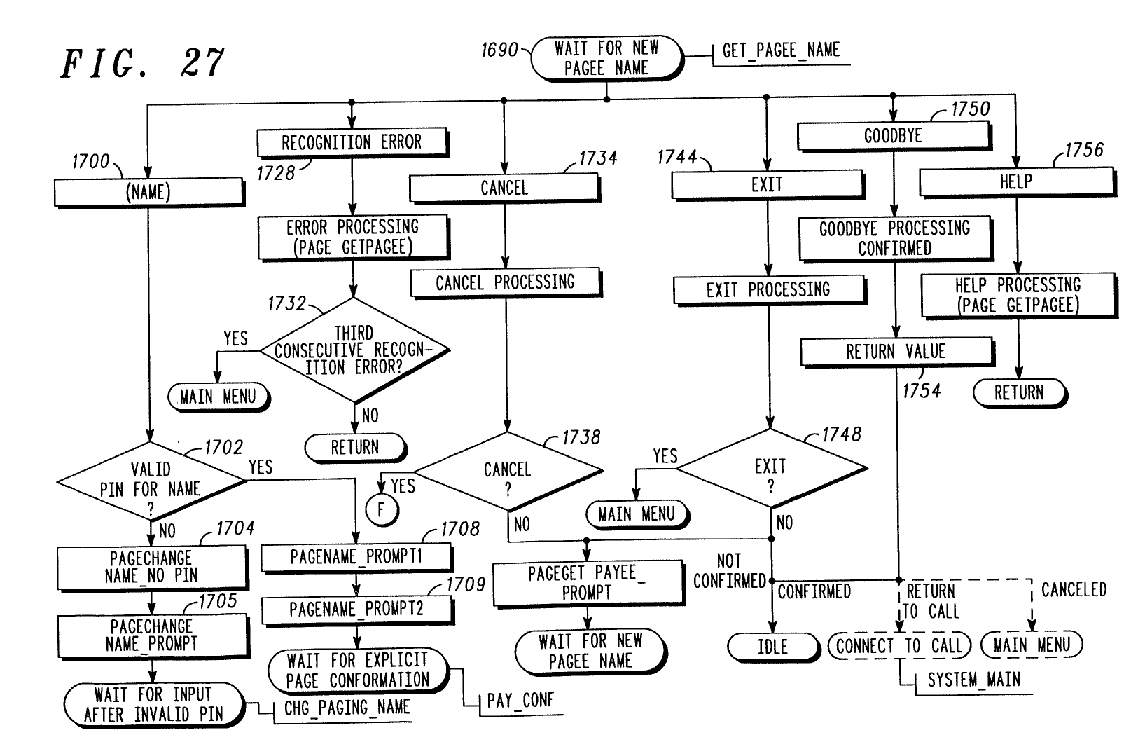

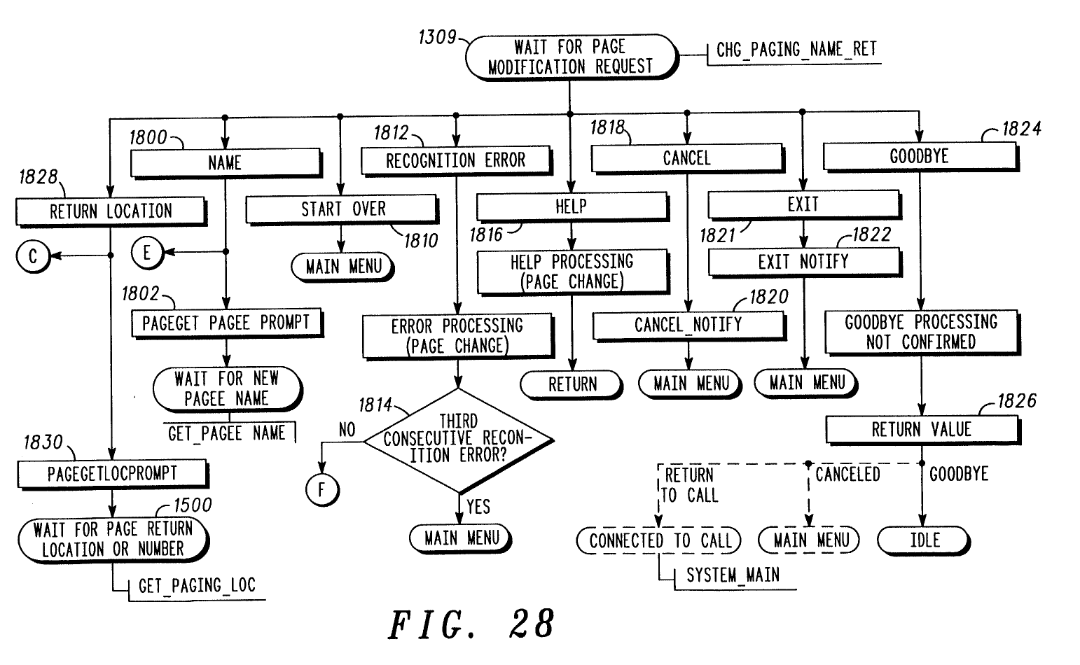

FIG. 27 shows a flow diagram of a Get_Pagee_Name routine 1690. The Get_Pagee_Name routine 1690 allows a user to change 20 name of the party the user desires to page. The node initially waits for a new name for a pagee from the user. The steps of the Get_Pagee_Name routine 1690 correspond, in many respects, in operation and function to the steps of the Paging_Main routine 144 of FIG. 24. Accordingly, further description of the steps of the Get_Pagee_Name routine 1690 is unnecessary for a complete understanding of the present embodiment. The steps of the Get_Pagee_Name routine 1690 which generally correspond to those steps of the Paging_Main routine 144 of FIG. 24 are designated in the seventeen hundred series.

FIG. 28 shows a flow diagram of a Chg_Paging_Name_Ret routine 1309. The Chg_Paging_Name_Ret routine 1309 allows the user to change the return location or call back number of a page and the name of the party to page. Initially, the node waits for a page modification request from the user. When the node receives a “return location” from the user at block 1828, the node responds “Please say a phone number or location” at block 1830. The node then waits for the user to enter a return location (i.e., home, work, mobile phone) or a call back number (i.e., 630 123 4567), and proceeds to the Get_Paging_Loc routine 1500 as further described above (see FIG. 25).

The remaining steps of the Chg_Paging_Name_Ret routine 1309 correspond, in many respects, in operation and function to the previously described steps of the Change_Name_Loc routine 508 of FIG. 18. Accordingly, further description of the steps of the Chg_Paging_Name_Ret routine 1309 is unnecessary for a complete understanding of the present embodiment. The steps of the Chg_Paging_Name_Ret routine 1309 which generally correspond to the steps of the Change_Name_Loc routine 508 of FIG. 18 are designated in like reference numerals in the eighteen hundred series.

FIG. 29 shows a flow diagram of the Page_Conf routine 1516. The Page_Conf routine 1516 allows a user to confirm he or she wants a page to be sent. The node initially waits for a page confirmation from the user. When the node receives a “Yes” command from the user at block 1950, the node sends a page to a paging network at block 1952. When the node receives a page sent indication message from a paging network, the node responds “Page sent” at block 1954. The node then proceeds to the Main Menu routine 120.

When the node receives a “No” command or a “Cancel” command from the user at block 1956, the node proceeds to block 1504. When the node detects a recognition error at block 1958, the node proceeds to the Error Processing routine 430 as further described below (see FIG. 39). The node then proceeds to the beginning of the Page_Conf routine 1516.

The remaining steps of the Page_Conf routine 1516 correspond, in many respects, in operation and function to the steps to the Chg_Paging_Name_Ret routine 1309 of FIG. 28. Accordingly, further description of the steps of the Page_Conf routine 1516 is unnecessary for a complete understanding of the present embodiment. The steps of the Page_Conf routine 1516 which generally correspond to the steps of the Chg_Paging Name_Ret routine 1309 of FIG. 28 are designated by like reference numerals in the nineteen hundred series.

FIGS. 30-32 show a flow diagram of a Addr_Bk_Main routine 272. The Addr_Bk_Main routine 272 allows the user to access the contents of his or her personal file or address book and call or page parties stored in the address book. When the node receives a “Page” command from the user at block 2000, the node proceeds to block 2002. When the node receives a “Page” command followed by a name of a party from the user (i.e., Bob) at block 2004, the node proceeds to block 2005. Upon receiving a “Call” command from the user at block 2006, the node then proceeds to block 440. When the node receives a “Call” command followed by a name of a party from the user (i.e., Jill) at block 2010, the node proceeds to block 422. If the node receives a “Call” command followed by a name of a party and a location at block 2014, the node proceeds to block 522. Upon receiving a name of a party (i.e., Bill Smith) from the user at block 2016, the node announces “Name, numbers, etc.” at block 2018. The node then proceeds to a System_Add_Bk_Main routine 2020 as further described below.

When the node is having difficulty recognizing the commands from the user or detects a recognition error at block 2022, the node proceeds to the Error Processing subroutine 430 as further described below (see FIG. 39). If three consecutive recognition errors have been detected by the node at block 2024, the node proceeds to the Main Menu routine 120. If three consecutive recognition errors have not been detected by the node at block 2024, the node proceeds to the beginning of the Addr_Bk_Main routine 272.

When the node receives a “Help” command from the user at block 2024, the node proceeds to the Help Processing subroutine 458 as further described below (see FIG. 43). The node then proceeds to the beginning of the Addr_Bk_Main routine 272. Upon receiving a “Cancel” command from the user at block 2026, the node responds “Canceling” at block 2028 and then proceeds to the Main Menu routine 120. If the node receives a “Exit” command from the user at block 2030, the node responds “Returning to Main Menu” at block 2032 and then proceeds to the Main Menu routine 120. If the node receives a “Goodbye” command from the user at block 2034, proceeds to the Goodbye Processing Not Confirmed subroutine 232 (see FIG. 42a). The node then determines the value of a “return value” flag at block 2036. When the value of the “return value” flag is equal to “goodbye” at block 2036, the node proceeds to the Idle routine 100 as described above. When the value of the “return value” flag is equal to “return to call” at block 2036, the node connects the user to the call and then proceeds to the System Main routine 214 (see FIG. 22). When the value of the “return value” flag is equal to “canceled” at block 2036, the node proceeds to the Main Menu routine 120.

As shown in FIG. 30, the Add_Bk_Main routine 2020 reads the address book entries to the user. The node can read back all of the parties in the address book or a selected number of parties. While the node is reading an address book entry to the user, the user can select various features of the node.

When the node receives a “Page” command followed by “Him” or “Her” from the user at block 2040, the node selects the name of the party based upon the current entry or party at block 2042 and then proceeds to block 2005. If the node receives a “Page” command followed by the name of a party at block 2046, the node proceeds to block 2005.

When the node receives a “Call” command followed by “Him” or “Her” from the user at block 2050, the node selects the name of the party based upon the current entry or party at block 2056 and then proceeds to block 494. When the node receives a “Call him” or “Call her” command followed by a location of the party from the user at block 2056, the node selects the name of the party based upon the current entry at block 2058 and then proceeds to block 522. Upon receiving a “Call” command followed by the name of a party from the user at block 2062, the node proceeds to block 422. If the node receives a “Call” command followed by a name of a party and a location at block 2066, the node proceeds to block 522.

When the node receives an “Everyone” command from the user at block 2070, the node proceeds to block 2072. Upon receiving a name of a party from the user at block 2074, the node proceeds to block 2076. When the node receives a “Category” command from the user at block 2078, the node proceeds to block 2080.

If the node is having difficulty recognizing the commands from the user or detects a recognition error at block 2082, the node proceeds to the Error Processing subroutine 430 as further described below (see FIG. 39). If three consecutive recognition errors have been detected by the node at block 2084, the node proceeds to the Main Menu 120. If three consecutive recognition errors have not been detected by the node at block 2084, the node then waits for an address book command from the user and proceeds to the beginning of the Addr_Bk_Main routine 272.

Referring still to FIG. 30, when the node receives a “Help” command from the user at block 2084, the node proceeds to the Help Processing subroutine 458 as further described below (see FIG. 43). The node then proceeds to the beginning of the Addr_Bk_Main routine 272. Upon receiving a “Cancel” command from the user at block 2086, the node cancels the current operation at block 2088 and then proceeds to the Main Menu routine 120. When the node receives an “Exit” command from the user at block 2090, the node responds “Returning to Main Menu” at block 2092 and then proceeds to the Main Menu routine 120. Upon receiving a “Goodbye” command from the user at block 2094, the node proceeds to the Goodbye Processing Not Confirmed 232 (see FIG. 42a). At block 2096, the node determines the value of a “return value” flag. When the value of the “return value” flag is equal to “Goodbye” at block 2096, the node proceeds to the Idle routine 100. When the value of the “return value” flag is equal to “return to call” at block 2096, the node connects the user to the call and then proceeds to the System_Main routine 214 (see FIG. 22). When the value of the “return value” flag is equal to “canceled” at block 2096, the node proceeds to the Main Menu routine 120. When the user has completed entering a name of a party at block 2098, the node proceeds to block 2099.

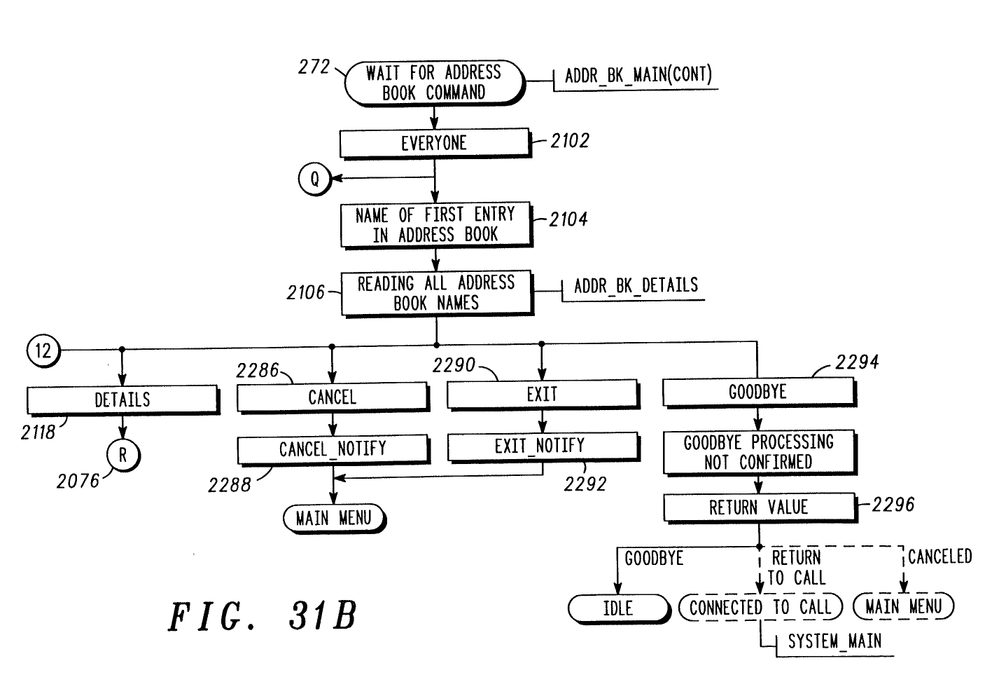

Referring now to FIG. 31, the node initially waits for an address book command from the user. When the node receives an “Everyone” command from the user at block 2102, the node accesses the address book of the user and responds “Name of first entry in address book” at block 2104. The node begins to read all of the names in the address book to the user and then proceeds to a Addr_Bk_Details routine 2106. The Address_Bk_Details routine 2106 allows the user to select various features of the node while the node is reading the names of the parties to the user. For example, the user can page or call a party or request details (i.e., an address) of a particular party.

When the call control of the node indicates that an address book entry has been read at block 2108, the node determines whether all entries have been completed at block 2110. If all entries have been read at block 2110, the node proceeds to the Idle routine 100. If all entries have not been read at block 2110, the node retrieves the next entry of the address book at block 2112 and responds “Reading name of next entry” at block 2114. The node then reads the name of the entry and proceeds to the beginning of the Addr_Bk_Details routine 2106. When the node receives a “Details” command from the user at block 2118, the node proceeds to block 2076 to provide various details (i.e., addresses, etc.) of a party.

The remaining steps of the Addr_Bk_Details routine 2106 correspond, in many respects, in operation and function to the previously described steps of the System_Add_Bk_Main routine 2020 of FIG. 30. Accordingly, further description of the steps of the Add_Bk_Details routine 2106 is unnecessary for a complete understanding of the present embodiment. The steps of the Addr_Bk_Detail routine 2106 which generally correspond to the steps of the System_Add_Bk_Main routine 2020 of FIG. 30 are designated by like reference numerals in twenty-two hundred series.

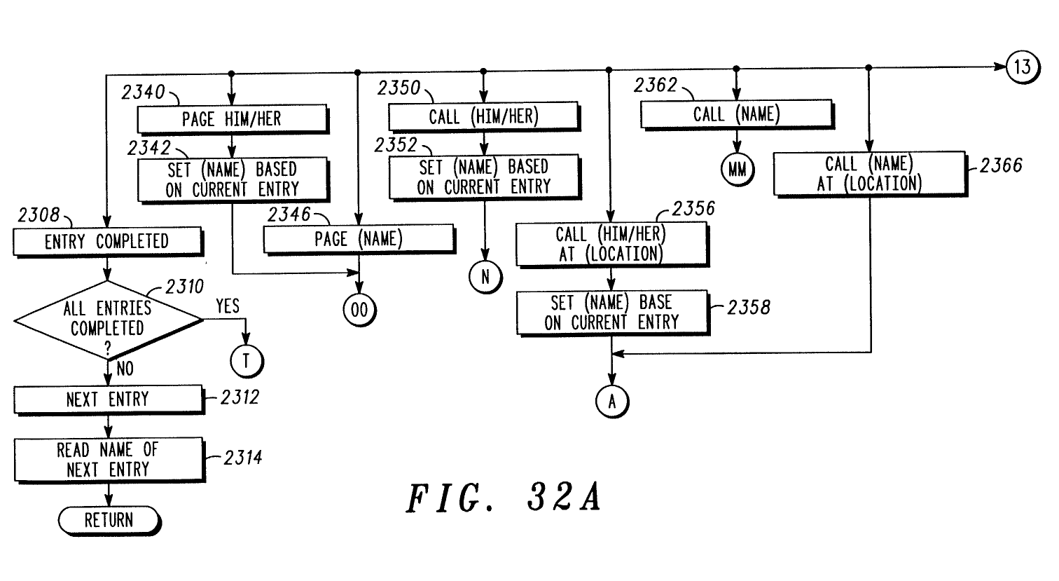

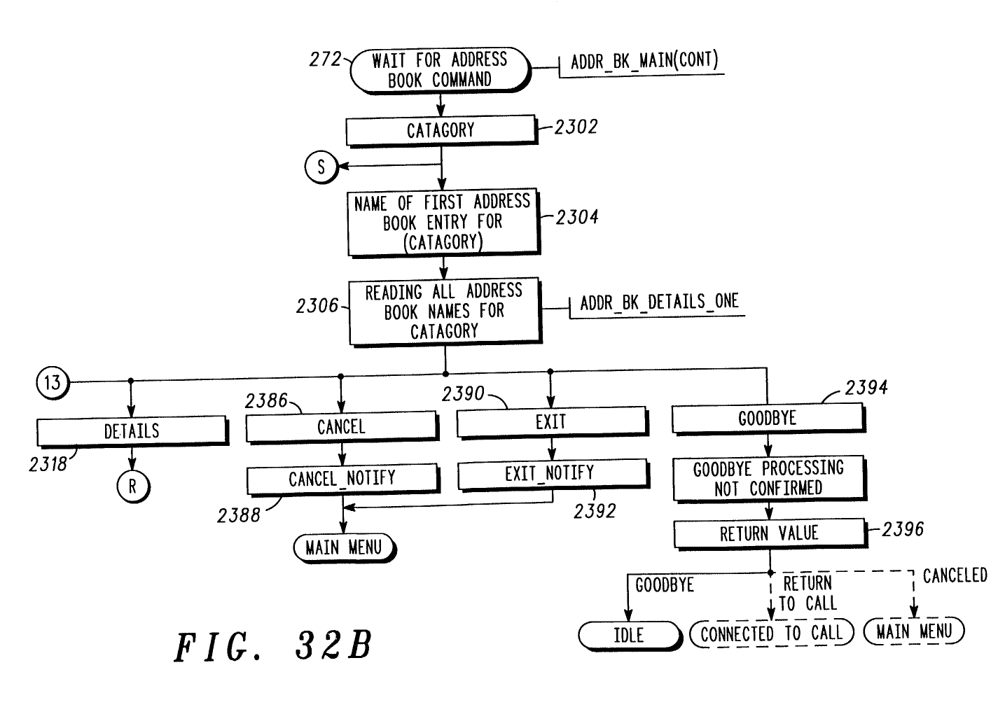

Referring now to FIG. 32, the node waits for an address book command from the user. When the node receives a “Category” command from the user (i.e., business contacts, friends, family, etc.) at block 2302, the node responds “Name of first address book entry for (category)” at block 2304. The node then begins to read all of the parties in the address book for the selected category and then proceeds to a Addr_Bk_Details_One routine 2306.

The steps of the Addr_Bk_Details_One 2306 correspond, in many respects, in operation and function to the steps of the Addr_Bk_Details routine 2106 of FIG. 31. Accordingly, further description of the steps of the Add_Bk_Details_One routine 2306 is unnecessary for a complete understanding of the present embodiment. The steps of the Addr_Bk_Details_One routine 2306 which generally correspond to the steps of the Addr_Bk_Details routine 2106 of FIG. 31 are designated by like reference numerals in the twenty-three hundred series.

FIG. 33 shows a flow diagram of a VoiceNote_GetNames routine 304. The VoiceNote_GetNames routine 314 allows the user to store, retrieve, and send voice mail messages. For example, the users can e-mail a recorded message (i.e., a voice note) to a party stored in the user's personal address book or a designated contact. Initially, the node waits for the user to enter a name of a party.

When the node receives a name of a party (i.e., Bob) from the user at block 2400, the node determines whether there is a valid e-mail address for the party at block 2402. If there is not a valid e-mail address for the party at block 2402, the node proceeds to the VoiceNote_GetNames_One routine 2404 as further described below. If there is a valid e-mail address for the party at block 2402, the node adds the name of the party to a list at block 2406. The node then proceeds to the VoiceNote_GetNames_One routine 2404.

The VoiceNote_GetNames routine 2404 waits for the next name of a party from the user. When the node receives a name of a party at block 2408, the node determines whether there is an e-mail address for the name of the party at block 2410. If there is not a valid e-mail address for the name of the contact at block 2410, the node proceeds to the beginning of the VoiceNote_GetNames_One routine 2404. If there is a valid e-mail address for the name of the party at block 2410, the node adds the name of the party to the list at block 2412 and then proceeds to the beginning of the VoiceNote_GetNames_One routine 2404.

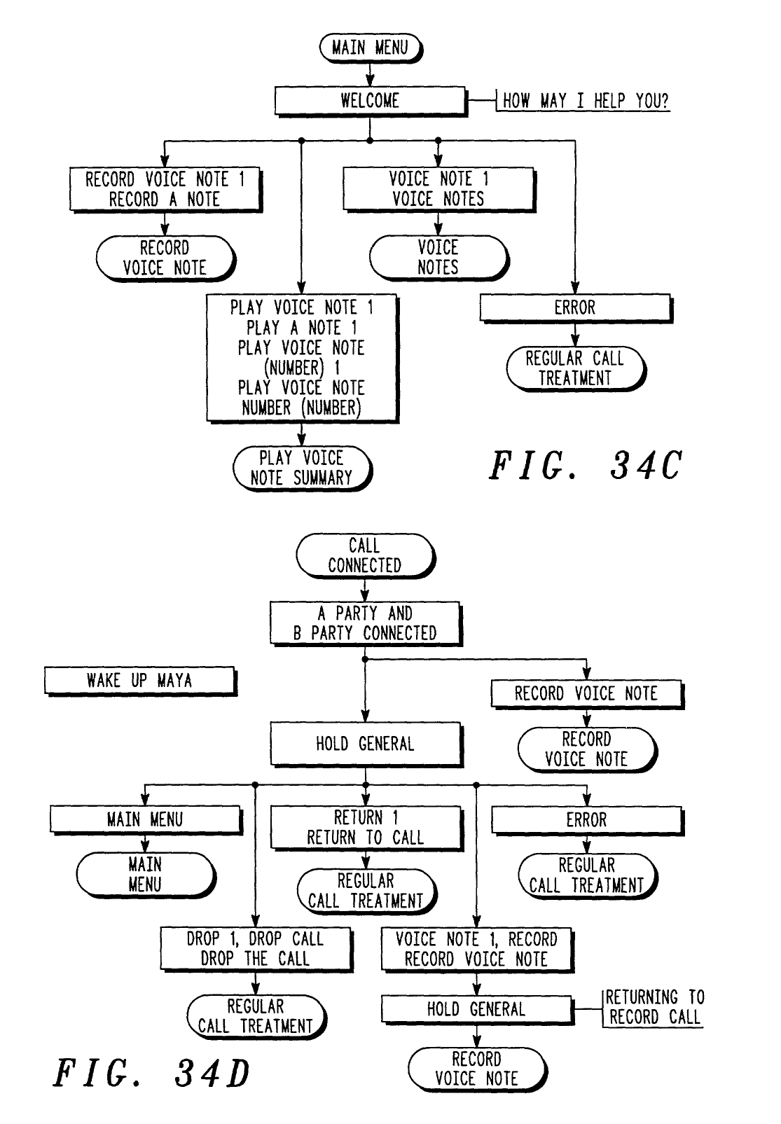

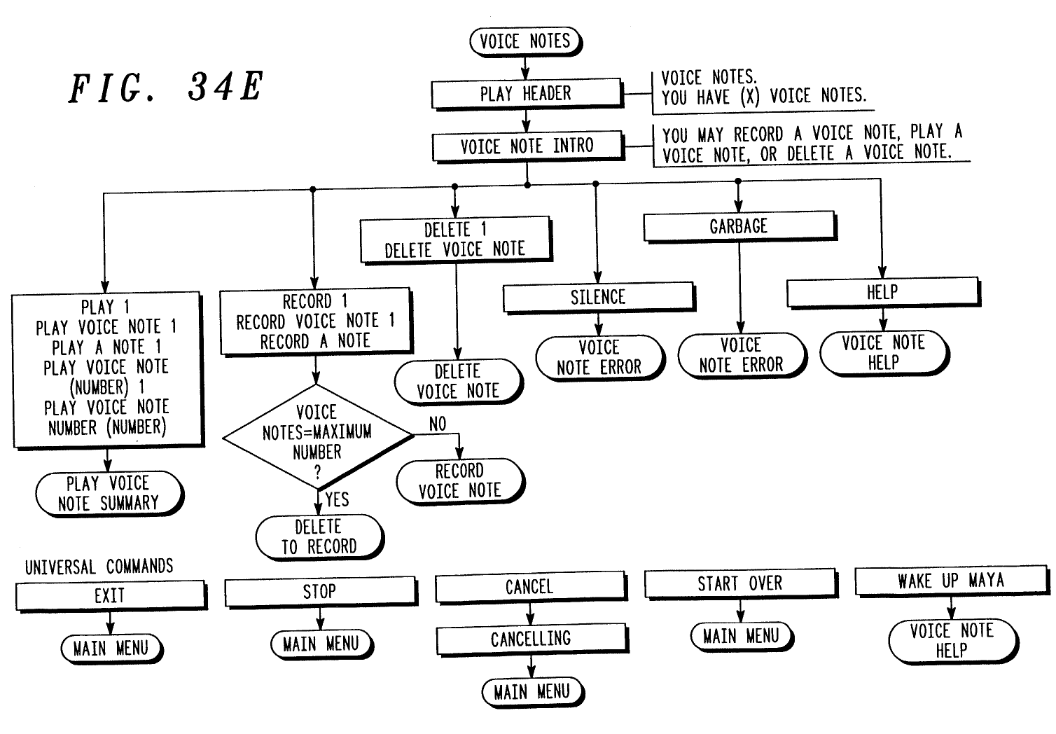

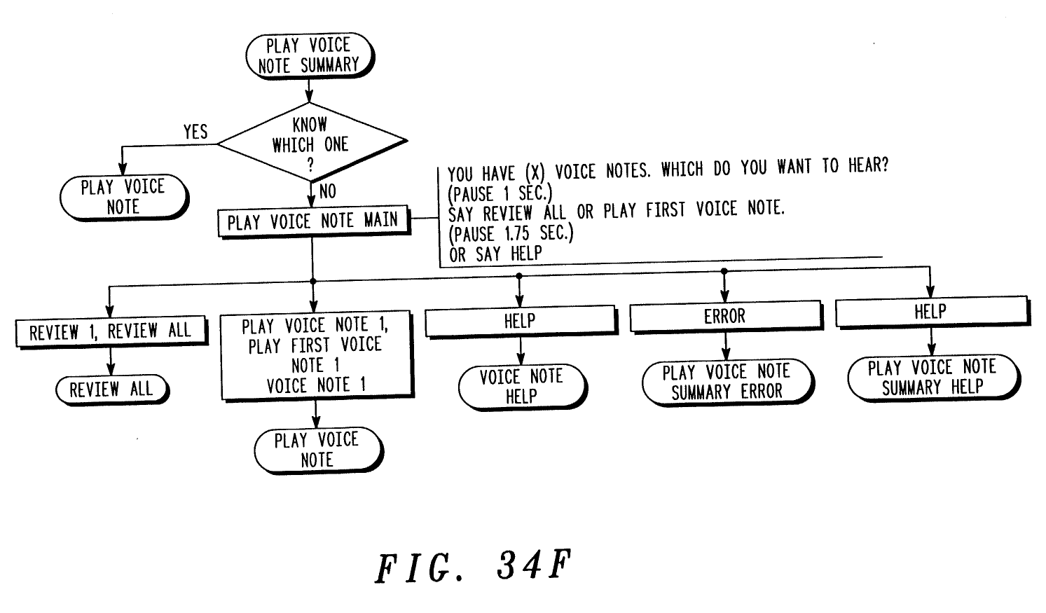

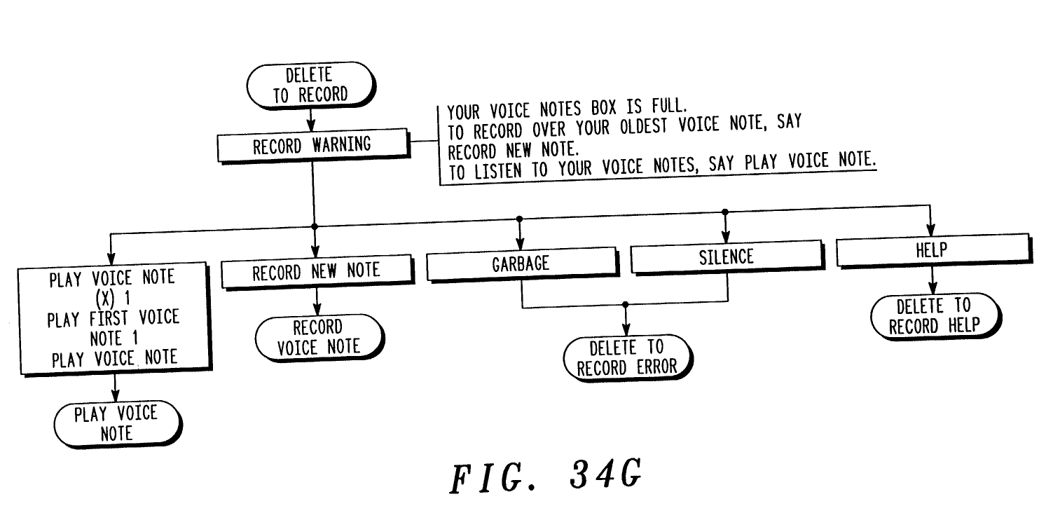

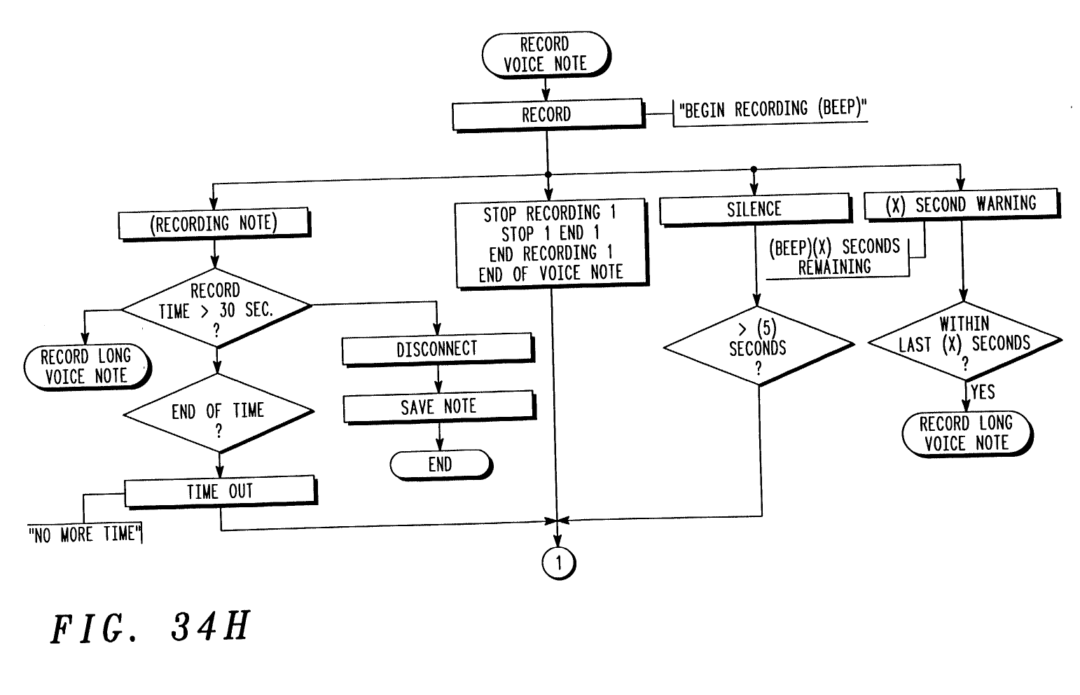

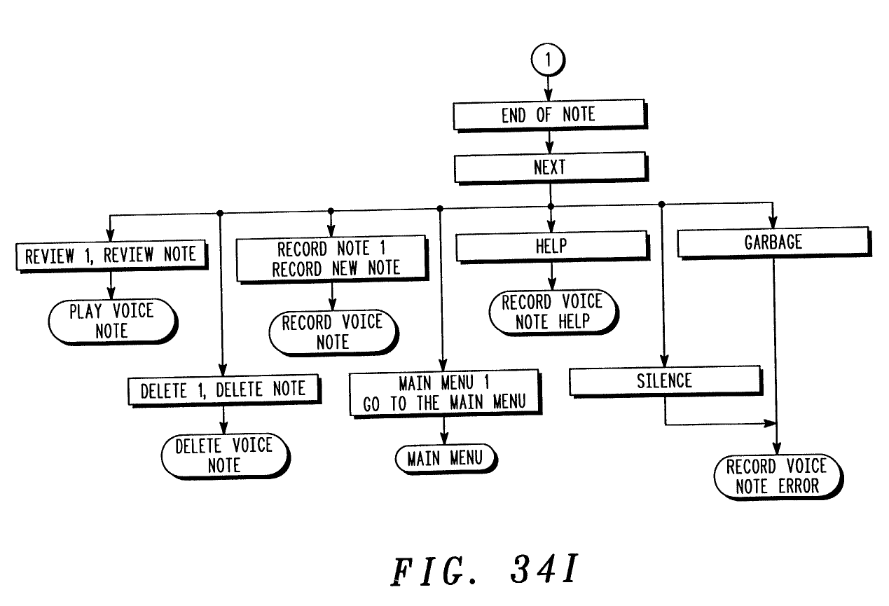

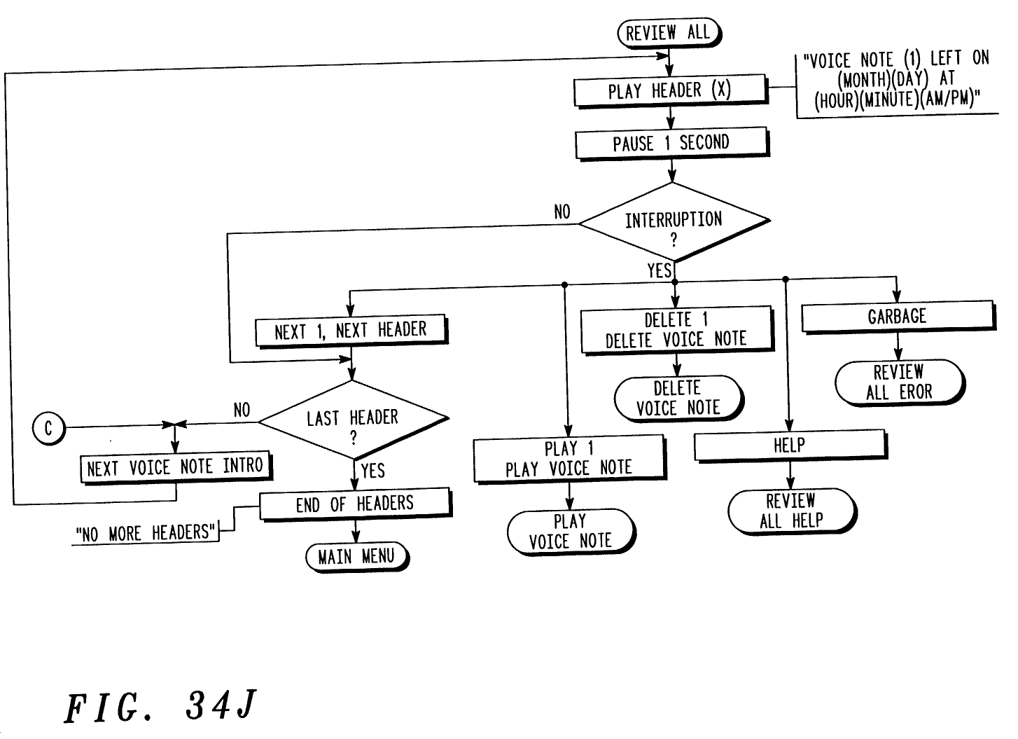

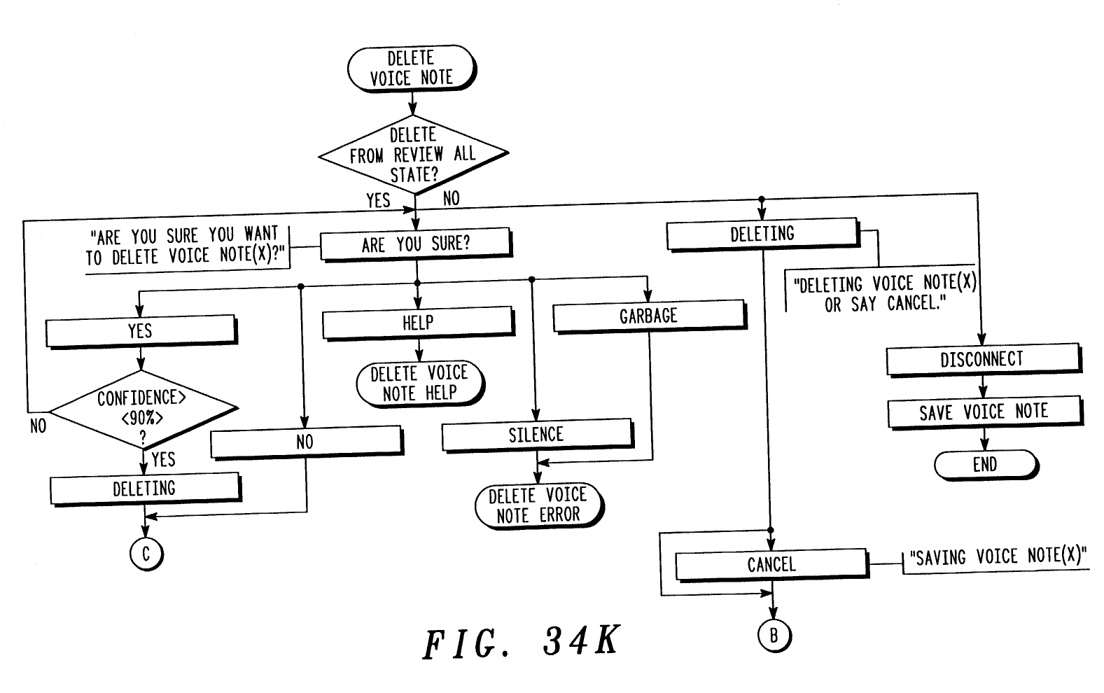

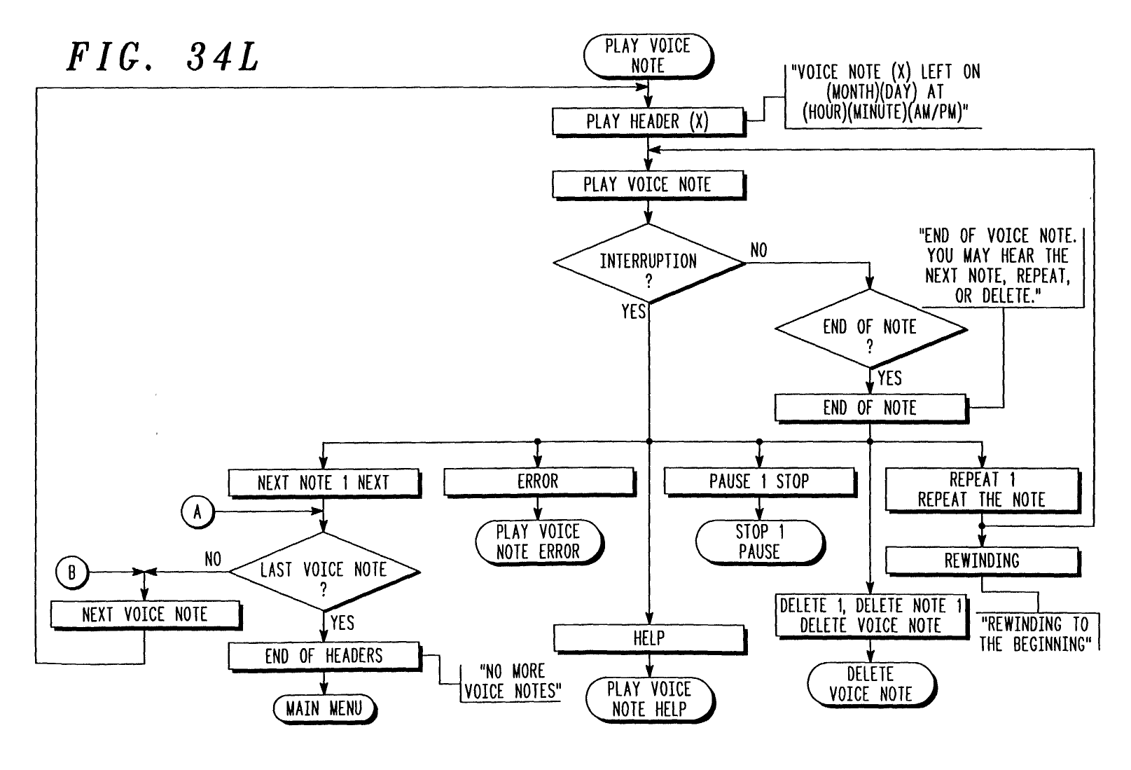

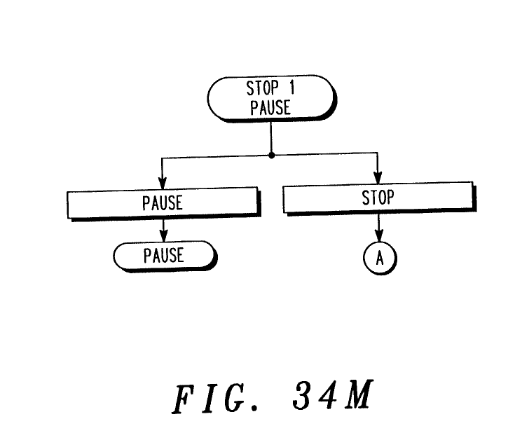

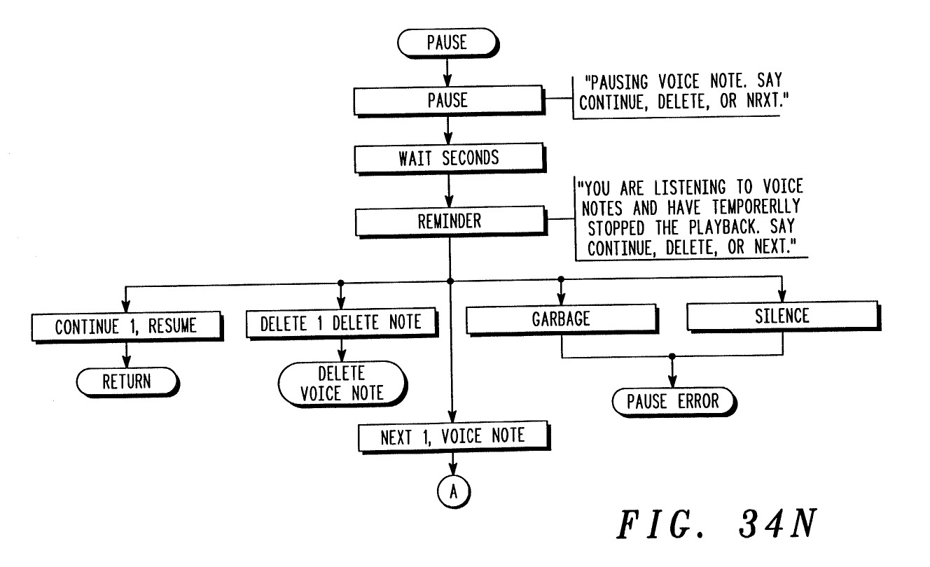

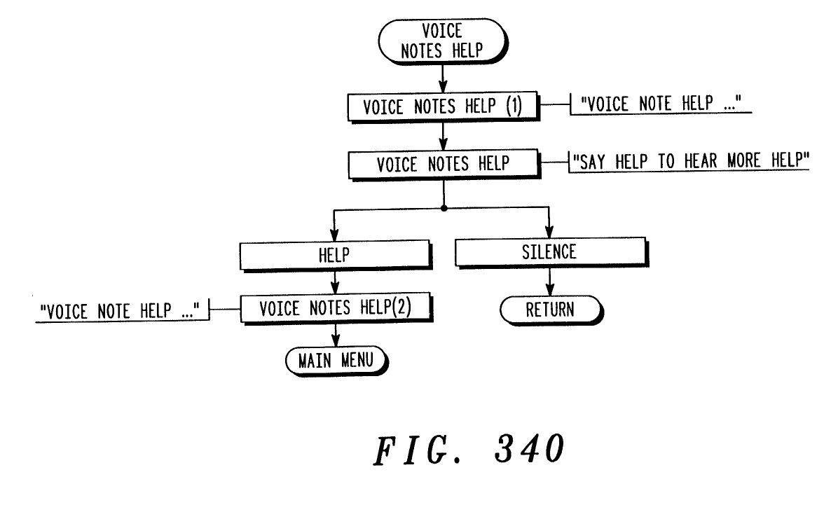

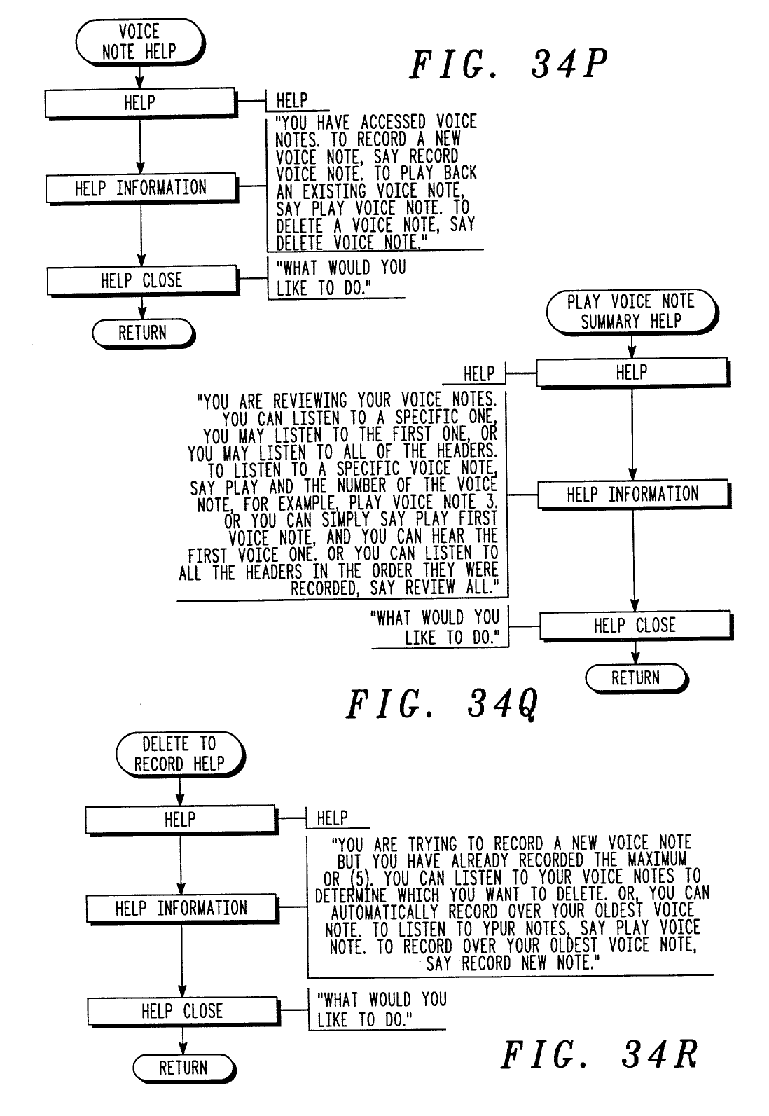

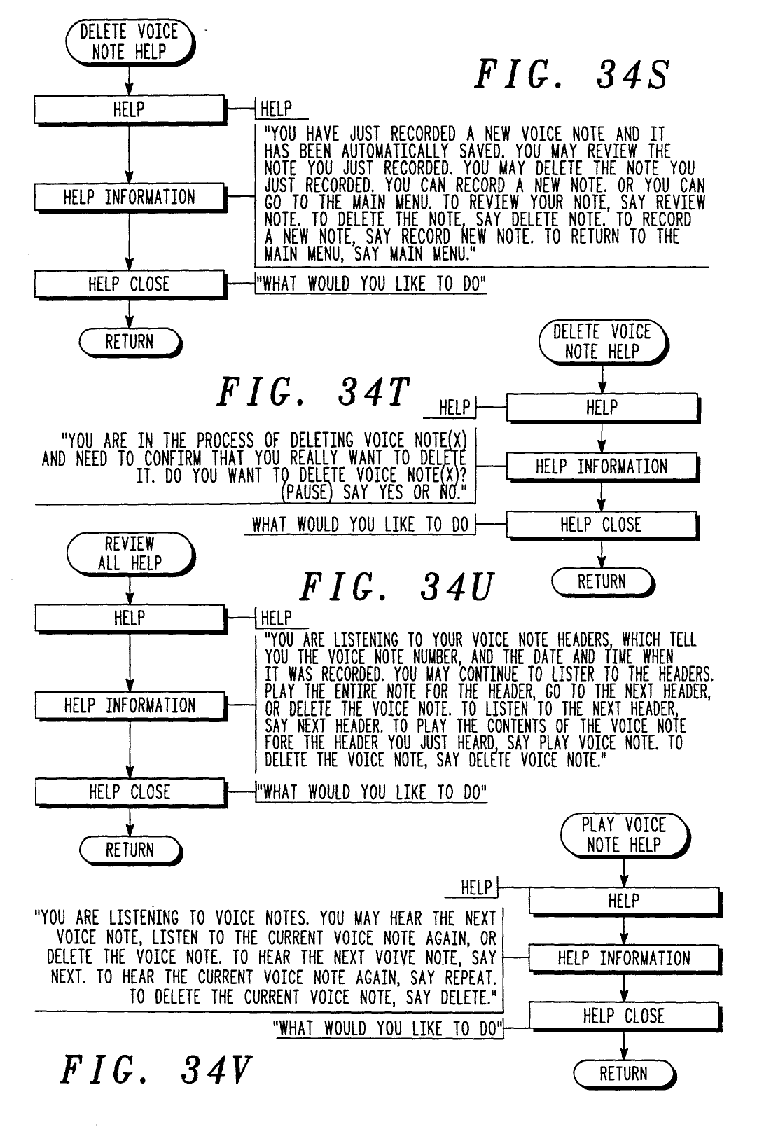

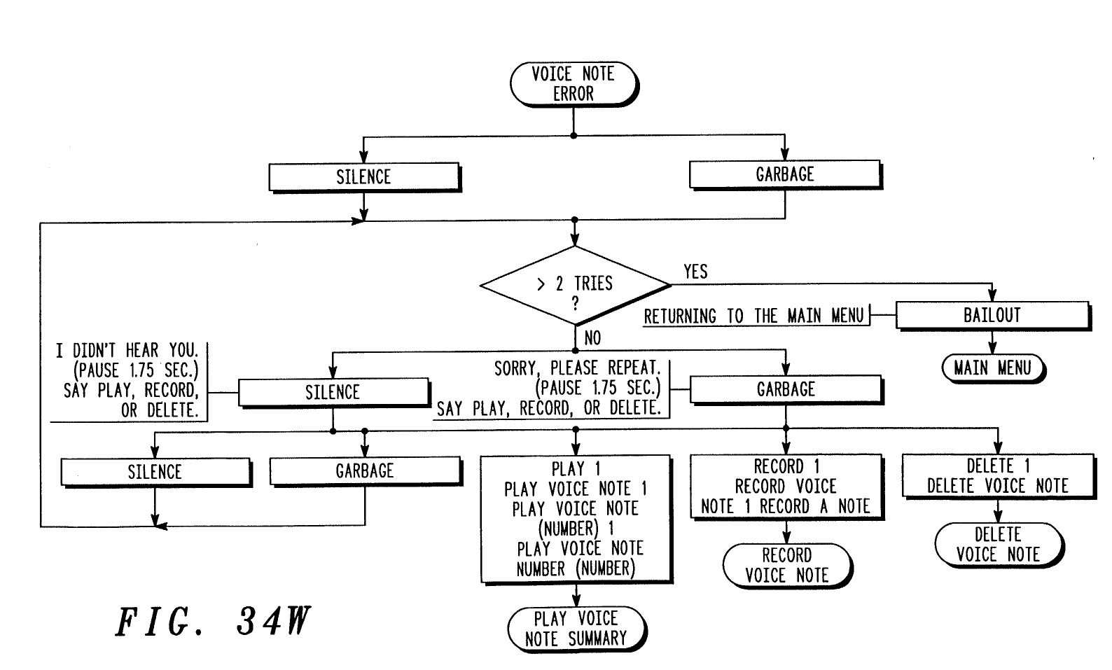

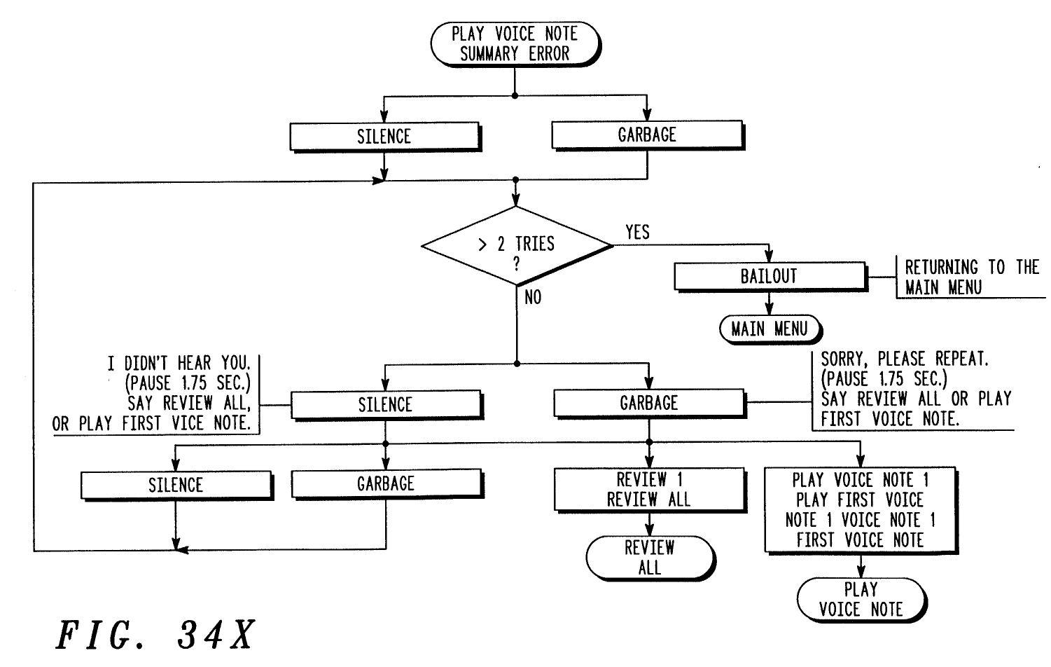

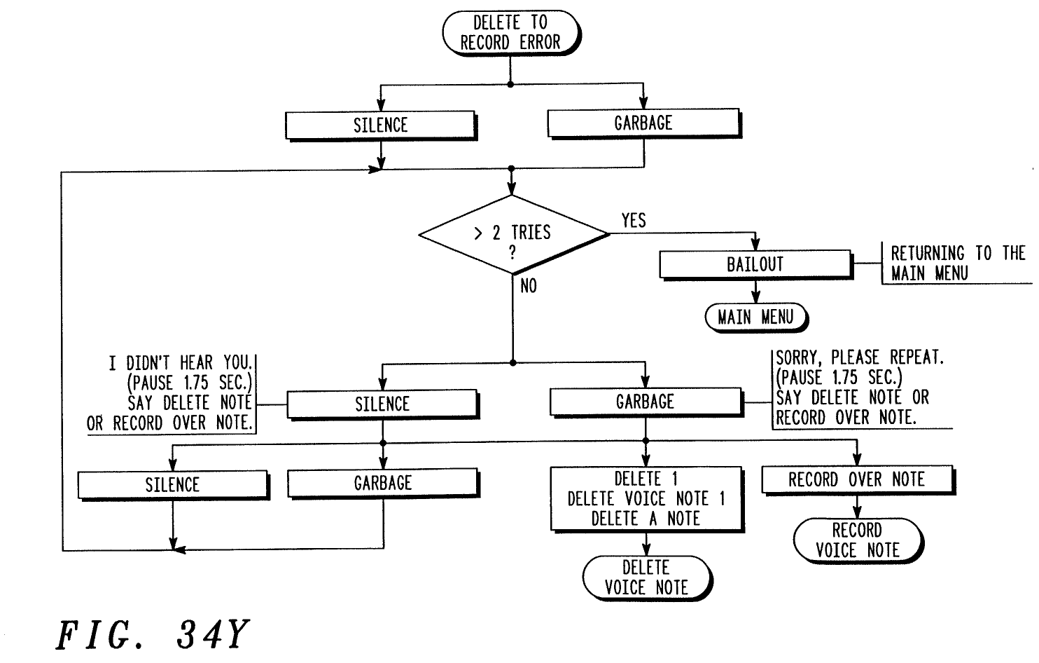

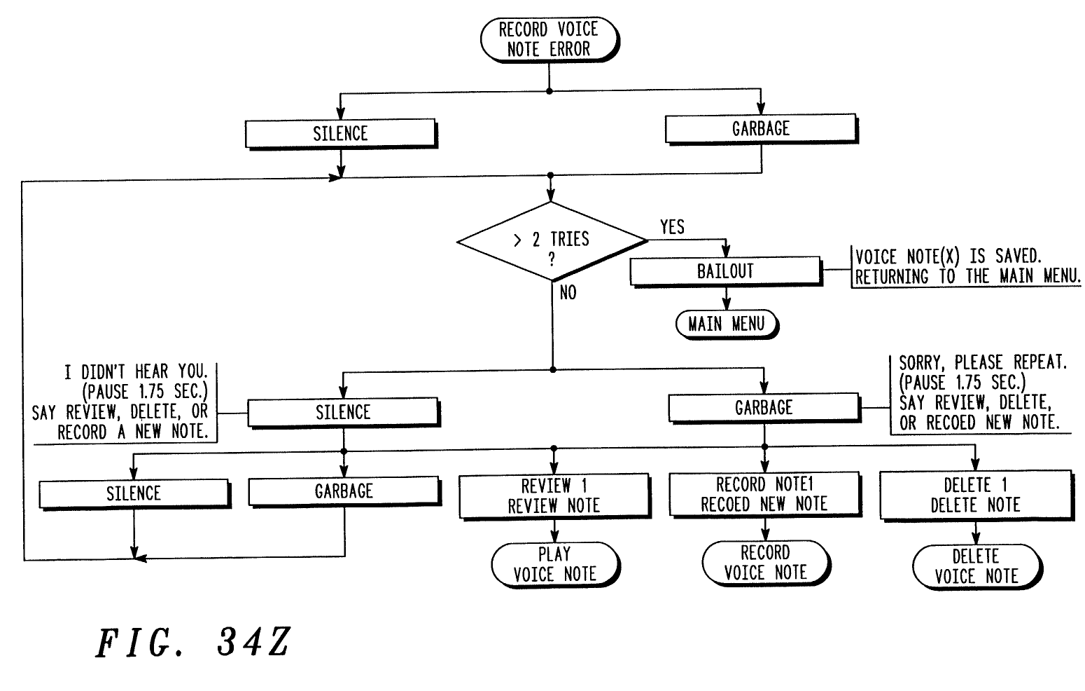

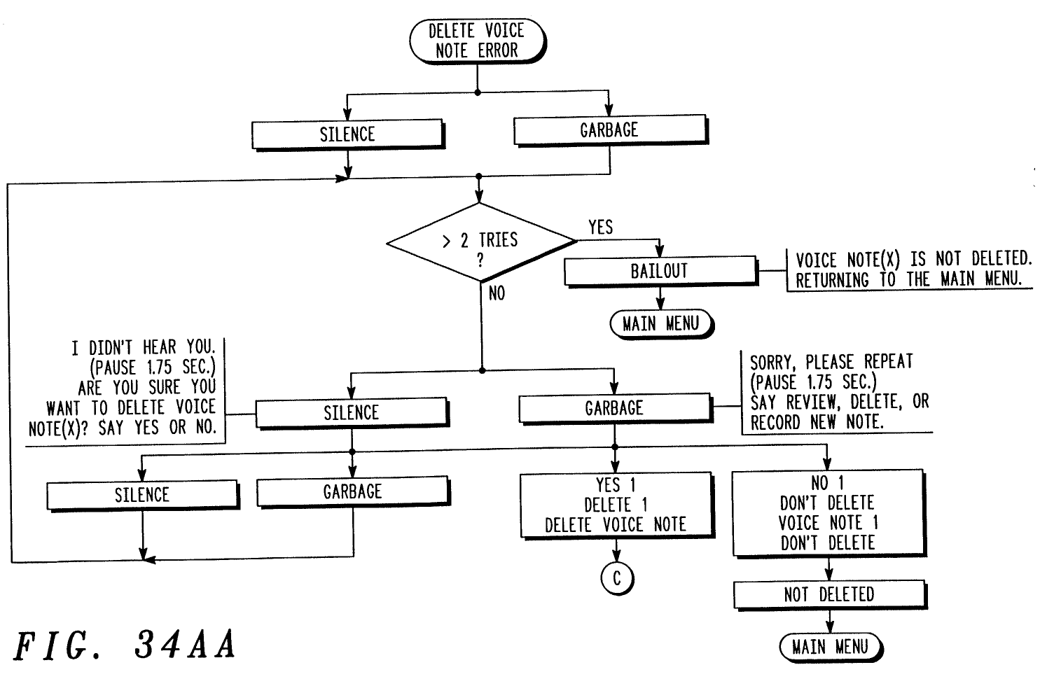

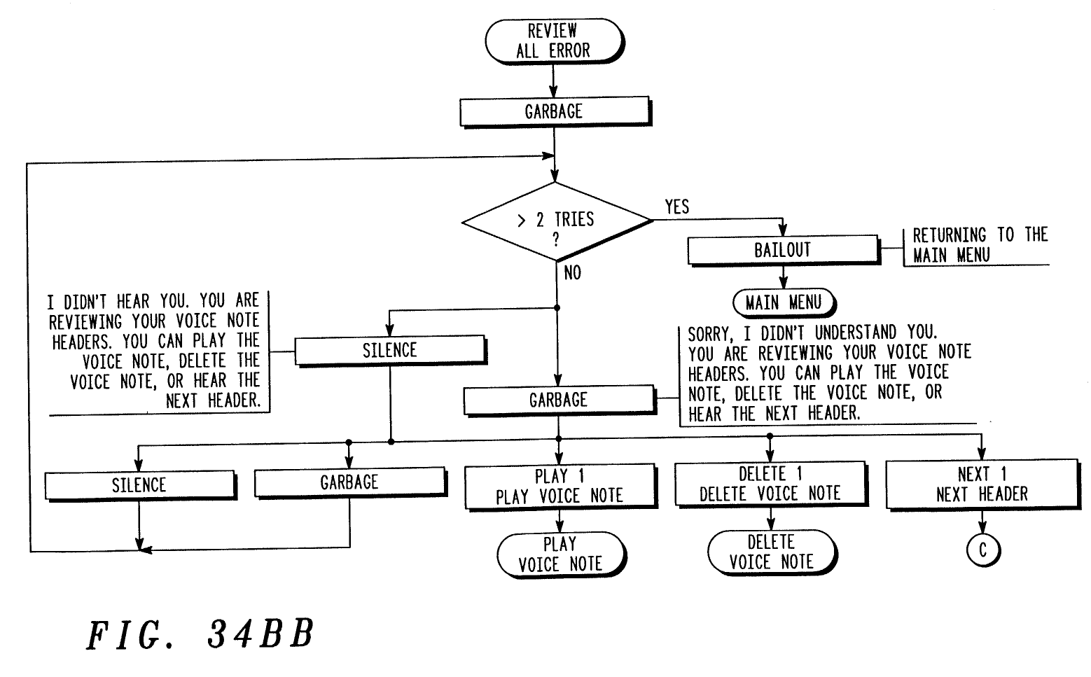

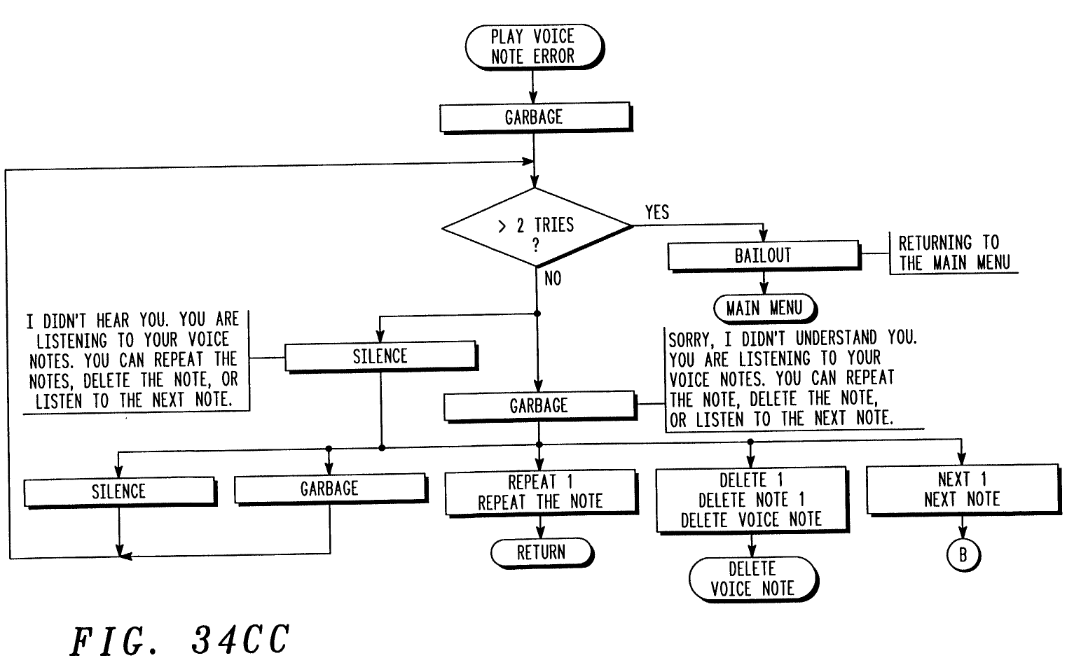

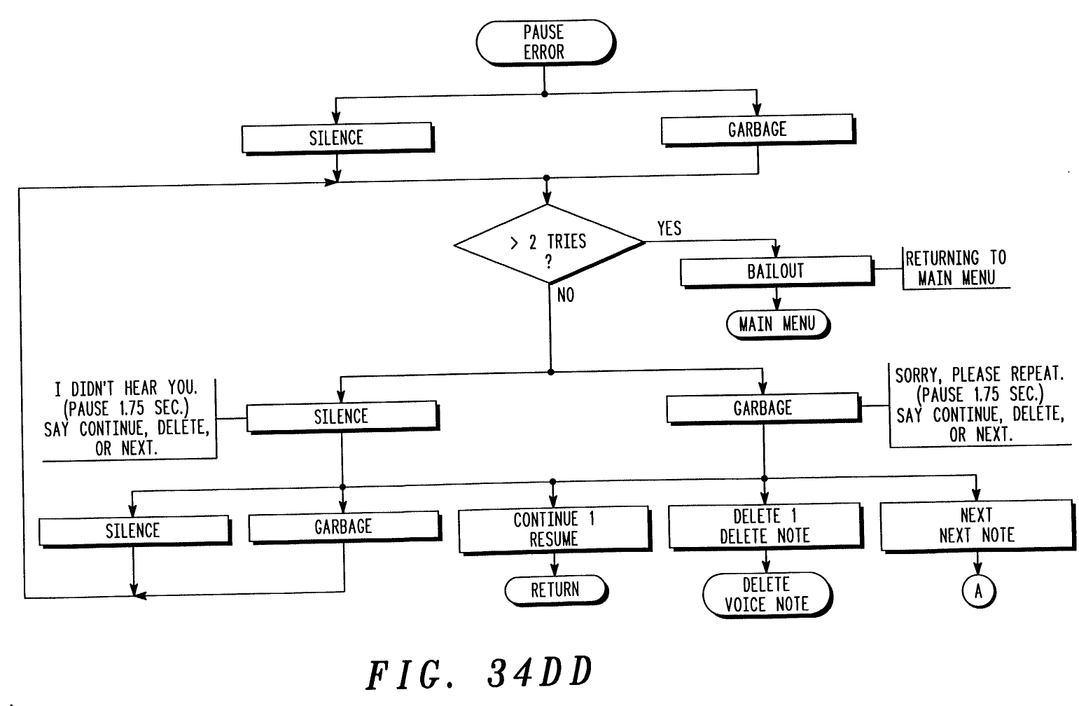

When the node does not receive a name of a party from the user within a certain period of time at block 2414, the node times out and the node responds “Recognized” indicating that the voice command was recognized by the node at block 2416. The node then determines whether the names are on the list at block 2418. If there are no names on the list at block 2418, the node responds “No names” at block 2420 and proceeds to block 2421. If the node determines that the list contains at least one name at block 2418, the node plays back the names on the list at block 2422 and announces “Please record your voice note after the tone” at block 2424. The node records the voice note and then proceeds to Fp_Sp_Rec_Gr routine 2425 as further described below (see FIG. 34).

Referring now to FIG. 34, a flow diagram of the Fp_Sp_Rec_Gr routine 2425 is illustrated. The Fp_SP_Rec_Gr routine 2425 allows a user to send, review, re-record, and cancel voice notes. Initially, the node is recording a voice note from a user.

If the name or e-mail address is recognized by the node or no recognition errors are detected by the node at block 2500, the node continues to record the user's voice communication or note at block 2502. The node then determines whether the voice note recording is completed at block 2504. The node can determine when the user has finished recording the voice note by detecting a period of silence at block 2506. At block 2508, the node determines whether the length of a voice note has exceeded a maximum length. At block 2510, the node announces “Would you like to review, send, or re-record the voice note?” The node then proceeds to a Fp_Sp_Conf_Gr_One routine 2512.

The Fp_Sp_Conf_Gr_One routine 2512 allows the user to send, review, re-record, and cancel the voice note. When the node receives a “Send” command from the user at block 2530, the node sends the voice note to the destination at block 2532 and responds “voice note sent” at block 2534. The node the node proceeds to the Main Menu routine 120.

When the node receives a “Review” command from the user at block 2536, the node plays back the recorded voice note to the user at block 2538 and the node proceeds to block 2540. If the node receives a “Re-record” command from the user at block 2542, then proceeds to block 2544.

When the node receives a “Cancel” command from the user at block 2546, the node proceeds to the Canceling Processing routine 436 as further described below (see FIG. 41). The node then determines whether to cancel the voice note operation at block 2548. If the user desired to cancel the voice note operation, the node proceeds to the Main Menu routine 120. If the user does not wish to cancel the voice note operation at block 2548, the node proceeds to block 2540.

When the node receives an “Exit” command from the user at block 2552, the node proceeds to the Exit Processing subroutine 446 as further described below (see FIG. 40). At block 2554, the node determines whether the user wishes to exit the node. If the user desires to exit the voice note operation at block 2554, the node proceeds to the Main Menu routine 120. If the user does not wish to exit the voice note operation at block 2554, the node proceeds to block 2540.

When the node receives a “Goodbye” command from the user at block 2556, the node proceeds to the Goodbye Processing Confirmed subroutine 452 as further described below (see FIG. 42). If the user desires to leave the node at block 2558, the node proceeds to the Idle routine 100. If the user does not desire to leave the node at block 2558, the node proceeds to block 2540.

When the node is having difficulty recognizing the commands from the user or detects a recognition error at block 2560, the node proceeds to the Error Processing subroutine 430 as further described below (see FIG. 39). If three consecutive recognition errors have been detected by the node at block 2562, the node proceeds to the Main Menu routine 120. If three consecutive recognition errors have not been detected by the node at block 2562, the node proceeds to block 2540.

Referring still to FIG. 34, when the node receives a “Cancel” command from the user at block 2514, the node proceeds to the Cancel Processing subroutine 436 as further described below (see FIG. 42). The node then determines whether to cancel the voice note recording at block 2516. If the user desires to cancel the voice note operation at block 2516, the node proceeds to block 2518. If the user does not wish to cancel the voice note at block 2516, the node proceeds to the Main Menu routine 120 as described above.

When the node is having difficulty recognizing the commands from the user or detects a recognition error at block 2520, the node proceeds to the Main Menu routine 120. When the node receives an “Exit” command from the user at block 2522, the node proceeds to the Exit Processing subroutine 446 as further described below (see FIG. 40). The node then determines whether to exit the voice note operation at block 2524. If the user desires to exit the voice note operation at block 2524, the node proceeds to the Main Menu routine 120. If the user does not wish to exit the voice note operation at block 2524, the node proceeds to block 2518.

When the node receives a “Goodbye” command from the user at block 2526, the node proceeds to the Goodbye Processing Confirmed subroutine 452 as further described below (see FIG. 42). If the user wishes to leave the node at block 2528, the node proceeds to the Idle routine 100. If the user does not wish to leave the node at block 2528, the node proceeds to block 2518.

FIGS. 34a-34bb illustrate flow diagrams of another voice note routine to process voice notes.

FIG. 35 shows a flow diagram of the Fp_Sp_Rec_Gr_System routine 324. The Fp_Sp_Rec_Gr System routine 324 allows the user to record, review, send or re-record feedback messages. The steps of Fp_Sp_Rec_Gr_System routine 324 correspond, in many respects, in operation and function to the previously described steps of the Fp_Sp_Rec_Gr routine 2425 of FIG. 34. Accordingly, further description of the steps of the Fp_Sp_Rec_Gr_System routine 324 is unnecessary for a complete understanding of the present embodiment. The steps of the Fp_Sp_Rec_Gr_System routine 324 which generally correspond to the steps of the Fp_Sp_Rec_Gr routine 2425 of FIG. 34 are designated by like reference numerals in the twenty-six hundred series.

FIG. 36 shows a flow diagram of the Weather_Main routine 384. The Weather_Main routine 384 accesses weather information from the electronic network or a content provider (i.e., the weather channel) and allows a user to access designated city weather, short term weather forecasts, long term weather forecasts, etc. Initially, the node waits for the user to enter a weather forecast duration command.

When the node receives a “Today's” command from the user at block 2700, the node responds “Today's weather forecast” at block 2702 and then begins to read today's weather forecast to the user at block 2703. The node then proceeds to a Today_Weather routine 2710.

The Today_Weather routine 2710 allows a user to repeat, cancel, and exit the weather operation. When the node receives a “Repeat” command from the user at block 2750, the node proceeds to block 2752. Upon receiving a “Help” command from the user at block 2753, the node proceeds to the Help Processing routine 450 (see FIG. 43) and then proceeds to block 2758 as further described below. When the node receives a DTMF tone at block 2754, a “Completed” command at block 2756, or an “Exit” command from the user at block 2758, the node responds “Exiting weather information” at block 2758 and then proceeds to the Main Menu routine 120.

When the node receives a “Goodbye” command from the user at block 2760, the node proceeds to the Goodbye Processing Not Confirmed subroutine 232 (see FIG. 42). At block 2762, the node determines the value of a “return value” flag. When the value of the “return value” flag is equal to “Goodbye” at block 2762, the node proceeds to the Idle subroutine 100. When the value of the “return value” flag is equal to “return to call” at block 2762, the node connects the user to the call and then proceeds to the System_Main routine 214 (see FIG. 22). When the value of the “return value” flag is equal to “canceled” at block 2762, the node proceeds to the Main Menu routine 120. If the node receives a “Cancel” command from the user at block 2764, the node responds “Canceling” at block 2766 and then proceeds to the Main Menu routine 120.

As shown in FIG. 36, when the node receives a “Five day” command from the user at block 2712, the node responds “Five day weather forecast” at block 2714 and begins reading the five day weather forecast to the user at block 2716. The node then proceeds to an Extended_Weather routine 2720.

The Extended_Weather routine 2720 allows a user to repeat, cancel, or exit the current weather operation. When the node receives a “Repeat” command from the user at block 2768, the node proceeds to block 2769. If the node receives a DTMF tone at block 2770, a “Completed” command at block 2772, or an “Exit” command from the user at block 2776, the node responds “exiting weather information” at block 2774 then proceeds to the Main Menu routine 120.

When the node receives a “Help” command from the user at block 2777, the node proceeds to the Help Processing routine 458 (see FIG. 43) and then proceeds to block 2774 as described above. When the node receives a “Goodbye” command from the user at block 2778, the node proceeds to the Goodbye Processing Not Confirmed subroutine 232 (see FIG. 42a). At block 2779, the node determines the value of a “return value” flag. When the “return value” flag is equal to “Goodbye” at block 2777, the node proceeds to the Idle subroutine 100. When the value of the “return value” flag is equal to “return to call” at block 2779, the node connects the user to the call and then proceeds to the System_Main routine 214 (see FIG. 22). When the value of the “return value” flag is equal to “canceled” at block 2779, the node proceeds to the Man Menu routine 120. If the node receives a “Cancel” command from the user at block 2782, the node responds “Canceling” at block 2784 and then proceeds to the Main Menu routine 120.

As shown in FIG. 36, when the node receives a “start over” command from the user at block 2722, the node proceeds to the Main Menu routine 120. If the node is having difficulty recognizing commands from the user or detects a recognition error at block 2724, the node proceeds to the Error Processing subroutine 430 as further described below (see FIG. 39). If three consecutive recognition errors have been detected by the node at block 2726, the node proceeds to the Main Menu routine 120. If three consecutive recognition errors have not been detected by the node at block 2726, the node proceeds to the beginning of the Weather_Main routine 384.

When the node receives a “Help” command from the user at block 2728, the node proceeds to the Help Processing subroutine 458 as further described below (see FIG. 43). The node then proceeds to the beginning of the Weather_Main routine 384. When the node receives a “Cancel” command from the user at block 2730, the node responds “Canceling” at block 2732 and then proceeds to the Main Menu routine 120. Upon receiving an “Exit” command from the user at block 2734, the node responds “Returning to the Main Menu” at block 2736 and then proceeds to the Main Menu routine 120. When the node receives a “Goodbye” command from the user at block 2738, the node proceeds to the Goodbye Processing Not Confirmed subroutine 2740. At block 2742, the node determines the value of a “return value” flag. When the “return value” flag is equal to “Goodbye” at block 2742, the node proceeds to the Idle routine 100. When the value of the “return value” flag is equal to “return to call” at block 2742, the node connects the user to the call and then proceeds to the System_Main routine 214 (see FIG. 22). When the value of the “return value” flag is equal to “Canceled” at block 2742, the node proceeds to the Main Menu routine 120.

FIG. 37 shows a flow diagram of the Stock_Mkt_Main routine 402. The Stock_Mkt_Main routine 402 accesses stock market information covering the U.S. stock exchanges from the electronic network or a content provider (i.e., Yahoo stock indicators). For example, the Stock_Mkt_Main routine 402 allows a user to access stock market indicators (i.e., Dow Jones Industrials, etc.), stock quotes (i.e., Motorola (MOT)), and the user's stock market portfolio. After the node receives a stock market command from the user, the node retrieves the desired stock information.

The steps of the Stock_Mkt_Main routine 402 correspond, in many respects, in operation and function to the previously described steps of the Weather_Main routine 384 of FIG. 36. Accordingly, further description of the steps of the Stock_Mkt_Main routine 402 is unnecessary for complete understanding of the present embodiment. The steps of the Stock_Mkt_main routine 402 which generally correspond to the steps of the Weather_Main routine 384 are designated by like reference numerals in the twenty-eight hundred series.

FIG. 38 shows a flow diagram of the Authenticate subroutine 106. The Authenticate subroutine 106 validates a user to allow the user to access the node. At block 2900, the node responds “Please say or key in PIN”. The node then waits for the user to enter a PIN number and then proceeds to a Login_Main routine 2902.

The Log_Main routine 2902 verifies the PIN of the user. When the node receives a DTMF digit string at block 2904, the node then repeats the DTMF digit string to the user at block 2905 and increments the value of a PIN attempts flag at block 2906. The node then determines whether or not the PIN is valid at block 2908. If the PIN is valid at block 2908, the node sets the PIN attempts flag equal to zero and the value of an authenticated flag equal to “yes” at block 2910. The node then proceeds to block 2912. If the PIN is not valid at block 2908, the node determines whether the value of the PIN attempts flag is equal to three at block 2914. If the value of the PIN attempts flag is equal to three at block 2914, the node proceeds to block 2915 as further described below. If the PIN attempts value is not equal to three at block 2914, the node responds “PIN incorrect. Retry” at block 2916. The node then proceeds to block 2918.

As shown in FIG. 38, when the node receives a spoken digit string at block 2920, the node processes the spoken digits string and then plays back the digits string back to the user at block 2922. The node then waits for a PIN confirmation from the user and then proceeds to a Login_Pwd_Conf routine 2924. It is also contemplated that the node can identify a user through speaker identification.

The Login_Pwd_Conf routine 2924 allows a user to confirm that the node correctly received the user's PIN. If the node receives a “Yes” command from the user at block 2926 or does not receive a response for a period of time at block 2928, the node proceeds to block 2906 as described above. When the node receives a “No” command at block 2930 or has difficulty recognizing the spoken commands from the user at block 2932, the node increments the value of a PIN error flag at block 2934 and then determines whether the value of the PIN error flag is equal to three at block 2936. If the value of the PIN error flag is not equal to three at block 2936, the node proceeds to block 2938. If the value of the PIN error value is equal to three at block 2936, the node sets the value of the PIN attempts flag equal to zero and the authenticated flag equal to “no” at block 2915. The node then proceeds to block 2912.

FIG. 39 shows a flow diagram of the Error Processing subroutine 430. The Error Processing subroutine 430 processes errors detected by the node (i.e., speech recognition errors) and provides appropriate error messages to the user. At block 3000, the Error Processing subroutine 430 determines the error type. If a command from the user has been rejected by the node at block 3002, the node detected too much speech from the user at block 3006, or the recognition is too slow at block 3010, the node responds “Sorry, I didn't understand you” at blocks 3004, 3008, and 3012. The node then increments the value of a recognition error flag at block 3024.

When the node receives unexpected DTMF tones at block 3014, the node responds “I heard tones. Please speak your response” at block 3016 and then proceeds to block 3024. When the node does not detect any speech from the user at block 3020, the node responds “I am having difficulty hearing you” at block 3022 and then proceeds to block 3024.

As shown in FIG. 39, if the recognition error value is equal to one at block 3026, the node reads a first stored error message to the user at block 3028 and then proceeds to block 2912. If the recognition error is equal to two at block 3026, the node reads a second stored error message to the user at block 3030 and then proceeds to block 2912. If the recognition error is equal to three at block 3026, the node reads a third stored error message to the user at block 3032 and then proceeds to block 2912.

FIG. 40 shows the Exit Processing subroutine 446. The Exit Processing subroutine 446 allows a user to exit the current operation and return to the Main Menu routine 120. At block 3100, the node responds “Do you wish to exit and return to the Main Menu?” The node then waits for an input from the user and then proceeds to a Univ_Exit_Conf routine 3102.

When the node receives a “Yes” command from the user at block 3104, the node responds “Exiting and returning to the Main Menu” at block 3106 and sets a value of an exit flag equal to “yes” at block 3108. The node then proceeds to block 2912.

When the node receives a “No” command from the user at block 3110, the node sets the value of the exit flag to “no” at block 3112 and then proceeds to block 2912. If the node is having difficulty recognizing commands from the user or detects a recognition error at block 3114, the node proceeds to the Error Processing subroutine 430 as described above (see FIG. 39). At block 3116, the node determines whether there have been two consecutive recognition errors. If two consecutive recognition errors have been detected by the node at block 3116, the node sets the value of the exit flag equal to “no” at block 3118 and then proceeds to block 2912. If two consecutive recognition errors have not been detected by the node at block 3116, the node waits for a response from the user and then proceeds to the beginning of the Univ_Exit_Conf routine 3102.

When the node receives a “Help” command from the user at block 3120, the node proceeds to the Help Processing subroutine 458 as further described below (see FIG. 43). The node then proceeds to the beginning of the Univ_Exit_Conf routine 3102.

FIG. 41 illustrates a flow diagram of the Cancel Processing subroutine 436. The Cancel Processing subroutine 436 allows a user to cancel any current operation. The steps of the Cancel Processing subroutine 436 correspond, in many respects, in operation and function to the previously described steps of the Exit Processing subroutine 446 of FIG. 40. Accordingly, further description of the steps of the Cancel Processing subroutine 436 is unnecessary for a complete understanding of the present embodiment. The steps of the Cancel Processing subroutine 436 which generally correspond to the steps of the Exit Processing subroutine 446 are designated by like reference numerals in the thirty-two hundred series.

FIG. 42 shows a flow diagram of the Goodbye Processing subroutine 452. The Goodbye Processing subroutine 452 allows the user to leave the node. The steps of the Goodbye Processing subroutine 452 correspond, in many respects, in operation and function to the previously described steps of the Exit Processing subroutine 446 of FIG. 40. Accordingly, further description of the steps of the Goodbye Processing subroutine 452 is unnecessary for a complete understanding of the present embodiment. The steps of the Goodbye Processing subroutine 452 which generally correspond to the steps of the Exit Processing subroutine 446 are designated by like reference numerals in the thirty-three hundred series.

FIG. 42a illustrates the Goodbye Processing Not Confirmed subroutine 232. At block 3350, the node determines whether a call is on hold. If a call is not on hold at block 3350, the node responds “Goodbye” at block 3352 and sets a value of a “return value” flag equal to “goodbye” at block 3354. The node then proceeds to block 2912. If the call is on hold at block 3350, the node responds “A call is on hold. Do you wish to leave?” at block 3356 and then proceeds to the MMenu_GoodbyeWhenCallIsOnHold routine 3358.

The MMenu_GoodbyeWhenCallIsOnHold routine 3358 processes the user's request to determine whether the user wishes to leave the node. Initially, the node is waiting for a command from the user. When the node does not receive a recognized command at block 3360, the node responds “Goodbye” and sets the value of the “return value” flag equal to “Goodbye” at block 3364. The node then proceeds to block 2912. When the node receives a “return” command from the user at block 3366, the node responds “returning to call” and sets the value of the “return value” flag equal to “Return to call” at block 3370. The node then proceeds to block 2912. When the node receives a DTMF tone at block 3372 or a “Cancel” command from the user at block 3374, the node sets the value of the “return value” flag equal to “Canceled” at block 3376 and then proceeds to block 2912.

FIG. 43 shows a flow diagram of the Help Processing subroutine 458. The Help Processing subroutine 458 allows the user to receive on-line help from the node. The node can provide help about a specific operation or feature the user is attempting to implement or use. At block 3400, the node increments the value of “help request” flag. If the value of the “help request” flag is equal to one at block 3402, the node reads a first stored help message to the user at block 3404 and then proceeds to block 2912. If the value of the “help request” flag is equal to two at block 3402, the node reads a second stored help message to the user at block 3408 and then proceeds to block 2912. If the value of the “help request” flag is equal to three at block 3402, the node reads a third stored help message to the user at block 3410 and then proceeds to block 2912.

While specific embodiments of the present invention have been shown, it will be recognized by those skilled in the art that the disclosed embodiments may be modified in numerous ways and may assume many embodiments other than the preferred form specifically set out and described above. Accordingly, it is intended that the appended claims to cover all modifications of the invention which fall within the true spirit and scope of the invention.

What is claimed:

1. A telecommunication system comprising:
a telephone switch having at least one incoming line and at least one outgoing line, the telephone switch responsive to control signals to switch a call received from a caller to an outgoing line directed to one of a plurality of numbers stored in a database for a first party;
an audio processing unit connected to the telephone switch to receive incoming audio communications from the caller and to provide outgoing audio communications to the caller; and
a control unit to control the telephone switch to transfer the call to the at least one outgoing line.

2. The telecommunication system of claim 1, wherein the audio processing unit continuously monitors the incoming audio communications from the caller for a selected audio communication from the caller.

3. The telecommunication system of claim 1, wherein the telecommunication system establishes a connection with a communication device over the at least one incoming line.

4. The telecommunication system of claim 3, wherein the communication device comprises one of a network access apparatus, a mobile phone, a paging device, and a telephone.

5. The telecommunication system of claim 4 wherein the network access apparatus comprises one of a computer, a handheld device, a personal information management device, and a personal digital assistants.

6. The telecommunication system of claim 1, wherein the database includes information supplied by the caller.

7. The telecommunication system of claim 1, wherein the audio recognition unit performs independent speaker voice recognition.

8. The telecommunication system of claim 1, wherein the incoming audio communications include one of voice communications and touch-tone signals.

9. The telecommunications system of claim 1, wherein the database includes an address book containing a list of parties supplied by the caller.

10. The telecommunication system of claim 1, wherein the database is programmable by voice commands.

11. The telecommunication system of claim 1, wherein the outgoing audio communications correspond to one of voice communications, content information, voice mail messages, paging information, and information stored in the database.

12. The telecommunication system of claim 1, wherein the telecommunication system is coupled to one of a carrier network, a local exchange network, a private branch office, a public switched telephone network, a content provider, an electronic network, a paging network, a voice mail system, and a short messaging system.

13. The telecommunication system of claim 1, further comprising a gateway server responsive to commands from the control unit, to route calls to an electronic network.

14. The telecommunication system of claim 1, further comprising an application server, responsive to commands from the control unit, to retrieve content information from a content provider.

15. The telecommunication system of claim 1, wherein the audio processing unit comprises one of a voice recognition unit client and a voice recognition unit server.

16. The telecommunication system of claim 1, wherein the audio processing unit server includes one of a key word spotting unit, a text-to-speech unit, an automatic speech recognition unit, and a speech-to-text unit.

17. The telecommunication system of claim 1 further comprising a local area network coupled to the audio processing unit.

18. The telecommunication system of claim 1, wherein the telecommunication switch includes a monitoring unit to continuously monitor incoming audio communications for a selected audio communication from a caller.

19. The telecommunication system of claim 17, further comprising an application server unit, coupled to the local area network, to retrieve one of traffic data, stock data, news data, restaurant data, bank data, and weather data from a content provider.

20. The telecommunication system of claim 17, further comprising an integrated message server unit coupled to the local area network.

21. The telecommunication system of claim 17, wherein the database is coupled to the local area network.

22. The telecommunication system of claim 17, further comprising a billing server unit coupled to the local area network.

23. The telecommunication system of claim 17, further comprising a message unit coupled to the local area network to deliver an audio message to the user.

24. The telecommunication system of claim 24, wherein the message server is coupled to one of a paging network, a voice mail system, and a short messaging system.

25. A telecommunication system comprising:
a telephone switch having at least one incoming line;
an audio processing unit to receive incoming audio communications from a user and to provide outgoing audio communications to the user;
a gateway unit, coupled to the audio processing unit, having at least one line to communicate with an electronic network; and
a control unit, in communication with the audio processing unit, to switch a call received from the user to the at least one line directed to the electronic network.

26. The telecommunication system of claim 25 further comprising a voice over internet protocol unit in communication with the telephone switch to convert audio communications from the call to a selected internet protocol.

27. A telecommunication system comprising:
a telephone switch having at least one incoming line and at least one outgoing line;
an audio recognition unit to receive incoming audio communications from a user and to provide outgoing audio communications to the user;
a local area network coupled to the audio processing unit; and
a control unit, coupled to the local area network, to switch a call received from a user to an outgoing line directed to number other than that which the user originally called.

28. A telecommunication system comprising:
a telephone switch having at least one incoming line and at least one outgoing line;
a response unit to receive incoming audio communications from a user and to provide outgoing audio communications to the user, the response unit including a text-to-speech unit to convert textual information into voice communications that are provided to the user; and
a gateway server to receive textual information from a destination of a content provider and to provide the textual information to the text-to-speech unit.

29. A method of providing telephone communication service to a user comprising the steps of:
receiving an incoming call from a user;
connecting the incoming call to an audio processing unit;
receiving audio commands from the user;
processing the audio commands received from the user;
providing audio messages to the user in response to the audio commands from the user;
obtaining a first audio request from the user;
determining whether the first audio request corresponds to one of a plurality of parties stored in a database; and
placing an outgoing call directed to the one of the plurality of parties.

30. The method of claim 29 further comprising the steps of:
obtaining a second audio request from the user;
determining whether the second audio request corresponds to one of a plurality of destinations for the one of the plurality of parties; and
placing the outgoing call to a phone number associated with the one of the plurality of destinations.

31. The method of claim 30, wherein the destinations include one of a mobile phone, a car phone, a home phone, a work phone, and a paging device of a party.

32. The method of claim 29, wherein the outgoing call is directed to one of an electronic network, a telephone network, a paging network, a carrier network, a local exchange network, a private branch office, a public switched telephone network, a content provider, an external voice mail system, and a short messaging system.

33. The method of claim 29, wherein the incoming call is received from one of an electronic network, a telephone network, a paging network, a carrier network, a local exchange network, a private branch office, a public switched telephone network, a content provider, an external voice mail system, and a short messaging system.

34. The method of claim 29, further comprising the step of determining the identity of the user as the source of the incoming call.

35. The method of claim 34, wherein the step of identifying includes the step of comparing a calling line identification associated with the incoming call with a stored calling line identification for the user.

36. The method of claim 34, wherein the step of identifying includes the step of comparing a voice communication from the user to a prestored voice communication of the user.

37. The method of claim 29, further comprising the steps of switching the received call to an outgoing line to a number other than that which the user original called.

38. The method of claim 29, further comprising the step of programming the database with inputs from the user.

39. The method of claim 29, wherein the audio commands are processed using a voice recognition unit.

40. The method of claim 29, wherein audio commands include DTMF signals.

41. The method of claim 29, further comprising the step of programming data associated with a contact into the database.

42. The method of claim 29, further comprising the step of providing a first message identifying the caller.

43. The method of claim 29, further comprising the step of converting text data to a speech message and permitting the caller to hear the speech message.

44. The method of claim 43, wherein the text data includes emails and content information.

45. The method of claim 29, further comprising the step of connecting an announcement to the user.

46. The method of claim 29, further comprising the step of accessing one of a plurality of dedicated memory locations having stored therein a phone number to be automatically dialed by the telecommunication system.

47. The method of claim 29, further comprising the step of translating a voice message to a textual message and routing the textual message to a pager associated with a party.

48. The method of claim 29 further comprising the step of simultaneously placing the outgoing call to plurality of phone numbers of a single party.

49. The method of claim 29 further comprising the step of identifying the user by a speech pattern.

50. The method of claim 29 further comprising the step of determining the caller line identification of a calling communication device used of the user.

51. The method of claim 29 further comprising the step of playing a welcome greeting based upon one of the calling communication device, the caller line identification, and the user.

52. The method of claim 29 further comprising the step of routing the outgoing call to a long distance carrier based upon a long distance calling number stored in the database.

53. The method of claim 29 further comprising the step of notifying the user of new messages.

54. The method of claim 29 further comprising the step of selecting one of a plurality of voice personalities to read prestored messages to the user.

55. The method of claim 29 further comprising the step of routing the outgoing call to a long distance carrier in response to a command from the user.

56. The method of claim 29 further comprising the step of selecting a speech recognition model based upon one of a calling communication device, the caller line identification, and the user.

57. A method of providing content information to a user comprising the steps of:
receiving an incoming call from a user;
connecting the incoming request to an audio processing unit;
obtaining a first audio request from the user;
comparing the first audio request to stored data to determine a destination for the content information;
retrieving the content information from the destination;
translating the content information to a voice communication; and
providing the voice communication to the user.

58. The method of claim 47, further comprising the steps of:
establishing a data connection between the call and a gateway server;
receiving the data associated with request at the gateway server; transmitting a request onto an electronic network by the gateway server; and receiving the content information from the electronic network by the gateway server.
